(19) United States
(12) Patent Application Publication
(10) Pub. No.: US 2012/0321348 A1
(43) Pub. Date: Dec. 20, 2012

(54) IMAGE BEARING DRUM, IMAGE FORMING APPARATUS, IMAGE FORMING METHOD, AND PROCESS CARTRIDGE

(76) Inventors: Noboru Toriu, Shizuoka (JP); Daisuke Kubo, Shizuoka (JP); Hideo Nakamori, Shizuoka (JP); Mitsuaki Hirose, Shizuoka (JP)

(21) Appl. No.: 13/524,617

(22) Filed: Jun. 15, 2012

(30) Foreign Application Priority Data
Jun. 16, 2011 (JP) 2011-134032
Jun. 16, 2011 (JP) 2011-134418
Apr. 20, 2012 (JP) 2012-096270

(51) Int. Cl. G03G 15/00

(52) U.S. Cl. 399/159

(57) ABSTRACT

An image bearing drum having a hollow cylinder sleeve member; a photosensitive layer; a protective layer having fillers; and flange members, each of which has an attachment unit, a shaft hole unit, and a linking unit, wherein the surface of the protective layer having waviness has an arithmetical mean deviation of an assessed profile Wa (μm) of from 0.050 μm to 0.400 μm and a mean width of profile elements WSm (mm) of from 0.500 mm to 1.500 mm, and wherein the linking unit has at least one shock-absorbing hole located on a virtual line segment drawn to the shaft hole unit from the circumference of a virtually projected circle formed by projecting the outer periphery of the attachment unit axially along the shaft onto a virtual plane that contains the linking unit and is orthogonal to the shaft direction.

### CROSS-REFERENCE TO RELATED APPLICATION

This patent application is based on and claims priority pursuant to 35 U.S.C. §119 to Japanese Patent Application Nos. 2011-134032, 2011-134418, and 2012-096270, filed on Jun. 16, 2011, Jun. 16, 2011, and Apr. 20, 2012, respectively, the entire disclosures of which are hereby incorporated by reference herein.

### BACKGROUND OF THE INVENTION

1. Field of the Invention

The present invention relates to an image forming drum, an image forming apparatus, an image forming method, and a process cartridge.

2. Description of the Background Art

Recently, organic photoconductors (photoreceptors) have been used as image bearing members (e.g., drums) in place of inorganic photoreceptors in photocopiers, facsimile machines, laser printers, and multi-functional devices thereof in light of performances and advantages. Specific reasons for this supersession include (1) good optical characteristics, for example, a broad range of optical absorption wavelengths and a large amount of absorption of light; (2) superior electrical characteristics, for example, high sensitivity and stable chargeability; (3) a wide selection of materials; (4) ease of manufacturing; (5) inexpensive cost; and (6) non-toxicity.

In particular, electrophotography has expanded into production printing fields such as commercial printing and mass printing. As a result, image quality on a par with offset printing has also come to be demanded for such image forming apparatuses in addition to high processing speed, compact size, and excellent durability.

From this durability point of view, a typical organic photoconductor is soft in general and easy to wear down because the surface layer thereof is mainly made of a low molecular weight charge transport material and an inert polymer. Thus, the organic photoconductor repetitively used in the electrophotographic process tends to be abraded by mechanical stress by a development system or a cleaning system. Moreover, to deal with the size-reduced toner particles currently demanded for production of quality images, harder rubber is used for the cleaning blade. As a result, contact pressure between the cleaning blade and the photoreceptor increases, which also accelerates the abrasion of the image bearing member.

Such abrasion of the image bearing member in turn degrades the electrical characteristics of the image bearing member, for example, the sensitivity and the chargeability, resulting in production of defective images having, for example, low image density and background fouling. Abrasion and localized damage to the image bearing member cause production of defective images with streaks ascribable to bad cleaning of the image bearing member. Currently, the working life of the image bearing member is limited by this abrasion and damage, which leads to premature replacement.

A number of attempts have been made to minimize abrasion and degradation of the image bearing member. For example, Japanese Patent Application Publication No. S56-48637 (JP-S56-48637-A) describes (1) using a curable binder for the protective layer. Similarly, JP-S64-1728-A describes (2) using a charge transport polymer. JP-H04-281461-A describes (3) dispersing inorganic fillers in the protective layer.

However, these attempts, though partially successful, do not provide fully satisfactory overall durability, including both electrical durability and mechanical durability, required of the organic photoconductors.

In addition, Japanese Patent No. 3262488 (JP-3262488-B) describes an image bearing member that contains poly-functional curable acrylate monomers to improve the abrasion resistance and damage resistance. However, this image bearing member has problems of precipitation of the low molecular weight charge transport materials and cracking, thereby degrading the mechanical strength of the image bearing member. JP-3262488-B also describes including polycarboante resins to improve compatibility but does not provide sufficient abrasion resistance. In addition, with regard to image bearing members having no charge transport materials in the protective layer, JP-3262488-B further describes using a thinner protective layer to reduce the voltage at the exposed portion, but such an arrangement shortens the working life of the image bearing member. In addition, the environment stability of the charging voltage and the voltage at the exposed portion is inferior and greatly affected by temperature and moisture.

Alternatively, JP-3194392-B describes providing to an image bearing member a charge transport layer formed using a liquid application containing monomers having a carbon-carbon double bond, charge transport materials having a carbon-carbon double bond, and binder resins. The binder resins include binder resins that contain a carbon-carbon double bond with reactivity for the charge transport material and binder resins that contain no carbon-carbon double bond with no reactivity for the charge transport material.

Although this image bearing member is successful in that it provides a good combination of abrasion resistance and electrical characteristics, cured materials produced by reaction between the monomers having a carbon-carbon double bond and the charge transport materials having a carbon-carbon double bond exhibit poor compatibility with the binder resins. As a result, layer separation tends to occur, which causes rough surfaces when cross-linking, thereby degrading cleaning performance. In addition, the binder resins prevent the monomers from curing and the monomers having a carbon-carbon double bond for use in the image bearing member specified in JP-3194392-B mentioned above are bi-functional. Such bi-functional monomers are insufficient in terms of the number of functional groups so that the cross-linking density does not provide sufficient abrasion resistance.

Moreover, in the case of the binder resin having reactivity, due to the insufficient number of functional groups contained in the monomers and the binder resins having a carbon-carbon double bond, it is difficult to have a good combination of the amount of bonding and the cross-linking density of the charge transport materials having a carbon-carbon double bond. The upshot is that the electrical characteristics and abrasion resistance of the image bearing member are inadequate.

JP-2000-66425-A describes a photosensitive layer that contains cured materials formed by curing a positive-hole transfer compound having at least two chain-polymerizable functional groups in a single molecule. However, distortion tends to occur in the cured materials in the photosensitive layer, which increases the internal stress because the bulky positive hole transport compound has at least two chain-polymerizable functional groups. Therefore, a rough protective layer tends to be formed and cracking tends to occur over time.

Furthermore, JP-2004-302450-A, JP-2004-302451-A, and JP-2004-302452-A describe a cross-linking-type charge transport layer formed by curing a radical polymerizable monomer having three or more functional groups with no charge transport structure and a mono-functional radical polymerizable compound having a charge transport structure. In this charge transport layer, the protective layer is cured by using the mono-functional radical polymerizable compound having a charge transport structure to improve the mechanical and electrical durability and reduce occurrence of cracking in the photosensitive layer at the same time.

In addition, JP-2005-99688-A describes a cross-linking-type protective layer formed by curing using a radical polymerizable compound and a filler. The thus-formed image bearing member has high abrasion resistance due to the hardness of the cross-linking resin film and the filler.

By these efforts, the protective layer of contemporary image bearing members has acquired excellent abrasion resistance and good durability. But the latter is still insufficient in terms of the durability required with the expansion of electrophotography into production printing to be on a par with offset printing.

Also, although the working life of the image bearing member is prolonged to some extent by stiffening the surface layer of an image bearing member, the cleaning blade contacting the image bearing member is subjected to greater mechanical stress. Therefore, the cleaning blade tends to deteriorate, easily turns inward or outward, or the end thereof easily chips off so that toner particles slip through. Toner particles that have slipped through the blade cause production of defective images with streaks.

The cleaning property of an image bearing member is improved by roughening the surface of the image bearing member. For example, JP-S53-092133-A describes controlling the drying condition when forming the surface layer to roughen the surface of an image bearing member and JP-S-52-026226-A describes forming a surface layer containing particles to roughen the surface thereof. Methods of mechanically roughening the surface of an image bearing member are also available.

For example, JP-H02-169566-A describes grinding the surface of the surface layer of an image bearing member with a film-form abrading agent to roughen the surface thereof. JP-H02-150850-A describes roughening the surface of the image bearing drum by blasting treatment.

However, although such surface roughening methods are initially successful to obtain a good cleaning property, the image bearing member is abraded over an extended period of time, which leads to deterioration of the cleaning performance improved by roughening the surface.

In an attempt to solve this problem, JP-2011-7969-A describes improvement of the cleaning performance of the image forming process that, by micro-roughening and waving the protective layer, the cleaning blade that contacts the image bearing member micro-vibrates on the surface of the image bearing member to wipe off any remaining toner thereon. However, since the cleaning unit is intentionally micro-vibrated on the surface of an image bearing member, the image bearing member (drum) also vibrates. In addition, since micro-roughening and waving of the surface layer are not completely uniformly formed over the entire of the image bearing member, the vibration of the image bearing drum varies locally or increases.

These are non-problematic for the current electrophotography level but problematic in terms of the image quality required with further expansion of electrophotography into the production printing field to be on a par with offset printing because such vibration of the image bearing drum adversely affects image density.

### SUMMARY OF THE INVENTION

In view of the foregoing, the present invention provides an image bearing drum having a hollow cylinder sleeve member; a photosensitive layer overlying the hollow cylinder sleeve member; a protective layer having fillers and overlying the photosensitive layer; and flange members, each of which has an attachment unit attached to an open axial end of the hollow cylinder sleeve member, a shaft hole unit into which a shaft member is inserted at the position of the center axis of the hollow cylinder sleeve member, and a linking unit that extends in a direction parallel to a circular cross-section of the hollow cylinder sleeve member to link the attachment unit to the shaft hole unit, wherein the surface of the protective layer having waviness has an arithmetical mean deviation of an assessed profile Wa (μm) of from 0.050 μm to 0.400 μm and a mean width of profile elements WSm (mm) of from 0.500 mm to 1.500 mm, which are obtained from a waviness profile in which roughness components are blocked off by a λc profile filter of 0.25 mm and wavelength components longer than the waviness are blocked off by λf profile filter of 2.5 mm, and wherein the linking unit has at least one shock-absorbing hole located on a virtual line segment drawn to the shaft hole unit from the circumference of a virtually projected circle formed by projecting the outer periphery of the attachment unit axially along the shaft onto a virtual plane that contains the linking unit and is orthogonal to the shaft direction.

As another aspect of the present invention, an image forming apparatus is provided which has the image bearing drum mentioned above, a charger to charge the surface of the image bearing drum, an exposure device to expose the surface of the image bearing drum to form a latent electrostatic image thereon, a development device to develop the latent electrostatic image formed on the image bearing drum with toner to obtain a toner image, a transfer device to transfer the toner image to a recording medium; and a cleaner to remove toner remaining on the surface of the image bearing drum.

As another aspect of the present invention, an image forming method is provided which includes charging the surface of the image bearing drum mentioned above, exposing the surface of the charged image bearing drum to form a latent electrostatic image thereon, developing the latent electrostatic image formed on the surface of the image bearing drum with toner to form a toner image, transferring the toner image onto a recording medium, and removing toner remaining on the surface of the image bearing drum.

As another aspect of the present invention, a process cartridge including the image bearing drum mentioned above and at least one device selected from the group consisting of a charger, a development device, a transfer device, and a cleaner, wherein the process cartridge is detachably mounted to an image forming apparatus.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a side view illustrating an example of an image bearing drum (photoreceptor drum);

FIG. 2 is a diagram illustrating an example of the image bearing drum from which flange members are removed from the image bearing sleeve;

FIG. 3 is a schematic diagram illustrating an example of the layer structure of the image bearing drum for use in the present disclosure;

FIG. 4 is a schematic diagram illustrating another example of the layer structure of the image bearing drum for use in the present disclosure;

FIG. 5 is a schematic diagram illustrating another example of the layer structure of the image bearing drum for use in the present disclosure;

FIG. 6 is a schematic diagram illustrating another example of the layer structure of the image bearing drum for use in the present disclosure;

FIG. 7A is a cross section illustrating an example of the flange member relative to the direction parallel to the shaft;

FIG. 7B is a cross section illustrating an example of the flange member relative to the direction perpendicular to the shaft;

FIG. 8A is a side view illustrating an example of the flange member having a driving force transmission gear;

FIG. 8B is a cross section illustrating an example of the flange member having a driving force transmission gear;

FIG. 9 is a view illustrating another example of the flange member;

FIG. 10 is a view illustrating another example of the flange member;

FIG. 11 is a view illustrating another example of the flange member;

FIG. 12 is a view illustrating another example of the flange member;

FIG. 13 is a view illustrating another example of the flange member;

FIG. 14 is a view illustrating another example of the flange member;

FIG. 15 is a view illustrating another example of the flange member;

FIG. 16 is a view illustrating another example of the flange member;

FIG. 17 is a view illustrating another example of the flange member;

FIG. 18 is a view illustrating another example of the flange member;

FIG. 19 is a view illustrating another example of the flange member;

FIG. 20 is a view illustrating another example of the flange member;

FIG. 21 is a view illustrating another example of the flange member;

FIG. 22 is a view illustrating another example of the flange member;

FIG. 23 is a view illustrating another example of the flange member;

FIG. 24 is a view illustrating another example of the flange member;

FIG. 25 is a view illustrating another example of the flange member;

FIG. 26 is a view illustrating another example of the flange member;

FIG. 27 is a view illustrating another example of the flange member;

FIG. 28 is a view illustrating another example of the flange member;

FIG. 29 is a view illustrating another example of the flange member;

FIG. 30A is a cross section illustrating an example of the flange member in Comparative Examples described later relative to the direction parallel to the direction of the shaft;

FIG. 30B is a cross section illustrating an example of the flange member in Comparative Examples described later from relative to the direction perpendicular to the shaft;

FIG. 31 is a schematic diagram illustrating an example of a vicinity type roller charging system for use in the image forming apparatus of the present disclosure;

FIG. 32 is a schematic diagram illustrating an example of the image forming apparatus of the present disclosure;

FIG. 33 is a schematic diagram illustrating another example of the image forming apparatus of the present disclosure;

FIG. 34 is a schematic diagram illustrating an example of the process cartridge for use in the process cartridge of the present disclosure;

FIG. 35 is an X-ray diffraction spectrum diagram of the charge generating material for use in Examples described later with a Y axis representing a count number per second (cps: counter per second) and an X axis representing an angle (2θ);

FIG. 36A is a schematic top view illustrating a device for use in measuring the deviation of the image bearing drum;

FIG. 36B is a schematic side view illustrating a device for use in measuring the vibration of the image bearing drum;

FIG. 37 is a diagram illustrating spraying application of a protective layer; and

FIG. 38 is a schematic diagram illustrating the protective layer in which filler particulates are dispersed.

### DETAILED DESCRIPTION OF THE PRESENT DISCLOSURE

### Image Bearing (Photoreceptor) Drum

The image bearing drum of the present disclosure has a hollow cylinder sleeve member, a photosensitive layer, a protective layer, and flange members with other optional layers and members.

The photosensitive layer and the protective layer are sequentially laminated on the outer periphery of the hollow cylinder sleeve member.

The protective layer contains fillers.

The surface of the protective layer having waviness has an arithmetical mean deviation of the assessed profile Wa (μm) of from 0.050 μm to 0.400 μm and a mean width of the profile elements WSm (mm) of from 0.500 mm to 1.500 mm, which are obtained from a waviness profile in which roughness components are blocked off by a λc profile filter of 0.25 mm and wavelength components longer than the waviness are blocked off by λf profile filter of 2.5 mm.

The flange members are attached to the open axial ends of the hollow cylinder sleeve member relative to the direction of the shaft thereof.

The flange member has: an attachment unit which can be attached to the open axial end of the end of the hollow cylinder sleeve member relative to the direction of the shaft of the hollow cylinder sleeve member; a shaft hole unit having a shaft hole into which a shaft member is inserted at the position of the center axis of the hollow cylinder sleeve member (when the attachment unit is attached to the open axial end); and a linking unit that extends in the direction parallel to the circular cross section of the hollow cylinder sleeve member and links the shaft hole unit to the attachment unit. The linking unit has at least one shock-absorbing hole located on a virtual line segment drawn to the shaft hole unit from the circumference of a virtually projected circle formed by projecting the outer periphery of the attachment unit relative to the direction of the shaft of the hollow cylinder sleeve member on a virtual plane which contains the linking unit and is orthogonal to the shaft direction.

Since the flange member can reduce eccentric (non-uniform) abrasion, the image bearing drum has an excellent durability. According to the analysis by the present inventors, the cause of the eccentric (non-uniform) abrasion is inferred that, in the repetitive image forming on the image bearing drum, micro-impact (shock such as vibration) ascribable to fillers in the surface of the protective layer repetitively occurs so that, due to the impact, the deviation (displacement) of the image bearing drum in the shaft direction varies depending on the location on the image bearing member, which resultantly creates the difference in hazard received on the image bearing drum depending on the contact positions thereon (with the cleaning blade, etc.). This leads to the difference in the scraped amount of the surface of the image bearing drum. In the present disclosure, the flange member is used.

The flange member is initially considered suitable to reduce the assembly deviation (error) occurring when the flange member is pressed into the image bearing drum when manufacturing the image bearing drum. The present inventors have also confirmed that the flange member absorbs the impact (shock such as vibration) which is ascribable to the protective layer and occurs when forming images.

The mechanism of shock-absorbing by the flange member when forming images is not clear but as a result of the evaluation on the durability of the image bearing drum of the present disclosure and an image bearing member having the same structure as the image bearing drum of the present disclosure except that a typical flange member is used, non-uniform abrasion occurs to the image bearing member using a typical flange member but not the image bearing drum of the present disclosure.

The reason of the assembly deviation (error) occurring when a flange member is pressed into an image bearing drum when manufacturing the image bearing member is as follows:

When the pressed-in unit (attachment unit) of the flange member is pressed into the open axial end of the sleeve member, the outer periphery of the pressed-in unit contacts the inner periphery of the open axial end of the sleeve member and receives a stress therefrom. This stress transmits from the pressed-in unit to the shaft hole unit via the linking unit, thereby deforming or moving the shaft hole provided to the shaft hole unit. If the shaft hole is deformed or moved, the position of the shaft hole of the flange member shifts from the center axis of the sleeve member, resulting in increase in the assembly deviation of the image bearing member.

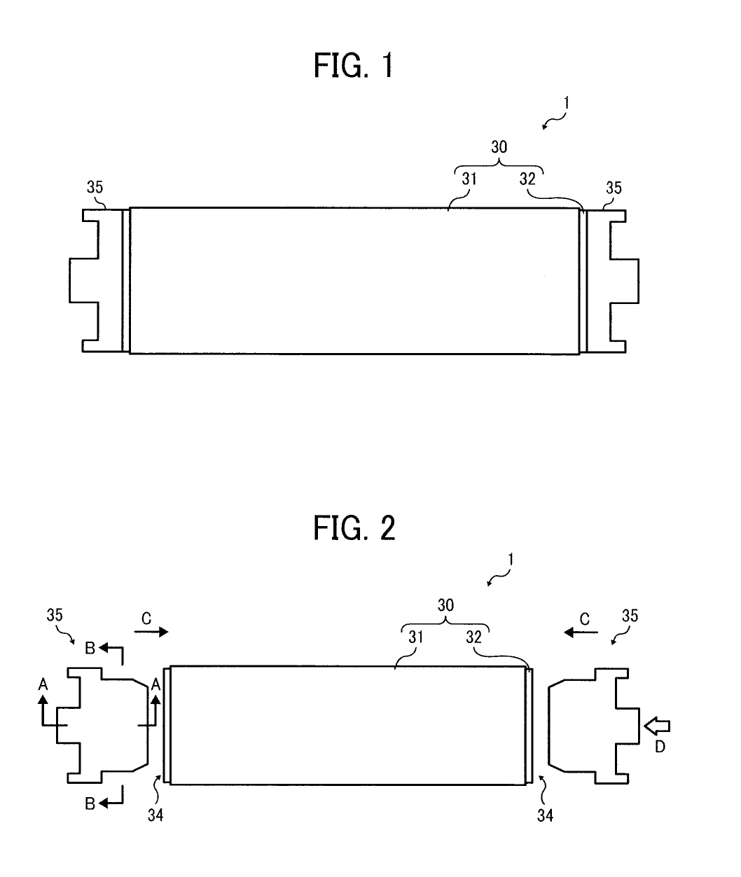

FIG. 1 is a side view illustrating an example of an image bearing drum (photoreceptor drum) 1.

The image bearing drum 1 has an image bearing sleeve 30 having a hollow cylinder sleeve member 32 and a protective layer 31 around the outer periphery of the hollow cylinder sleeve member 32, and flange members 35 arranged at the end portions of the image bearing sleeve 30 relative to the shaft direction thereof.

FIG. 2 is a diagram illustrating an example in which the flange members 35 are removed from the image bearing sleeve 30. As indicated by the arrows C in FIG. 2, the attachment units of the flange member 35 are pressed in the open axial ends 34 at the ends of the image bearing sleeve 30 relative to the shaft direction thereof so that the image bearing drum 1 illustrated in FIG. 1 is obtained.

### Hollow Cylinder Sleeve Member

There is no specific limitation to the hollow cylinder sleeve member. Any hollow cylinder sleeve member that has open axial ends at the ends relative to the shaft direction of the sleeve member can be suitably used.

For example, electroconductive materials having a volume resistance of 1.0×10¹⁰ Ω·cm or less can be used to form the hollow cylinder sleeve member. For example, there can be used plastic or paper having a film form or cylindrical form covered with a metal such as aluminum, nickel, chrome, nichrome, copper, gold, silver, and platinum or a metal oxide such as tin oxide and indium oxide by depositing or sputtering. It is also possible to use a tube which is manufactured from a board formed of aluminum, an aluminum alloy, nickel, and a stainless metal followed by a treatment of a crafting technique such as extruding and extracting and surface-treatment such as cutting, super finishing, and grinding.

There is no specific limitation to the size of the hollow cylinder sleeve member. For example, the diameter of the hollow cylinder sleeve member is from 20 mm to 150 mm, preferably from 24 mm to 100 mm, and more preferably from 28 mm to 70 mm. When the diameter of the hollow cylinder sleeve member is too small, physical arrangement of devices performing processes of charging, exposing, development, transfer, cleaning, etc. around the image bearing drum tends to be difficult. A diameter that is too large tends to result in an increase in size of the image forming apparatus. In particular, in an image forming apparatus of tandem type is used, a plurality of image bearing members are installed therein so that the diameter of the sleeve is preferably 70 mm at most and more preferably 60 mm at most.

### Photosensitive Layer

There is no specific limitation to the photosensitive layer. For example, a single-layered photosensitive layer in which a charge generating material and a charge transport material are mixed and a laminate type photosensitive layer in which a charge generating layer and a charge transport layer are laminated on each other are suitably used.

The laminate type photosensitive layer are classified in light of the sequence of the laminating the charge transport and the charge generating layer, that is, one is a laminate type photosensitive layer having a charge generating layer laminated on a charge transport layer and the other is a laminate type photosensitive layer having the reversing order. Of the two, the laminate type photosensitive layer having a charge generating layer laminated on a charge transport layer is preferable in terms of the durability.

### Charge Generating Layer

The charge generating layer contains at least a charge generating material and other optional materials such as resins.

### Charge Generating Material

Specific examples thereof include, but are not limited to, azo pigments such as monoazo pigments, disazo pigments, asymmetry disazo pigments, trisazo pigments, azo pigments having a carbazole skeleton (refer to JP-553-95033-A), azo pigments having a distyryl benzene skeleton (refer to JP-S53-13344-A5), azo pigments having a triphenylamine skeleton (refer to JP-S53-132347-A), azo pigments having a diphenylamine skeleton, azo pigments having a dibenzothiophene skeleton (refer to JP-554-21728-A), azo pigments having a fluorenone skeleton (refer to JP-554-22834-A), azo pigments having an oxadiazole skeleton (refer to JP-S54-12742-A), azo pigments having a bis-stilbene skeleton (refer to JP-S54-17733-A), azo pigments having a distyryloxadiazole skeleton (refer to JP-S54-2129-A), azo pigments having a distylylcarbazole skeleton (refer to JP-S54-14967-A); azulenium salt pigments; squaric acid methine pigments; perylene pigments, anthraquinone or polycyclic quinone pigments; quinone imine pigments; diphenylmethane and triphenylmethane pigments; benzoquinone and naphthoquinone pigments; cyanine and azomethine pigments, indigoid pigments, and bis-benzimidazole pigments, and phthalocyanine based pigments such as metal phthalocyanine represented by the following Chemical Structure 1, and metal free phthalocyanine.

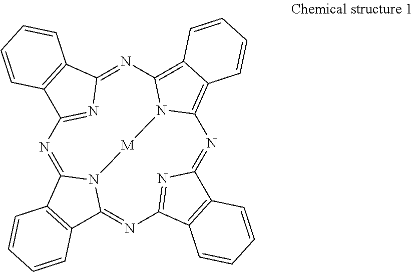

In the Chemical Structure 1, M represents a metal, a metal oxide, a metal chloride, a metal fluoride, metal hydroxide, a metal bromide, and non-metal (hydrogen). Specific example of the metals for M include, but are not limited to, Li, Be, Na, Mg, Al, Si, K, Ca, Sc. Ti, V, Cr, Mn, Fe, Co, Ni, Cu, Zn, Ga, Ge, Y, Zr, Nb, Mo, Tc, Ru, Rh, Pd, Ag, Cd, In, Sn, Sb, Ba, Hf, Ta, W, Re, Os, Ir, Pt, Au, Hg, Ti, La, Ce, Pr, Nd, Pm, Sm, Eu, Gd, Tb, Dy, Ho, Er, Tm, Yb, Lu, Th, Pa, U, Np, and Am.

Any phthalocyanine-based pigment that has at least a basic skeleton structure represented by the Chemical Structure 1 is suitable. Also, any phthalocyanine-based pigment having a higher multiple structure such as a dimer and a trimer is suitably used. In addition, the basic skeleton may have various kinds of substitution groups. Among these phthalocyanine-based pigments, titanyl phthalocyanine including Ti as the center metal, metal-free phthalocyanine, chrologallium phthalocyanine, hydroxygallium phthalocyanine are particularly preferable in terms of the characteristics of an image bearing member. In addition, these phthalocyanine-based pigments are known to have various kinds of crystal types, For example, titanylphthalocyanine has α, β, γ, m, Y type, etc., and copper phthalocyanine has α, β, γ, etc. The characteristics of the phthalocyanines having the same center metal vary depending on the crystal type. The characteristics of the image bearing member (drum) using the phthalocyanine-based pigments having various kinds of crystal types are reported to change accordingly (refer to Denshi Shashin Gakkaishi. Vol. 29, issue 4 published in 1990). These can be used alone or in combination.

In addition, among the azo pigments, the azo pigments represented by the Chemical Structure 2 are preferably used. In particular, an asymmetry azo pigment which has Cp₁ different from Cp₂ has an excellent carrier generation efficiency, which is effective in terms of high speed performance and is preferably used as the charge generating material for use in the present disclosure.

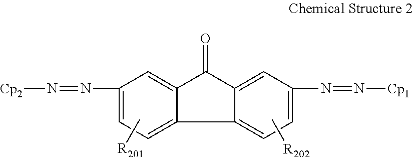

In the Chemical Structure 2, Cp₁ and Cp₂ independently represent coupler remaining groups. R₂₀₁ and R₂₀₂ independently represent hydrogen atoms, halogen atoms, alkyl groups, alkoxy groups, and cyano groups.

Examples of Cp₁ and Cp₂ are, for example, coupler remaining groups represented by the Chemical Structure 3.

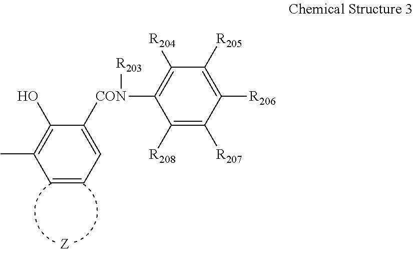

In the Chemical Structure 3, R₂₀₃ represents a hydrogen atom, an alkyl group such as methyl group and ethyl group, and an aryl group such as a phenyl group. R₂₀₄, R₂₀₅, R₂₀₆, R₂₀₇, and R₂₀₈ independently represent hydrogen atoms, nitro groups, cyano groups, halogen atoms such as fluorine, chlorine, bromine, and iodine, halogenized alkyl groups such as trifluoromethyl group, alkyl groups such as methyl groups and ethyl groups, alkoxy groups such as methoxy groups and ethoxy groups, dialkyl amino groups, and hydroxyl group. Z represents atom groups constituting a substituted or non-substituted carbon cyclic aromatic group or atom groups constituting a substituted or non-substituted heterocyclic aromatic ring.

### Binder Resin

Specific examples of the binder resin optionally for use in the charge generating layer include, but are not limited to, known binder resins such as polyamides, polyurethanes, epoxy resins, polyketones, polycarbonates, silicone resins, acrylic resins, polyvinylbutyrals, polyvinylformals, polyvinylketones, polystyrenes, poly-N-vinylcarbazoles, polyacrylamides, polyvinyl benzale, polyester, phenoxy resin, copolymer of vinylchloride and vinyl acetate, polyvinyl acetate, polyphenylene oxide, polyvinylpyridine, cellulose based resin, casein, polyvinyl alcohol, and polyvinyl pyrolidone. These can be used alone or in combination. In addition, there is no specific limitation to the content of the binder resin in the charge generating layer is preferably 500 parts by weight or less and more preferably from 10 parts by weight to 300 parts by weight based on 100 parts of the charge generating material.

There is no specific limitation to the method of forming a charge generating layer. Specific examples thereof include, but are not limited to, vacuum thin layer forming methods and casting methods. Specific examples of the vacuum thin layer forming methods include, but are not limited to, a vacuum evaporation method, a glow discharge decomposition method, an ion-plating method, a sputtering method, a reactive sputtering method, or a CVD method. Specific examples of the casting methods include, but are not limited to, a dip coating method, a spray coating method, a bead coating method.

Liquid applications are generally used in the casting methods. There is no specific limitation to the liquid application. Specific example thereof include, but are not limited to, liquid applications in which the charge generating material is dispersed in a solvent together with an optional binder resin by a known dispersion method such as a ball mill, an attritor, a sand mill, an ultrasonic wave. The optional binder resin can be added before or after the dispersion of the charge generating material. The liquid application of the charge generating layer is mainly formed of a charge generating material, a solvent, and a binder resin and may also contain additives such as a sensitizer, a dispersion agent, a surface active agent, and silicone oil. A charge transport material, which is described later, can be added to the charge generating layer.

Specific examples of the solvents for use in forming the charge generating layer include, but are not limited to, known organic solvents such as isopropanol, acetone, methylethylketone, cyclohexanone, tetrahydrofuran, dioxane, ethylcellosolve, ethyl acetate, methylacetate, dichloromethane, dichloroethane, monochlorobenzene, cyclohexane, toluene, xylene, and ligroin. Among these, ketone based solvents, ester based solvents, and ether based solvents are particularly preferable. These can be used alone or in combination.

The charge generating layer is formed by applying the liquid application mentioned above to the hollow cylinder sleeve member or an undercoating layer, etc. followed by drying. Known methods such as a dip coating method, a spray coating method, a bead coating method, a nozzle coating method, a spinner coating method, and a ring coating method can be used as the application method. The liquid application is heated and dried in an oven, etc. after the application. There is no specific limitation to the drying temperature. The drying temperature is preferably from 50° C. to 160° C. and more preferably from 80° C. to 140° C.

There is no specific limitation to the average thickness of the charge generating layer. The charge generating layer preferably has an average thickness of from 0.01 μm to 5 μm and more preferably from 0.1 μm to 2 μm. A thick charge generating layer is advantageous in terms of the residual voltage and the sensitivity. On the other hand, such a thick layer may degrade the chargeability such as retention of charges and formation of space charges. When the average thickness is within this preferable range, these are well balanced. When the average thickness is within this more preferable range, these are better balanced.

### Charge Transport Layer

The charge transport layer contains at least a charge transport material and other optional materials such as resins.

### Charge Transport Layer

There is no specific limitation to the selection of the charge transport material. Specific examples thereof include, but are not limited to, electron transport materials, positive hole transport materials, etc.

Specific examples of such electron transport structures include, but are not limited to, chloranil, bromanil, tetracyano ethylene, tetracyanoquino dimethane, 2,4,7-trinitro-9-fluorenone, 2,4,5,7-tetranitro-9-fluorenone, 2,4,5,7-tetranitroxanthone, 2,4,8-trinitro thioxanthone, 2,6,8-trinitro-4H-indeno[1,2-b]thiophene-4-one, 1,3,7-trinitro dibenzo thhiophene-5,5-dioxide, condensed heterocyclic quinine, diphenoquinone, benzoquinone, naphtharene tetracarboxylic acid diimide, and aromatic rings having a cyano group or a nitro group.

Specific examples of the positive hole transport materials include, but are not limited to, poly(N-vinylvarbazole) and derivatives thereof, poly(γ-carbzoyl ethylglutamate) and derivatives thereof, pyrenne-formaldehyde condensation products and derivatives thereof, polyvinylpyrene, polyvinyl phnanthrene, polysilane, oxazole derivatives, oxadiazole derivatives, imidazole derivatives, monoaryl amine derivatives, diaryl amine derivatives, triaryl amine derivatives, stilbene derivatives, α-phenyl stilbene derivatives, aminobiphenyl derivatives, benzidine derivatives, diaryl methane derivatives, triaryl methane derivatives, 9-styryl anthracene derivatives, pyrazoline derivatives, divinyl benzene derivatives, hydrazone derivatives, indene derivatives, butadiene derivatives, pyrene derivatives, disstilbene derivatives, and enamine derivatives. These can be used alone or in combination.

Among these charge transport materials, the compounds having a distyryl structure are preferable and among these, the charge transport materials represented by the Chemical Structure 4 are more preferable.

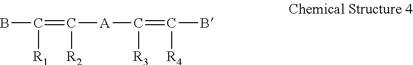

R₁ to R₄ independently represent hydrogen atoms, alkyl groups having 1 to 4 carbon atoms, alkoxy groups having 1 to 4 carbon atoms, or phenyl groups. The phenyl group may have an alkyl group having 1 to 4 carbon atoms and an alkoxy group having 1 to 4 carbon atoms as a substitution group. “A” represents a substituted or non-substituted arylene group and any group represented by the following Chemical Structure 5. “B” and “B′” independently represent substituted or non-substituted aryl groups and any groups represented by the following Chemical Structure 6.

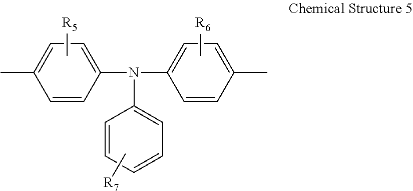

In the Chemical Structure 5, R₅, R₆, and R₇ independently represent hydrogen atoms, alkyl groups having 1 to 4 carbon atoms, alkoxy groups having 1 to 4 carbon atoms, and substituted or non-substituted phenyl groups. The phenyl group may have an alkyl group having 1 to 4 carbon atoms, and an alkoxy group having 1 to 4 carbon atoms as a substitution group.

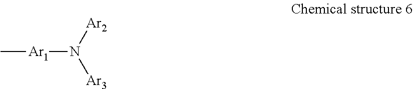

In the Chemical Structure 6, Ar₁ represents an arylene group, which may have an alkyl group having 1 to 4 carbon atoms, and an alkoxy group having 1 to 4 carbon atoms as a substitution group. In addition, Ar₂ and Ar₃ independently represent an aryl group, which may have an alkyl group having 1 to 4 carbon atoms and an alkoxy group having 1 to 4 carbon atoms as a substitution group. Among these, the charge transport materials represented by the Chemical Structure 7 are preferable.

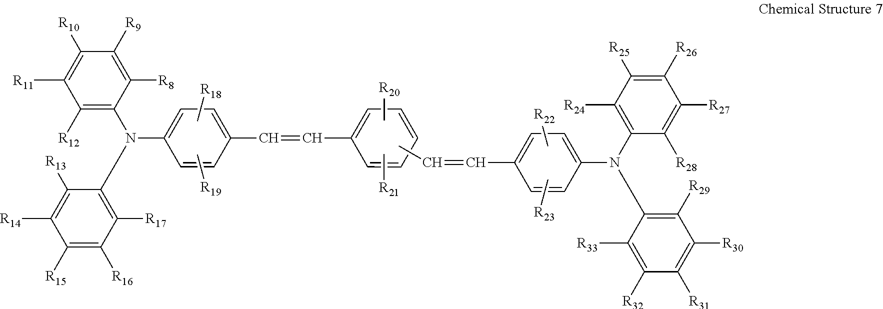

In the Chemical Structure 7, R₈ to R₃₃ independently represent hydrogen atoms, alkyl groups having 1 to 4 carbon atoms, alkoxy groups having 1 to 4 carbon atoms, or substituted or non-substituted phenyl groups.

In addition, the charge transport material illustrated by the following Chemical Structure 8 is preferable.

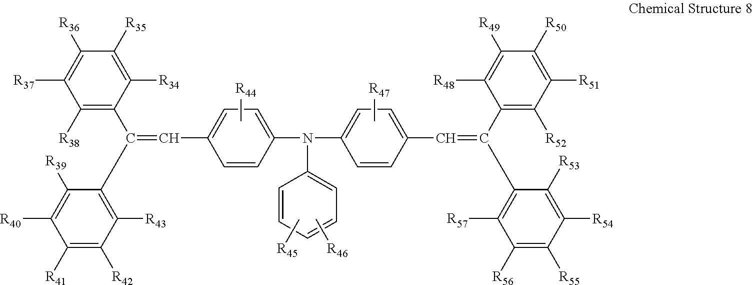

In the Chemical Structure 8, R₃₄ to R₅₇ independently represent hydrogen atoms, alkyl groups having 1 to 4 carbon atoms, alkoxy groups having 1 to 4 carbon atoms, and substituted or non-substituted phenyl groups.

Specific examples of these compounds used as the charge transport materials in the present disclosure include, but are not limited to, the following (represented by

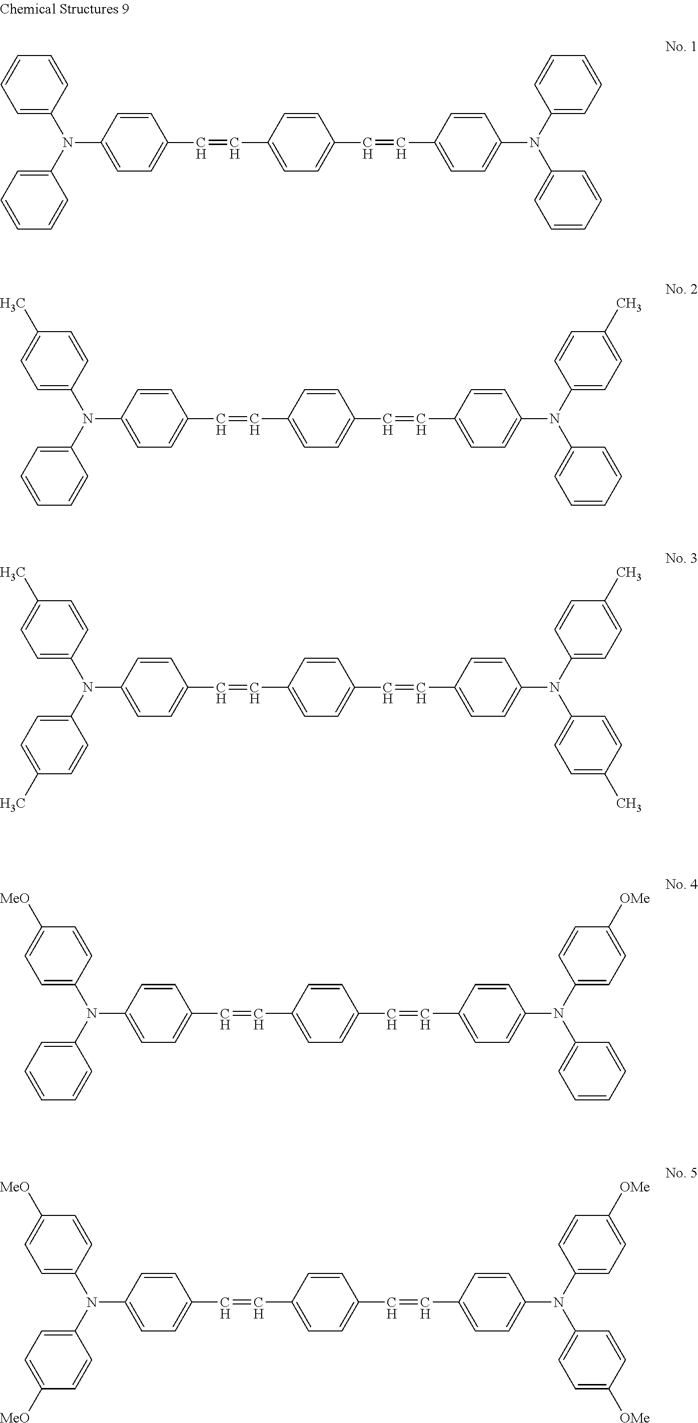

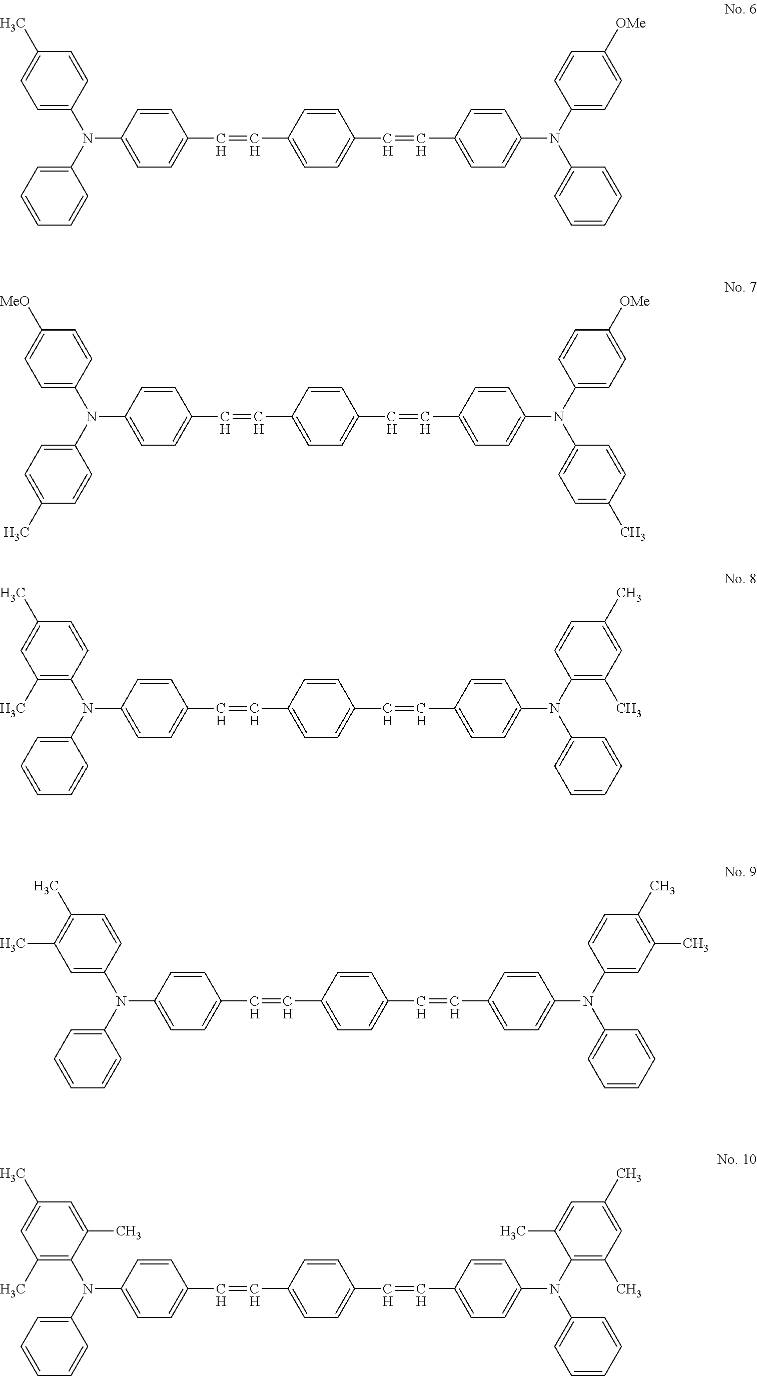

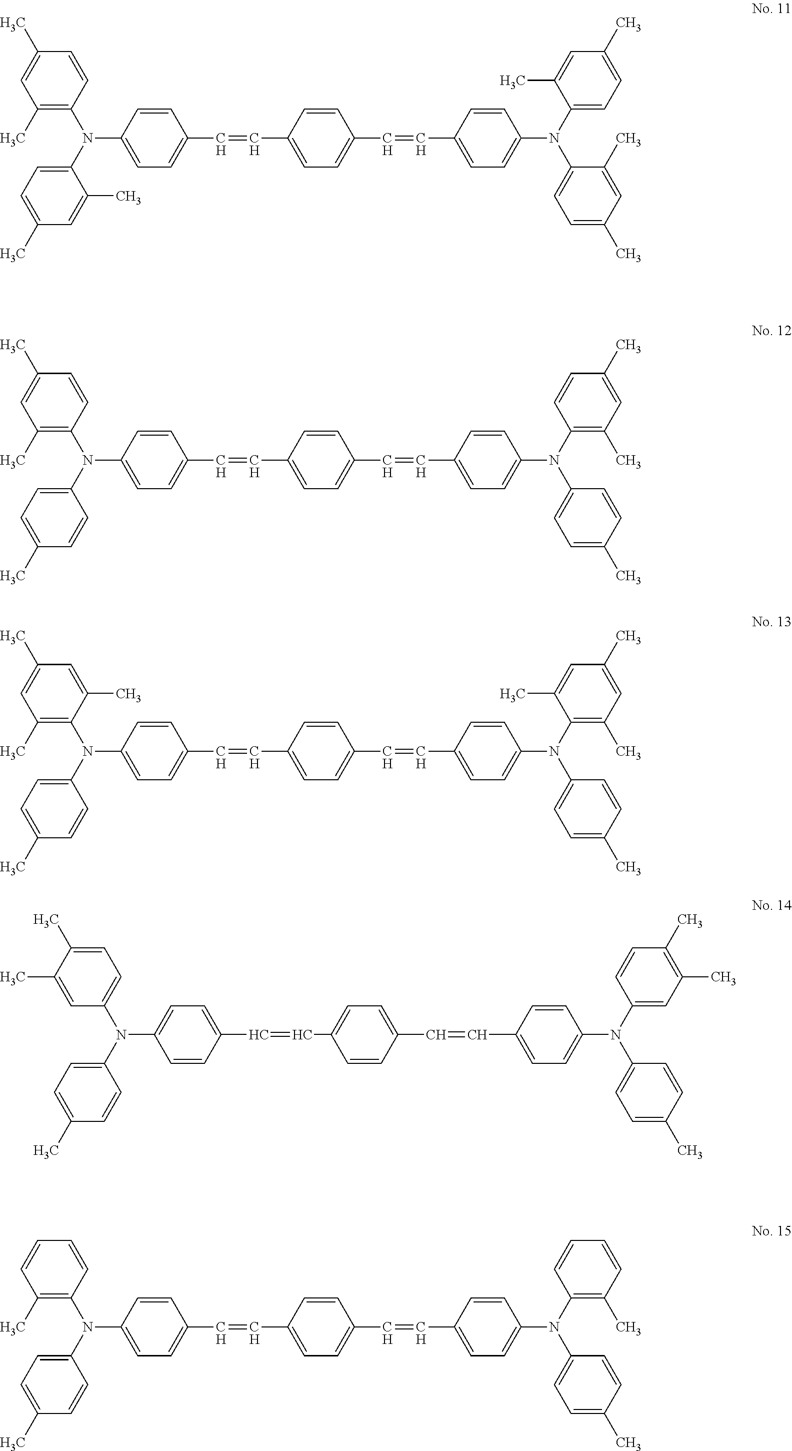

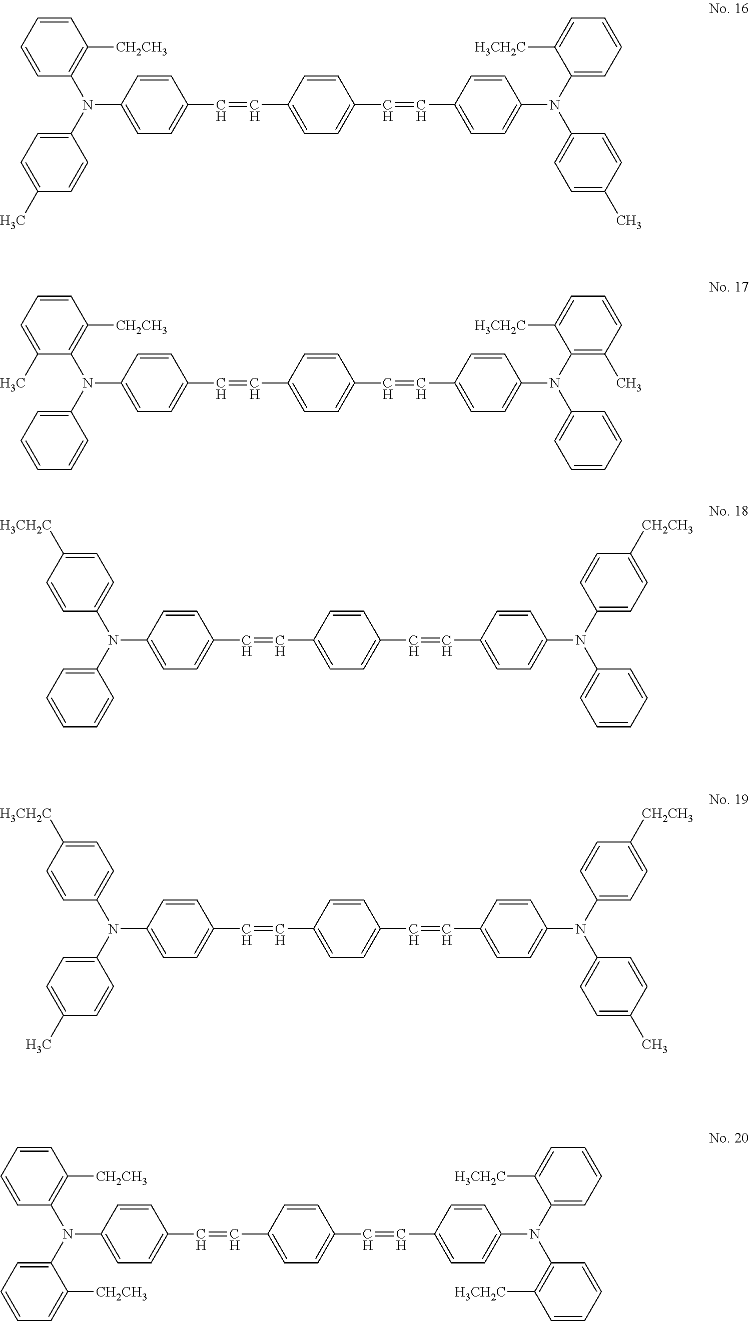

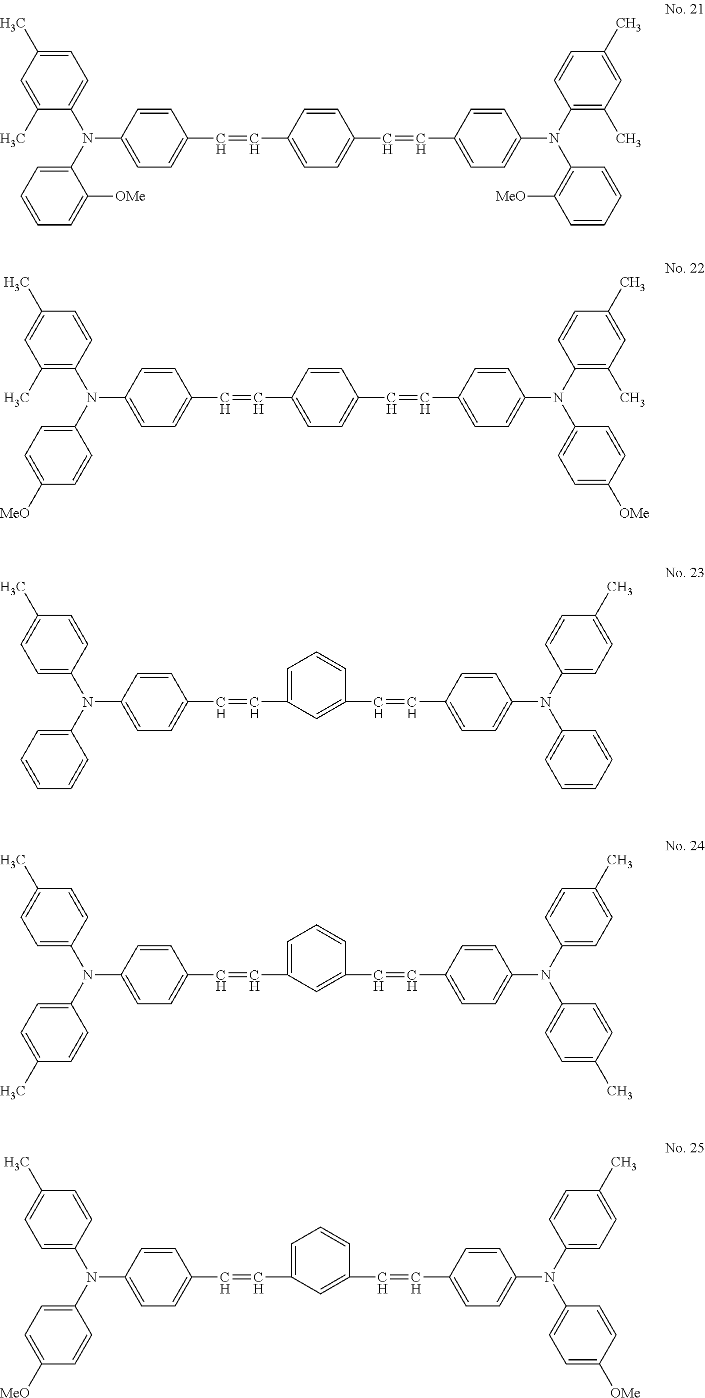

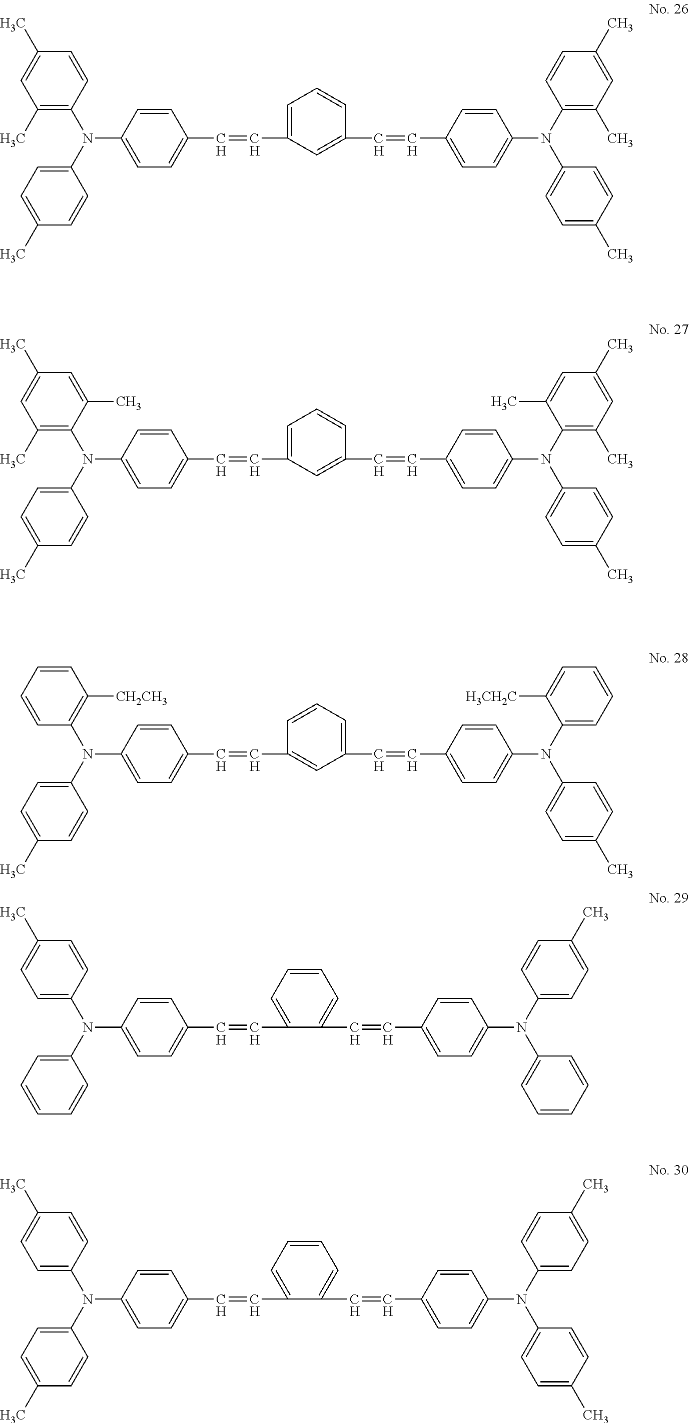

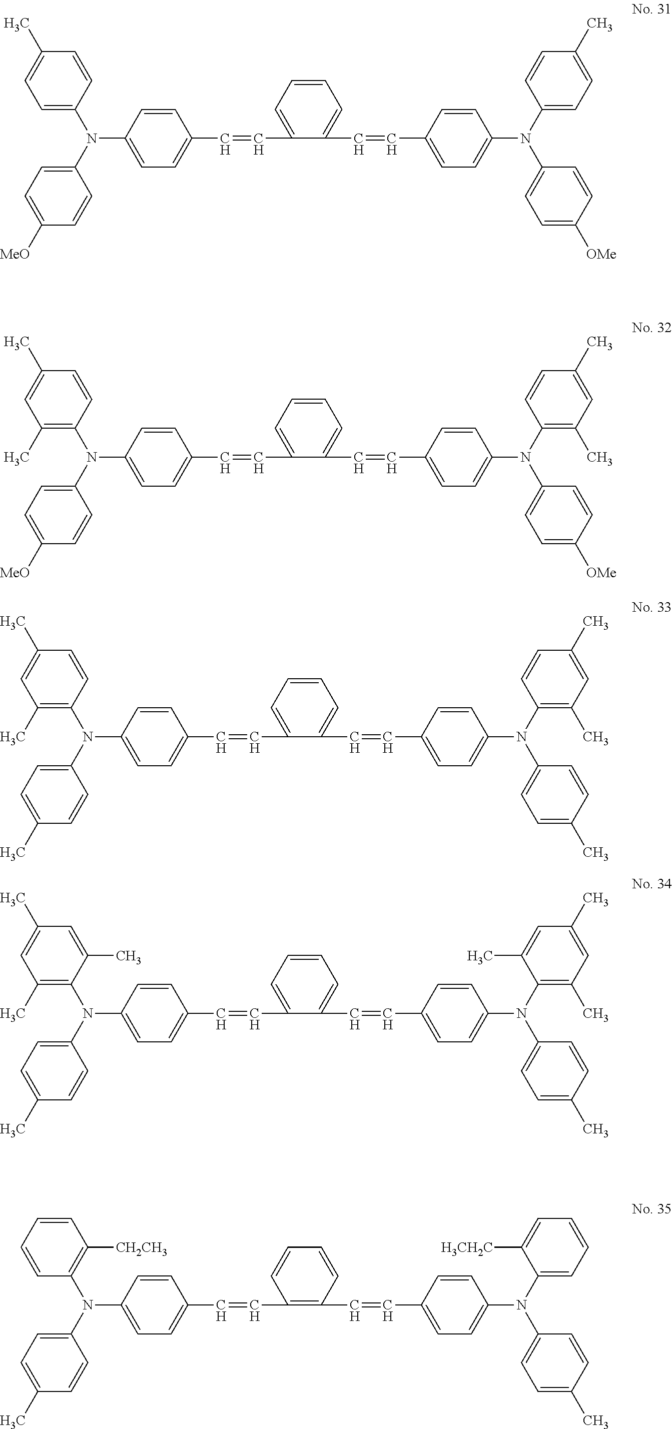

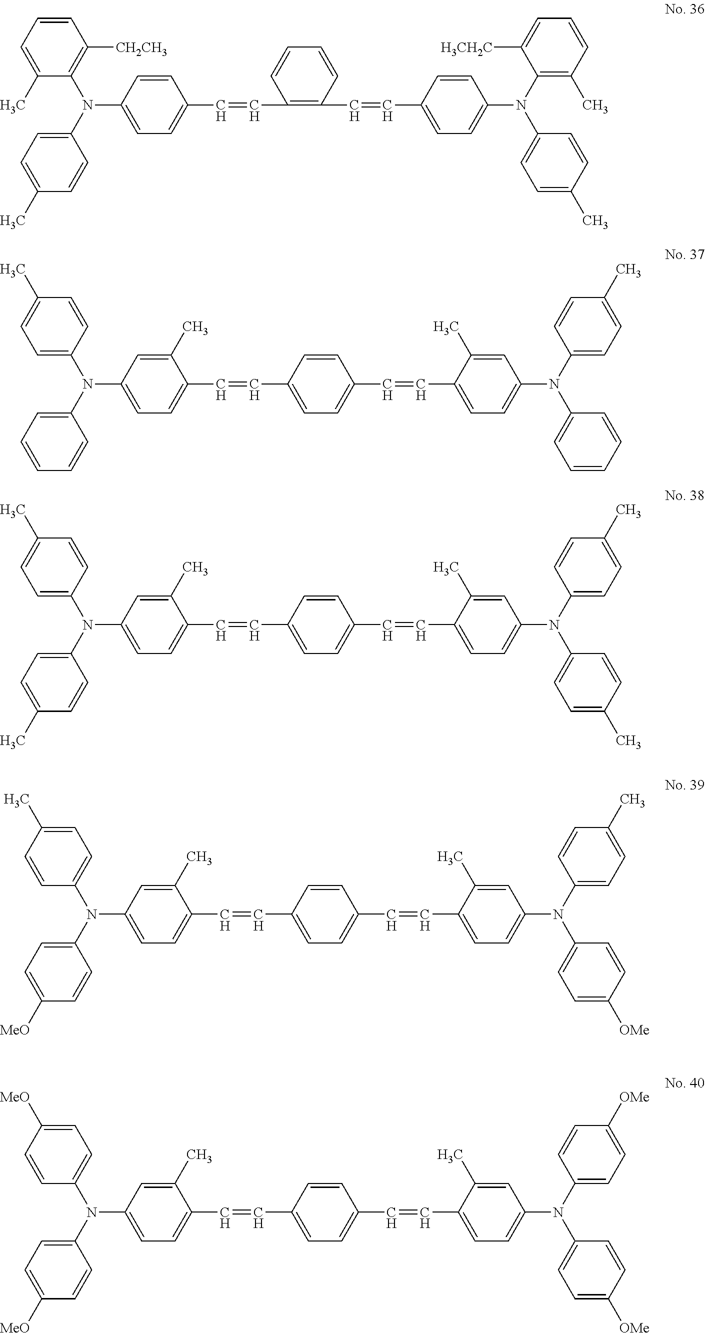

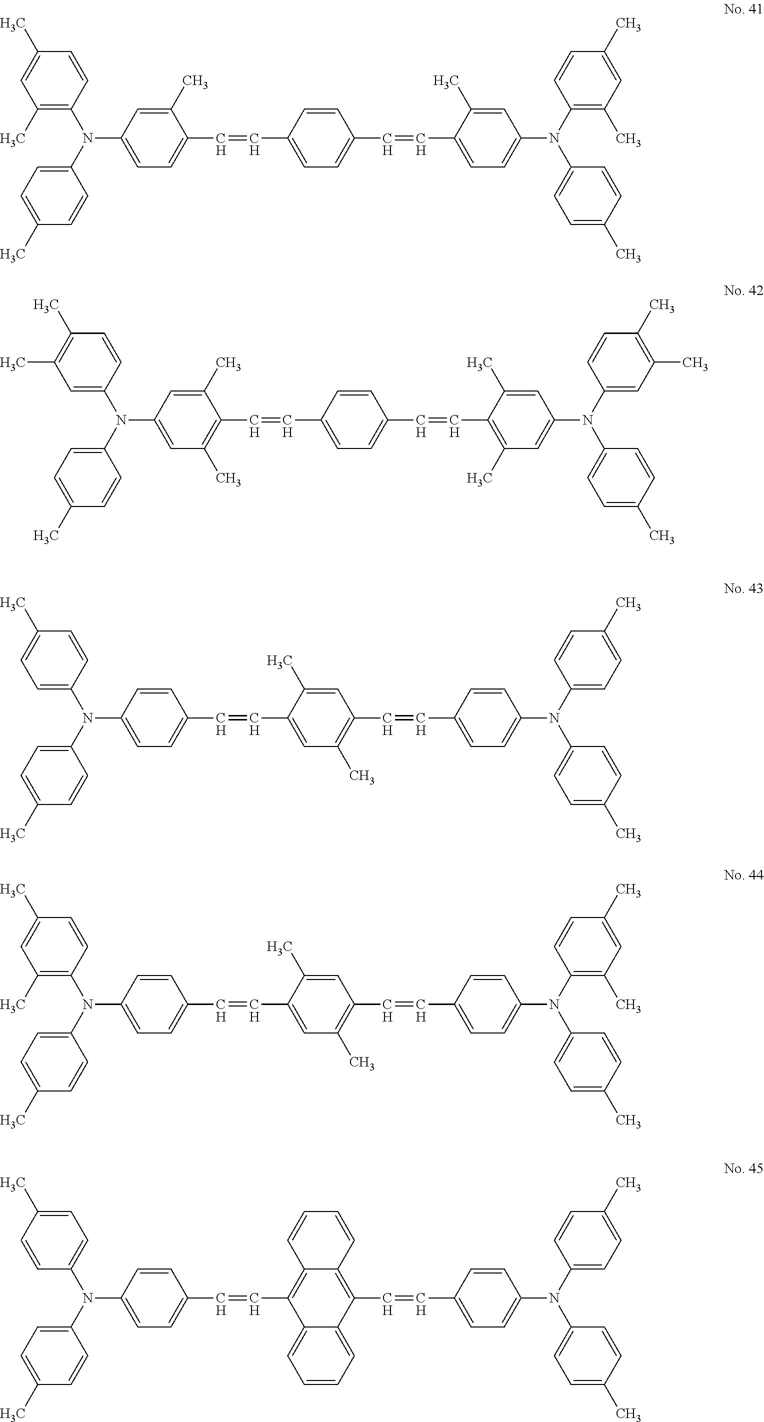

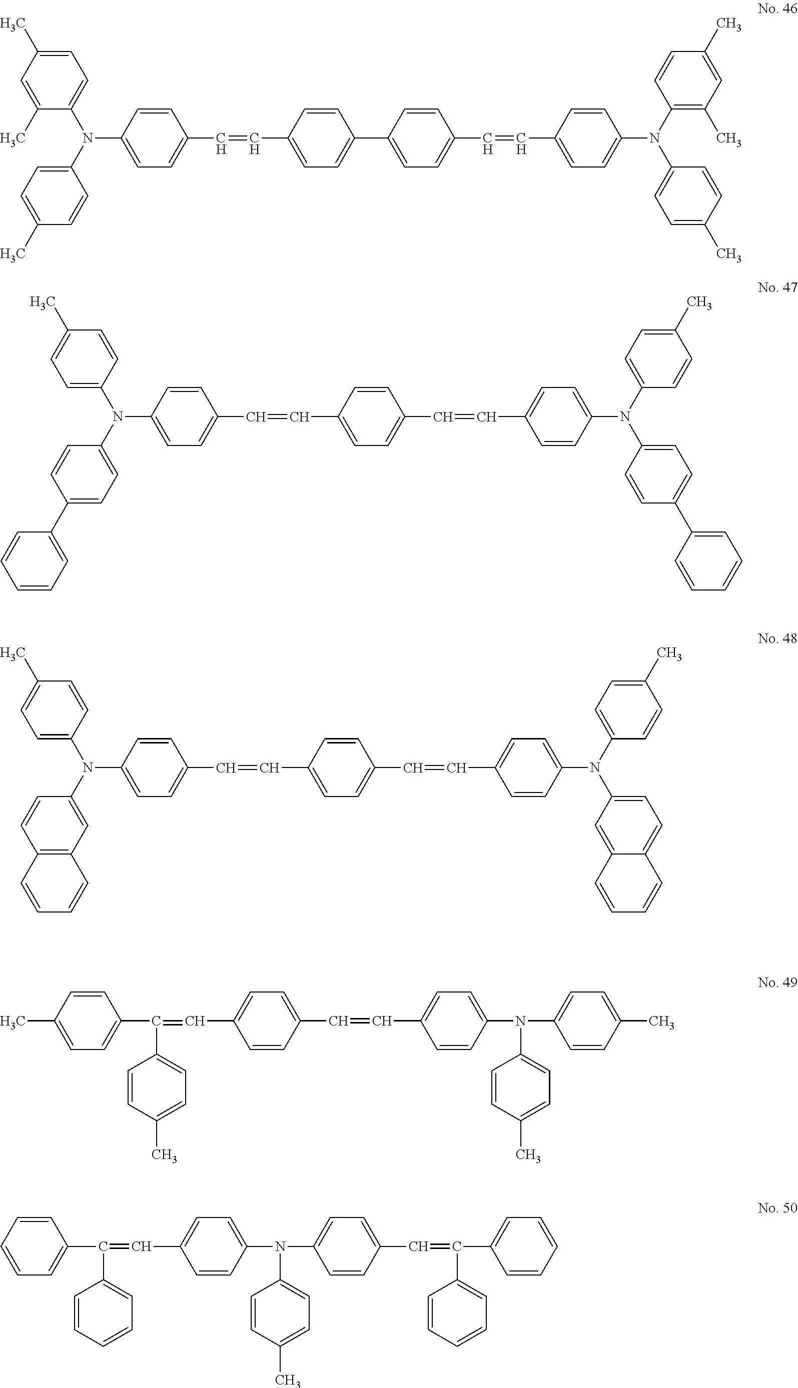

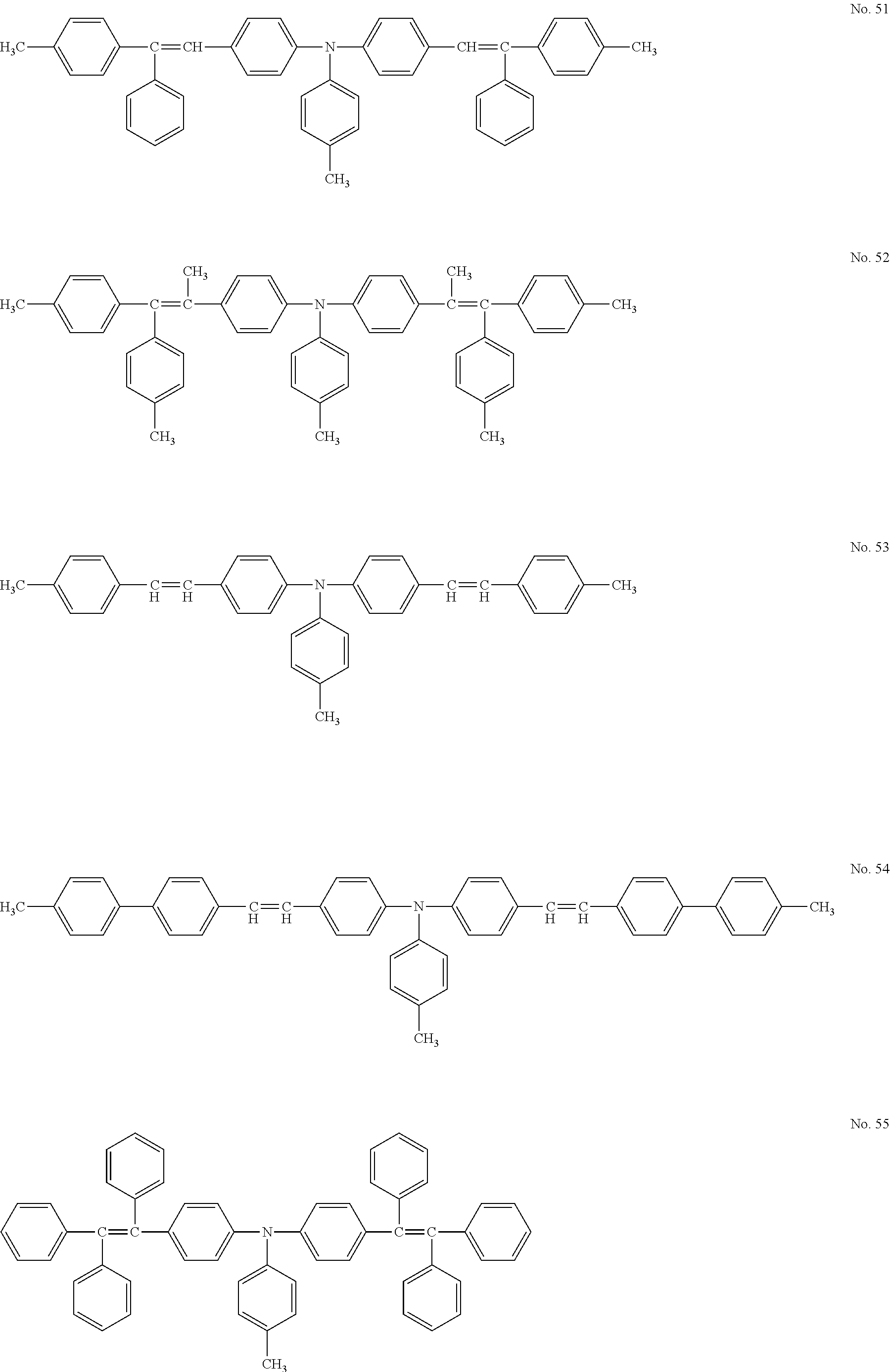

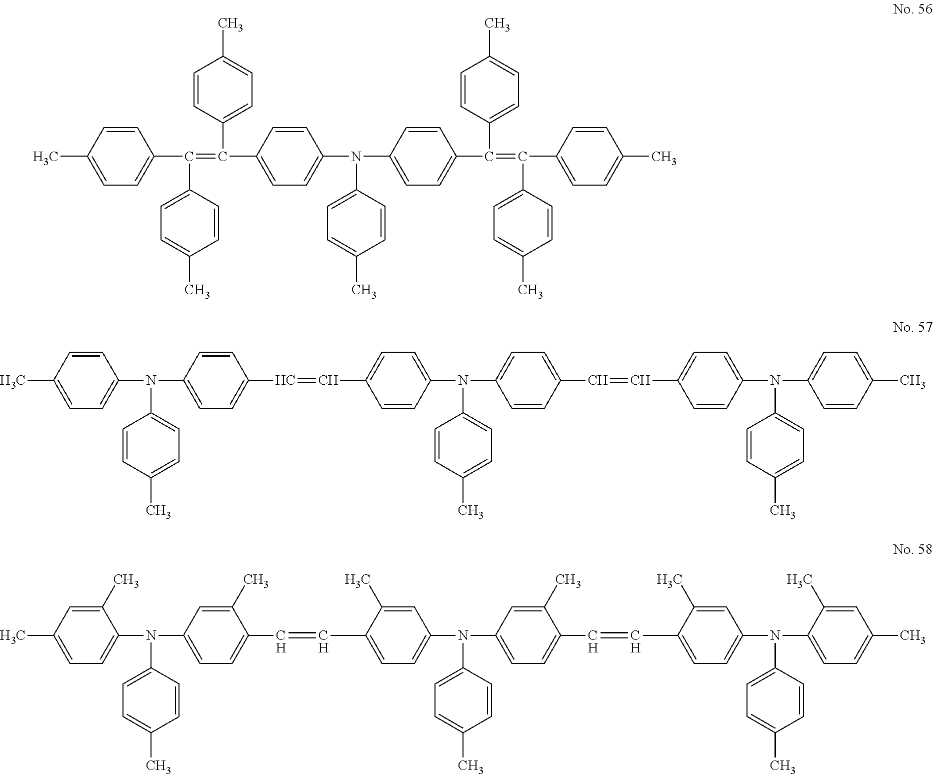

In the Chemical Structures 9, “Me” represents a methyl group.

In addition, there is no specific limitation to the content of the charge transport material in the charge transport layer. The content is preferably from 20 parts by weight to 300 parts by weight and more preferably from 40 parts by weight to 150 parts by weight based on 100 parts of the binder resin.

### Binder Resin

There is no specific limitation to the optional binder resins for use in the charge transport layer. Specific examples thereof include, but are not limited to, polycarbonate resins, styrene resins, acrylic resins, styrene-acrylic resins, ethylene-vinyl acetate resins, polypropylene resins, vinyl chloride resins, chlorinated polyether resins, vinyl chloride-vinyl acetate resins, polyester resins, furan resins, nitrile resins, alkyd resins, polyacetal resins, polymethyl pentene resins, polyamide resins, polyurethane resins, epoxy resins, polyarylate resins, diarylate resins, polysulfone resins, polyether sulfone resins, polyaryl sulfone resins, silicone resins, ketone resins, polyvinyl butyral resins, polyether resins, phenol resins, ethylene∀vinyl acetate∀copolymer (EVA) resins, acrylo nitrile, chlorinated polyethylene, and styrene (ACS) resins, acrylo nitrile, butadiene, and styrene (ABS), and epoxy acrylate resins. Among these, polycarbonate resins and polyarylate resins are preferable. These can be used alone or in combination.

There is no specific limitation to the forming method of the charge transport layer. Typically, a liquid application in which a charge transport material and an additive are dissolved or dispersed in a solvent together with a resin is applied to the charge generating layer described above followed by drying.

There is no specific limitation to the solvent. For example, the solvents specified in the description of the charge generating layer can be used.

There is no specific limitation to the average thickness of the charge transport layer. The charge transport layer preferably has an average thickness of from 5 μm to 50 μm and more preferably from 10 μm to 30 μm to maintain a practically good surface voltage.

### Other Components

There is no specific limitation to the other components and any known other components can be suitably used. Specific examples thereof include, but are not limited to, compounds having an alkylamino group, anti-oxidizing agents, and leveling agents.

### Compound Having Alkylamino Group

The compound having an alkylamino group is suitable to reduce the occurrence of image flow or prevent a decrease in the charge voltage in an atmosphere in which ozone and/or NOₓ have high concentration. The compound having an alkylamino group is particularly suitable in the case in which the compound for the charge transport material represented by the Chemical Structures 4, 7, and 8 is used for the charge transport layer.

By mixing the charge transport material and the compound having an alkylamino group, the occurrence of image flow and the decrease in the resolution in an atmosphere of an oxidized gas and electrostatic deterioration such as charge reduction can be reduced. As a result, quality images can be produced. In addition, since the compound having an alkylamino group has a charge transport structure, it has little impact on the residual voltage so that the compound can be added in a relatively large amount.

Any compound having an alkylamino group in its molecule can be suitably used as the compound having an alkylamino group. In particular, the compounds represented by the Chemical Structure 10 and the compounds represented by the Chemical Structure 11 are preferable.

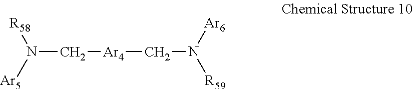

In the Chemical Structure 10, Ar₄ represents a substituted or non-substituted arylene group. AR₅ and AR₆ independently represent substituted or non-substituted aryl groups, substituted or non-substituted alkyl groups, substituted or non-substituted aralkyl groups. R₅₈ and R₅₉ independently represent substituted or non-substituted alkyl groups and substituted or non-substituted aralkyl groups. AR₅ and R⁵⁸ and AR₆ and R⁵⁹ optionally and independently share bond connectivities to form substituted or non-substituted heterocyclic rings containing a nitrogen atom.

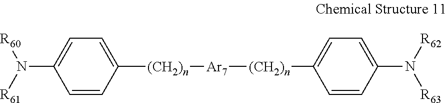

In the Chemical Structure 11, Ar₇ represents a substituted or non-substituted arylene group. R₆₀ to R₆₃ independently represent substituted or non-substituted alkyl groups and substituted or non-substituted aralkyl groups. “n” represents an integer of 1 or 2.

Specific examples of the compound having an alkylamino group include, but are not limited to, the compounds represented by the Chemical Structures 12

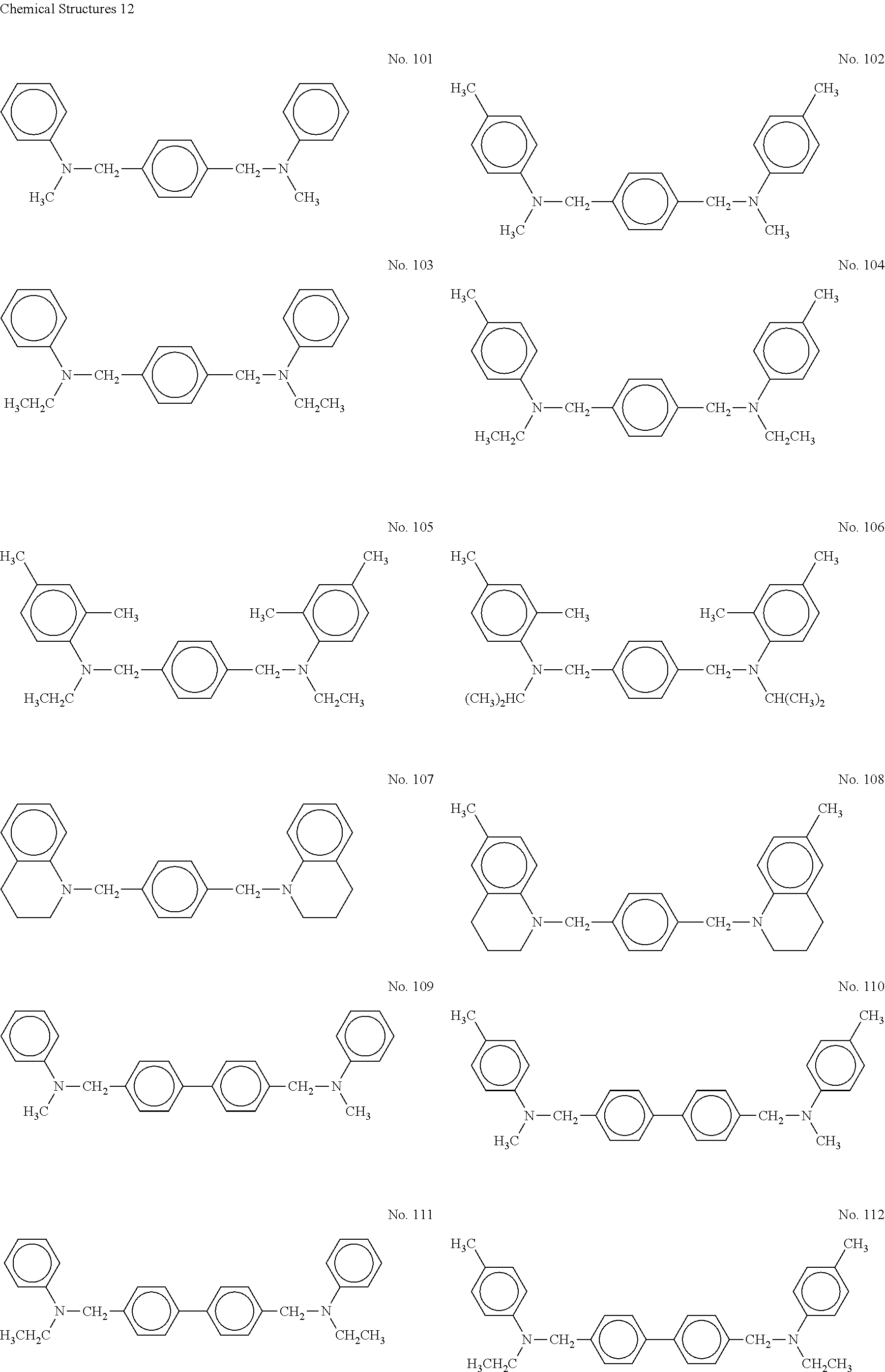

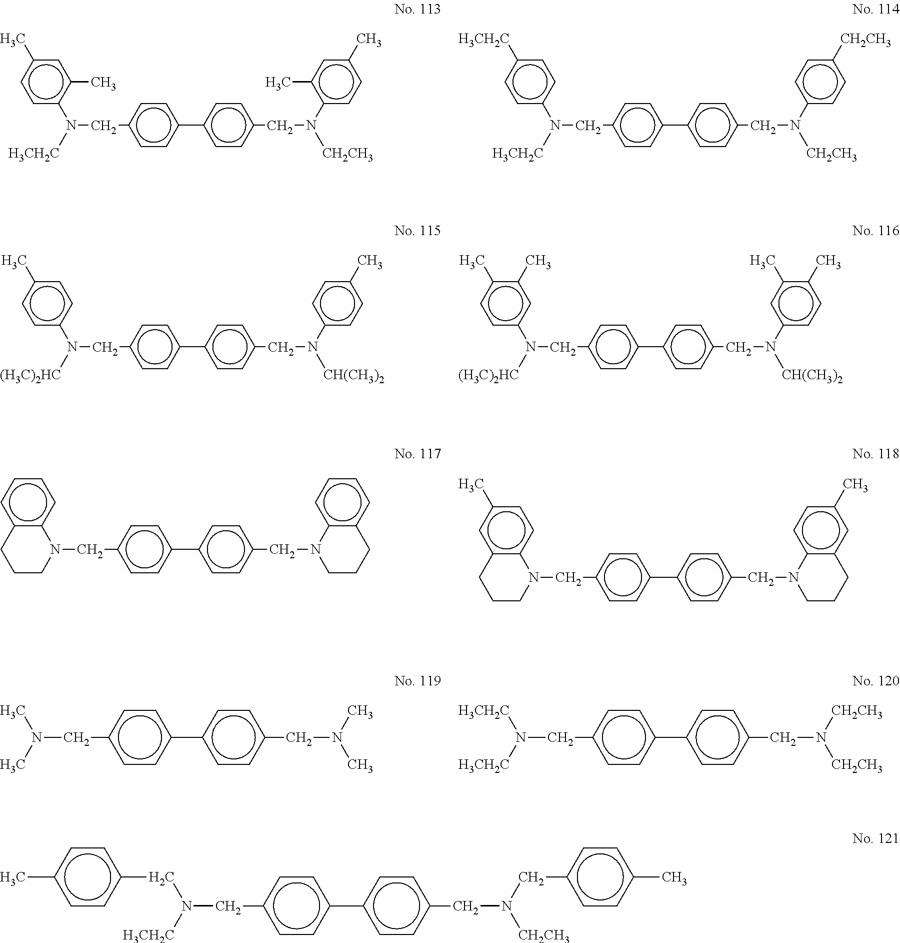

In addition, there is no specific limitation to the content of the compound having an alkylamino group in the charge transport layer. The content is preferably 30 parts by weight or less and more preferably from 1.0 parts by weight to 15 parts by weight based on 100 parts of the charge transport material. When the content is too large, the residual voltage tends to rise. When the content is too small, the resolution tends to decrease in an atmosphere of high concentration oxidized gas or cracking tends to occur by attachment of sebum.

### Anti-Oxidant

There is no specific limitation to the anti-oxidants. Specific examples thereof include, but are not limited to, phenol-based compounds, paraphenylene diamines, hydroquinones, organic sulfur compounds, organic phosphorus compounds, and hindered amines.

The anti-oxidant has a good impact on the stabilization of the electrostatic characteristics over repetitive use. Among the antioxidants, the anti-oxidants represented by the following Chemical Structures 13 are particularly preferable.

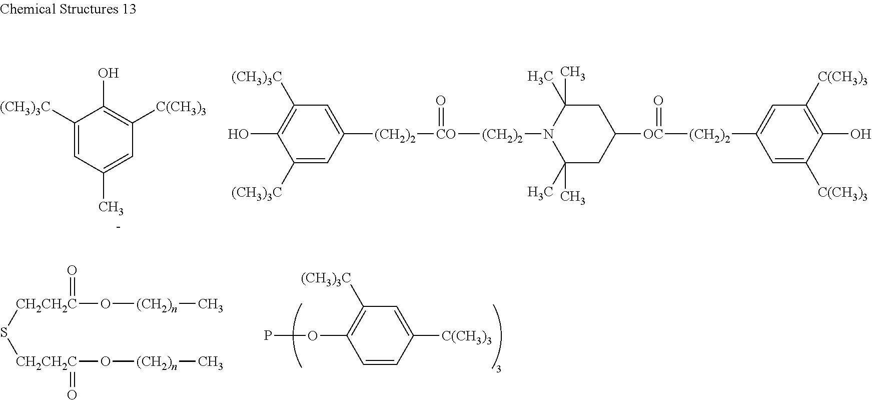

In the Chemical Structures 13, “n” represents an integer of from 12 to 18.

The charge transport materials represented by the Chemical Structures 4, 7, and 8 tend to be unstable in an oxidized gas atmosphere. However, these anti-oxidants can be suitably used in an oxidized gas atmosphere to prevent the charge reduction and occurrence of image blur, resulting in production of quality images. In the present disclosure, by using such anti-oxidants in combination, the effect of the anti-oxidants increases. Moreover, by mixing these anti-oxidants with the compound represented by the Chemical Structures 10 and 11, the effect increases furthermore. This is because these materials have different structures and demonstrate different effects. These have different features depending on the kinds of the materials. These features are, for example: anti-oxidizing against ozone produced by a charger; reducing charging reduction caused by releasing of accumulated charges in the photosensitive layer due to electrostatic fatigue; preventing image flow and reduction of resolution; and reducing occurrence of ghost. Therefore, a mixture thereof demonstrates many features so that quality images can be stably provided in any environment.

### Leveling Agent

There is no specific limitation to the leveling agent mentioned above. Specific examples thereof include, but are not limited to, silicone oils such as dimethylsilicone oil and methylphenyl silicone oil and polymers and oligomers having a perfluoroalkyl group in the side chain.

There is no specific limitation to the content of the leveling agent in the charge transport layer. The content is preferably 1 part by weight or less and more preferably from 0.01 parts by weight to 0.5 parts by weight based on 100 parts by weight of the binder resin mentioned above. When the content is within the preferable range mentioned above, it is possible to prevent the film application deficiency of the photosensitive layer and the charge transport layer to form a smooth layer.

### Photosensitive Layer Having Single Layer Structure

In the present disclosure, a photosensitive layer having a single layer structure can be used. The single layered photosensitive layer is formed by dissolving and/or dispersing a charge generating material, a charge transport material, a binder resin, etc, in a suitable solvent and applying the resultant liquid to the hollow cylinder sleeve member or the undercoating layer followed by drying. The charge generating material and the charge transport material (electron transport material and positive hole transport material) specified for the charge generating layer and the charge transport layer can be used in the single-layered photosensitive layer.

With regard to the binder resin, in addition to the binder resin specified for the charge transport layer, the binder resin specified for the charge generating layer can be mixed for use. In addition, a charge transport polymer can be used as the resin.

There is no specific limitation to the content of the charge generating material in the single-layered photosensitive layer. The content is preferably from 5 parts by weight to 40 parts by weight and more preferably from 10 parts by weight to 30 parts by weight based on 100 parts of the resin.

There is no specific limitation to the content of the charge transport material in the single-layered photosensitive layer. The content is preferably 190 parts by weight or less and more preferably from 50 parts by weight to 150 parts by weight based on 100 parts of the resin.

The single-layered photosensitive layer can be formed by dissolving and/or dispersing the charge generating material, the charge transport material, and the binder resin in a solvent such as tetrahydrofuran, dioxane, dichloroethane, methylethylketone, cyclohexanone, toluene, and acetone followed by application using a known method such as a dip coating method, a spray coating method, a bead coating method, and a ring coating method. In addition, a plasticizer, a leveling agent, an anti-oxidant, a lubricant, etc. can be added to the solution or the liquid dispersion, if desired.

There is no specific limitation to the average thickness of the single-layered photosensitive layer. The single-layered photosensitive layer preferably has an average thickness of from 5 μm to 25 μm.

### Protective Layer

The protective layer includes at least a filler, preferably a cured resin, and other optional components. The protective layer is formed on the uppermost surface of the image bearing drum mentioned above.

### Surface Texture of Protective Layer

The surface of the protective layer having waviness has an arithmetical mean deviation of the assessed profile Wa (μm) of from 0.050 μm to 0.400 μm and a mean width of the profile elements WSm (mm) of from 0.500 mm to 1.500 mm, which are obtained from a waviness profile in which roughness components are blocked off by a λc profile filter of 0.25 mm and wavelength components longer than the waviness are blocked off by λf profile filter of 2.5 mm.

The λc profile filter, the λf profile filter, the arithmetical mean deviation of the assessed profile Wa, the mean width of the profile elements WSm are defined in JIS B0601:2001 or have the same meaning as defined therein.

The reason why the roughness components are blocked off by the λc profile filter is to know the roughness of the protective layer and the reason why the wavelength component longer than the waviness are blocked off by the λf profile filter is to know the waviness of the protective layer.

These setting values are confirmed to indicate the relationship between the roughness and the waviness of the protective layer most clearly.

The present inventors have found that the surface of the protective layer have both micro-roughness and large waving form by fillers so that the cleaning performance is significantly improved and deterioration of a cleaning unit is prevented, thereby sustaining good cleaning properties for an extended period of time.

In the cleaning process in the image forming process, due to the protective layer having the micro-roughness and the large waving form, the cleaning blade that contacts the image bearing member micro-vibrates on the surface of the image bearing member, which improves wiping-off of the remaining toner thereon. Furthermore, since the contact area between the image bearing member and the cleaning unit by the large waving form, deterioration of the cleaning unit is deterred.

The protective layer becomes extremely hard by the resin and the filler. Therefore, the image bearing member is prevented from abrasion and damage, resulting in making the large waving form to sustain for an extended period of time.

The present inventors have found that the cleaning performance is improved when the waving form of the surface of the protective layer is that the arithmetical mean deviation of the assessed profile Wa is of from 0.050 μm to 0.400 μm and the mean width of the profile elements WSm is from 0.500 mm to 1.500 mm.

When the arithmetical mean deviation of the assessed profile Wa is too large, the thickness of the protective layer tends to vary, which causes non-uniform image density in the image forming process. In addition, the protective layer is formed by a spraying method in most cases. When the arithmetical mean deviation of the assessed profile Wa is less than 0.300 μm, the production tact time tends to become long.

Therefore, an arithmetical mean deviation of the assessed profile Wa that is 0.300 μm or greater is preferable in terms of the productivity and the stability during manufacturing. However, the vibration of the cleaning unit to obtain the quality of images on a par with the production printing tends to increase the vibration of the image bearing member, which leads to non-uniform image density.

Therefore, when the arithmetical mean deviation of the assessed profile Wa is 0.300 μm or greater, it is particularly necessary to reduce the vibration of the image bearing member.

This vibration can be reduced by using the flange members. The mechanism of reducing the vibration of the image bearing member ascribable to the micro-vibration of the cleaning unit is inferred that the flange members having the shock-absorbing hole absorbs the vibration. Therefore, the vibration of the image bearing member is reduced, thereby resulting in the reduction of the non-uniform image density.

When the arithmetical mean deviation of the assessed profile Wa is too small, the waviness of the protective layer is excessively small so that the vibration of the cleaning unit accordingly decreases. Therefore, the cleaning performance is not significantly improved. When the mean width of the profile elements WSm is too large, the waviness tends to have a large amplitude so that the micro-vibration of the cleaning blade decreases. Therefore, the cleaning performance is not significantly improved. When the mean width of the profile elements WSm is too small, the cleaning device (unit) tends not to vibrate, thereby degrading the cleaning performance and causing the cleaning blade to easily turn inward and outward. With regard to the waving form of the protective layer, it is preferable that the arithmetical mean deviation of the assessed profile Wa (μm) is from 0.100 μm to 0.300 μm and the mean width of the profile elements WSm is from 0.600 mm to 1.300 mm and more preferable that the arithmetical mean deviation of the assessed profile Wa (μm) is from 0.130 μm to 0.270 μm and the mean width of the profile elements WSm is from 0.700 mm to 1.200 mm.

The arithmetical mean deviation of the assessed profile Wa and the mean width of the profile elements WSm are according to JIS B 0601:2001 and calculated from the waviness profile obtained from a waviness profile in which roughness components are blocked off by a λc profile filter of 0.25 mm and wavelength components longer than the waviness are blocked off by λf profile filter of 2.5 mm. The measuring conditions are that the reference length is 2.5 mm, the measuring length is 12.5 mm, and the measuring speed is 0.6 mm/s.

The arithmetical mean deviation of the assessed profile Wa and the mean width of the profile elements WSm are measured by, for example, a surface texture and contour measuring instrument (SURFCOM 1400D, manufactured by TOKYO SEIMITSU CO., LTD.). Any measuring instrument which is according to JIS and has the same measuring ability can be used.

There is no specific limitation to the measuring points and the number of measuring points. It is preferable to measure multiple points to reduce the measuring error. For example, for a cylindrical image bearing member, three points of the top end, the center, and the bottom end relative to the longitudinal direction and four points with a gap of 90° relative to the circumference direction for each of the three points, i.e., 12 points in total, are measured to calculate the average, which has a less measuring error. The measuring direction is along the shaft direction of the image bearing member.

There is no specific limitation to the method of controlling the surface form (texture), i.e., waviness, when forming the protective layer. For example, a spray coating method is preferable to control the waviness. The waviness can be controlled by the spray application conditions such as the atomization air pressure, the amount of discharging, the distance between the spray gun and the substrate, and the number of applications. In addition, between the spray application and the drying, the waviness of the protective layer may be formed by a solvent or air spraying.

To control the waviness by the prescription of the liquid application, a leveling agent or a solvent is added to the liquid application while adjusting the kind, the addition amount, and the density of the solid portion thereof. The waviness is controlled better by a combinational use of the prescription of the liquid application and the spraying application method.

A method of controlling the waviness is described below but the control method of the present disclosure is not limited thereto. When the protective layer is formed by the spraying application method and the waviness thereof is controlled, any spray gun can be used. A spray gun that can adjust the amount of discharging the liquid application, the atomization air flow amount, and the atomization air pressure, etc. is preferable.

Specific examples of the spray guns include, but are not limited to, air spray guns, airless spray guns, and electrostatic spray guns. Such spray guns can be placed on its side for use.

Products of such spray guns are available from the market and an example thereof is Air Spray A100 (manufactured by MEIJI AIR COMPRESSOR MFG. CO., LTD.).

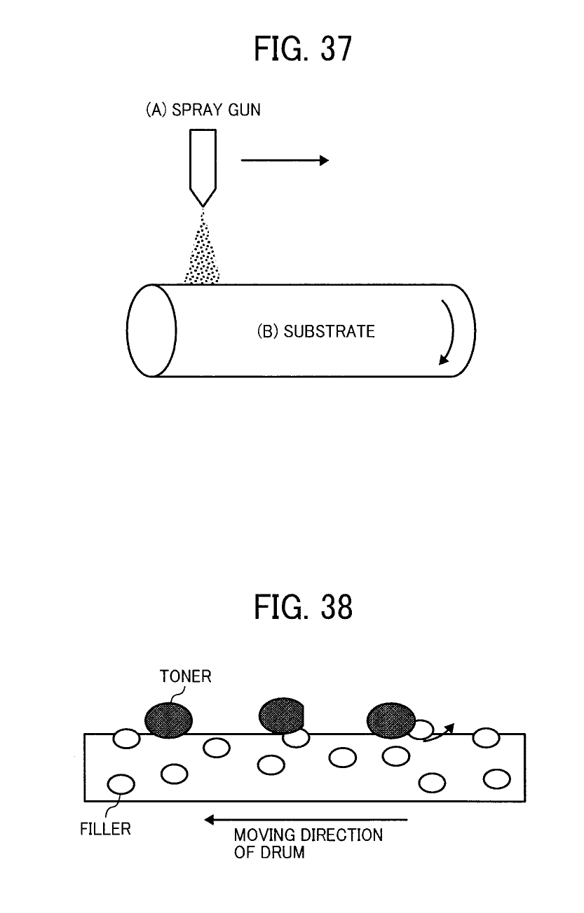

FIG. 37 is a schematic diagram illustrating the spray coating (application) method. A symbol “A” represents a spray gun and a symbol “B” represents a substrate (sleeve) subjected to spraying.

The sleeve B is a product in process of the image bearing member in which a photosensitive layer is applied to a sleeve. The sleeve B has a drum form. The sleeve B rotates in the direction indicated by the arrow by a driving device and the spray gun A applies the liquid application for the protective layer to the sleeve B while atomizing. The spray gun A slowly moves from the left end of the sleeve B in the direction indicated by the arrow to coat the sleeve B all over with the liquid application for the protective layer. The number of application to form the protective layer is arbitrary.

There is no specific limitation to the moving speed of the spray gun and the number of rotation of the sleeve. To prevent non-uniform coating, the moving speed of the spray gun is preferably 10 mm/s or less and the number of rotation of the sleeve is 80 rpm or more.

The distance between the spray gun and the sleeve is preferably from 20 mm to 100 mm and more preferably from 30 mm to 70 mm. When the distance is too short, non-uniform coating tends to occur. When the distance is too large, the attachment efficiency generally tends to deteriorate although it depends on the kind of the spray gun. If the distance between the spray gun and the sleeve is long, the solvent in the atomized droplet discharged from the spray gun easily evaporates so that the size of the droplet decreases, thereby making it difficult to form a waving form.

The amount of discharging the liquid application for the protective layer is 0.02 mL/s or more. When the amount of discharging is too small, the droplets tend to become narrow, thereby making it difficult to form a waving form. The amount of discharging can be controlled by the degree of nozzle opening of the spray gun, the extruding amount of the pump, etc.

In addition, the waviness can be formed by spraying a solvent or air to the protective layer which is still-wet after coating the liquid application for the protective layer to the sleeve. With regard to spraying the solvent, there is no specific limitation to the kind of the solvent but it is preferable to use a solvent having a low boiling point in order not for it to remain on the surface of the protective layer after spraying.

When the protective layer contains a cured resin (cross-linked resin), a process of cross-linking the applied layer is required after spraying the liquid application. The finger touch drying time between the spraying and cross-linking is preferably 10 minutes or less. When the finger touch drying time is too long, the applied layer is levelized so that the waving becomes small and may disappear.

By forming the particular waviness mentioned above on the surface of the protective layer, the cleaning device is micro-vibrated to conduct good cleaning performance. Furthermore, by using a resin in the protective layer and embedding fillers therein, the mechanical strength of the image bearing member increases, thereby improving the abrasion resistance thereof drastically so that the waviness of the protective layer can be sustained. Moreover, since the filler forms micro-roughness on the surface of the protective layer, the cleaning blade micro-vibrates more effectively.

Without the filler, the image bearing member is scraped over an extended period of time and the waviness disappears so that the cleaning performance gradually deteriorates.

To the contrary, when the filler is contained in the protective layer, the waviness is sustained over an extended period of time so that good cleaning performance is maintained over an extended period of time.

### Filler

When the filler is contained in the protective layer, the waviness is sustained over an extended period of time to keep good cleaning performance over an extended period of time. In addition to significant improvement on the abrasion resistance and the durability of the image bearing drum, the image bearing drum stably produces quality images during repetitive image formation processes over an extended period of time irrespective of the image area ratio.

There is no specific limitation to the selection of filler. Specific examples thereof include, but are not limited to, organic fillers and non-organic fillers.

Specific examples of the organic filler include, but are not limited to, fluorine resin powder of such as polytetrafluoroethylene, silicone resin powder, and a-carbon powder.

Specific examples of the inorganic fillers include, but are not limited to, powders of inorganic materials such as: metals such as copper, tin, aluminum, and indium; metal oxides such as silica, tin oxide, zinc oxide, titanium oxide, alumina, zirconia, indium oxide, antimony oxide, bismuth oxide, calcium oxide, tin oxide in which antimony is doped, and indium oxide in which tin is doped; metal fluorides such as tin fluoride, calcium fluoride, and aluminum fluoride, potassium titanate, and arsenic nitride.

The organic fillers tend to be better than the inorganic fillers with regard to the degree of the impact (shock such as vibration). However the organic filler is inferior to the inorganic filler in terms of the durability. When the organic filler is used, the applicability of lubricant materials tends to deteriorate in general.

By contrast, the inorganic filler has a high filler hardness and a high light scattering property, which is advantageous to improve the abrasion resistance and durability of the image bearing member and produce quality images. In addition, the inorganic filler is stable about the application amount of a lubricant material. Therefore, the inorganic filler is preferable and the metal oxide is more preferable. Among these, alumina is particularly preferable.

Furthermore, usage of the metal oxide is advantageous in terms of the quality as the layer of the protective layer in most cases.

Since the quality of the protective layer has a great impact on the image quality and abrasion resistance, forming a good protective layer is preferable to improve the durability and the image quality.

The metal oxides have greatly different specific resistances depending on the materials thereof. In the present disclosure, both a metal oxide having a low insulation property or specific resistance and a metal oxide having a high insulation property or specific resistance can be suitably used.

Specific examples of the metal oxide having a low insulation property or specific resistance includes, but are not limited to, tin oxide, indium oxide, antimony oxide, tin oxide in which antimony is doped, and indium oxide in which tin is doped. Specific examples of the metal oxide having a high insulation property or specific resistance includes, but are not limited to, alumina, zirconia, titanium oxide, and silica.

These are preferable to the metal oxide having a low insulation property or specific resistance because the resolution hardly decreases and image flowing hardly occur. However, the problem of the rise in the residual voltage may come to the surface as the content thereof in the protective layer increases.

Therefore, the metal oxide having a high insulation property or specific resistance is particularly suitable as the filler when the resin in the protective layer is a cured resin obtained by curing a polymerizable compound having no charge transport structure and a polymerizable compound having a charge transport structure.

Among these metal oxides, a-aluminum is highly light transmissive and stable against heat and has a hexagonal close-packed structure, which is excellent for abrasion resistance. Therefore, it can be preferably used to prevent the occurrence of image blur and improve the abrasion resistance and the quality of applied film of the protective layer, and have good light transmissiveness. Furthermore, α-aluminum is confirmed to be most suitable to stably supply a lubricant material to the surface of the protective layer.

When such a filler is contained in the protective layer, the degree of the good impact on the properties such as durability depends on the dispersibility of the filler. By improving the dispersibility and the dispersion stability of the filler in the dispersion state, the advantage is maintained at the layer formed by applying the filler. If the dispersibility of the filler deteriorates and the filler agglomerates, the contained filler is easily detached. Such a detached filler causes non-uniform abrasion or damages the surface of the image bearing member, thereby degrading the durability and producing defective images having spots or streaks locally.

In addition, it is probable that the amount of the supplied lubricant materials is locally dependent, meaning that the lubricant materials are not uniformly supplied to the surface of the image bearing drum.

Furthermore, such dispersion state of the filler may cause problems such that the cleaning blade chips off, the cleaning performance deteriorates, and the life of the liquid dispersion becomes shorter. Therefore, it is preferable to improve the dispersbility of the filler.

To improve the dispersbility of the filler, it is suitable to add a dispersant and/or a dispersing helper to the liquid application for the protective layer.

There is no specific limitation to the dispersant and the dispersing helper. It is preferable to make a selection in terms of the filler to be used in combination.

For example, when the metal oxide is used as the filler, the polycarboxylic compound is preferable as the dispersant and the polycarboxylic acid base wetting dispersant is more preferable. The polycarboxylic acid compound has both a hydrophilic group and a hydrophobic group so that it has affinity with a metal oxide having a hydrophilic surface and hydrophobic organic binder resin and organic solvent. Furthermore, since the wettability of the filler increases, the dispersibility and the dispersion stability are extremely improved.

The most characteristic thing about the polycarboxylic acid compound is a polycarboxylic acid structure having multiple carboxylic acid (groups).

Among the polycarboxylic acid compounds, the polycarboxylic acid base wetting dispersant is preferable. Any product of the polycarboxylic acid base wetting dispersant available from the market can be suitably used. Preferred specific examples thereof include, but are not limited to, BYK-P104 and BYK-P105 (both manufactured by BYK Chemie).

The polycarboxylic acid base wetting dispersant has a high acid value because it has carboxylic groups The polycarboxylic acid base wetting dispersant polycarboxylic acid compound is absorbed to the surface of the metal oxide that is hydrophilic and becomes a trap site of the charge because of its high acid value. Therefore, the polycarboxylic acid base wetting dispersant is expected to fill the trap site that causes a rise of the residual voltage. Therefore, even when a hydrophilic filler, which greatly affects the residual voltage, is contained in the liquid application, a synergy effect of significantly reducing the residual voltage and improving the dispersibility of the filler is obtained. JP-3802787-B describes these but does not describe cases of cured resins in detail. The acid value is defined by a number of mg of potassium hydroxide required to neutralize carboxyl groups contained in 1 g of a resin.

Also, the solvent used in dispersion has a large impact on the dispersiblity and the dispersion stability of the filler. Specific examples of the dispersion solvent of the filler include, but are not limited to, cyclohexanone, cyclopentanone, dioxane, tetrahydrofurane, methylethyl ketone, acetone, toluene, and xylene. These can be used alone or in combination.

Among these dispersion solvents, to improve the dispersibility and the dispersion stability, cyclohexanone and cyclopentanone are particularly preferable. These solvents have a tendency of remaining in the protective layer. Therefore, it is preferable to avoid using them in a large amount.

In addition, a combinational use of such a solvent and the polycarboxylic acid based wetting dispersant is extremely preferable in the present disclosure because the dispersion is significantly stabilized.

Furthermore, it is possible to conduct surface-treatment for the filler by at least one kind of surface preparation (treating) agents, which may improve the dispersibility and the dispersion stability.

There is no specific limitation to the surface preparation agent and any known surface preparation agent can be suitably selected.

There is no specific limitation to the average primary particle diameter of the filler. The filler preferably has an average primary particle diameter of from 0.1 μm to 1.0 μm and more preferably from 0.2 μm to 0.5 μm. When the average primary particle diameter is too small, the filler tends to agglomerate, thereby degrading the abrasion resistance. Furthermore, the supplying stability of the lubricant materials to the surface of the image bearing drum tends to deteriorate, which has an adverse impact with regard to filming, attachment of foreign objects, prevention of deterioration of the cleaning unit. When the average primary particle diameter is too large, the sedimentation of the filler tends to be accelerated, thereby shortening the life of the liquid dispersion.

Alternatively, even though the supplying stability of the lubricant materials is improved, uniform supplying thereof all over the surface may be sacrificed. Therefore, the quality of images may be inferior or defective images may be produced over repetitive use.

Furthermore, the impact (shock such as vibration) may increase over repetitive use, which leads to occurrence of non-uniform abrasion.

The average primary particle diameter means the particle diameter of the average primary particle diameter representing a particle group and is represented by the number average particle diameter.

The average primary particle diameter of the filler is obtained by averaging the primary particle diameters of 50 filler particles obtained by observing them with electron microscope (S-4200, manufactured by Hitachi Ltd.).

There is no specific limitation to the content of the filler in the protective layer. The content is preferably from 0.1% by weight to 50% by weight and more preferably from 5% by weight to 20% by weight. When the content is too small, the amount of scraped protective layer tends to increase. When the content is too large, the voltage after exposure tends to rise, the resolution tends to decrease, and image flow easily occurs.

Also, the filler tends to detach from the protective layer, thereby significantly degrading the abrasion resistance. Furthermore, the impact (shock such as vibration) increases over repetitive use, which leads to occurrence of non-uniform abrasion. When the content is within the preferable range, it is advantageous to have a good combination of reduction in the amount of scraped protective layer and optimization of the voltage after exposure.

FIG. 38 is a schematic diagram illustrating the protective layer in which the filler is dispersed.

### Cured Resin

Since the protective layer contains the cured resin, an image bearing drum is obtained which has excellent durability with a less abrasion amount.

There is no specific limitation to the cured resin. It is preferable to obtain the cured resin by curing a polymerizable compound having at least three polymerizable functional groups with no charge transport structure and more preferable to cure a polymeriable compound having a charge transport compound and a polymerizable compound having at least three polymerizable functional groups with no charge transport structure. The cured resin is a cross-linked resin having a three-dimensional networking structure.

Polymerizable Compound Having at Least Three Functional Group with No Charge Transport Structure

When a polymerizable compound having at least three polymerizable functional groups with no charge transport structure is cured, a three dimensional network structure is developed so that a layer having a high hardness and a high elasticity with an extremely high cross-linking density is obtained. In addition, the resultant layer demonstrates a high abrasion resistance and damage resistance (durability).

However, since a great number of bondings are formed instantly in the curing reaction depending on the curing condition and materials, volume contraction or internal stress may occur, which leads to cracking or peeling-off of the layer. If this is true, a radical polymerizable compound having one or two functional groups can be used in combination to avoid such cracking and peeling-off in some cases.

As the polymerizable compound having at least three polymerizable functional groups with no charge transport structure, for example, compounds having three or more acryloyloxy groups with no charge transport structure and compounds having three or more methacryloyloxy groups with no charge transport structure are suitable.

The compound having at least three acryloyloxy groups with no charge transport structure is obtained by conducting ester reaction or ester conversion reaction using, for example, a compound having at least three hydroxyl groups therein, an acrylic acid (salt), a halide acrylate, and an ester of acrylate. The compound having at least three methacryloyloxy groups with no charge transport structure is obtained in the same manner. In addition, the polymerizable functional groups in the monomer having at least three polymerizable functional groups in the compound can be identical or different from each other.

Specific examples of the polymerizable compounds having at least three methacryloyloxy groups with no charge transport structure include, but are not limited to, trimethylol propane triacrylate (TMPTA), trimethylol propane trimethacrylate, HPA modified trimethylol propane triacrylate, trimethylol propane ethyleneoxy (EO) modified triacrylate, propyleneoxy (PO) modified trimethylol propane triacrylate, trimethylol propane caprolactone-modified triacrylate, pentaerythritol triacrylate, pentaerythritol tetra acrylate (PETTA), glycerol triacrylate, glycerol epichlorihydrine (ECH) modified triacrylate, glycerol EO modified triacrylate, glycerol PO modified triacrylate, tris (acryloxyethyl) isocyanulate, dipenta erythritol hexacrylate (DPHA), dipenta erythritol caprolactone modified hexacrylate, dipenta erythritol hydroxyl penta acrylate, alkylized dipenta erythritol penta acrylate, alkylized dipenta erythritol tetra acrylate, alkylized dipenta erythritol triacrylate, dimethylol propane tetracrylate (DTMPTA), penta erythritol ethoxy tetracrylate, phosphoric acid EO modified triacrylate, and 2,2,5,5-tetrahydroxy methyl cyclopentanone tetracrylate. In addition, methacrylates thereof are also included. These can be used alone or in combination.

In addition, the polymerizable compounds having at least three methacryloyloxy groups with no charge transport structure preferably has a ratio (molecular weight/the number of polymerizable functional groups) of the molecular weight to the number of functional groups in the polymerizable compound of 250 or less to form a dense cross-linking bonds in the protective layer. When the ratio (molecular weight/the number of functional groups) is too large, the formed protective layer is soft at the surface and thus the abrasion resistance thereof tends to slightly deteriorate. Therefore, among the monomers specified above, a sole use of the monomer having an extremely long modified (e.g., EO, PO, caprolactone-modified) group is not suitable.

There is no specific limitation to the component ratio in the protective layer formed by using the polymerizable compound having at least three methacryloyloxy groups with no charge transport structure. The content is preferably from 20% by weight to 80% by weight and more preferably from 30% by weight to 70% by weight based on the total amount of the entire protective layer.

When the component ratio is too small, the density of three-dimensional cross-linking bond in the protective layer tends to be low. Therefore, the abrasion resistance thereof is not drastically improved in comparison with a case in which a typical thermoplastic binder resin is used. When the component ratio is too large, the content of the polymerizable compound having a charge transport structure tends to decrease, thereby significantly raising the residual voltage. Desired electrical characteristics and abrasion resistance vary depending on the process.

Therefore, it is difficult to jump to any conclusion but considering the balance of the combination of both, the range of from 30% by weight to 70% by weight is more preferable.

### Polymerizable Compound Having Charge Transport Structure

The polymerizable compound having a charge transport structure is, for example, a compound having one or more polymerizable functional group and both a positive hole transport structure such as triaryl amine, hydrazone, pyrazoline, and carbazole and an electron transport structure such as condensed polycyclic quinone, diphenoquinone, an electron absorbing aromatic ring having a cyano group, and an electron absorbing aromatic ring having a nitro group.

There is no specific limitation to the selection of the polymerizable functional group. Acryloyloxy group and methacryloyloxy group are preferable.

A polymerizable compound having two or more polymerizable functional groups with a charge transport structure can be used in combination as the polymerizable compound having a charge transport structure. However, while such a polymerizable compound having two or more polymerizable functional groups with a charge transport structure has a high cross-linking density due to the multiple bondings in the cross-linking structure, the layer structure tends to be greatly distorted since the charge transport structure is extremely bulky, thereby increasing the internal stress in the layer. In addition, the structure of the intermediary body (cation radical) during charge transport is not stabilized. This leads to deterioration of the sensitivity due to the charge trap and a rise of the residual voltage.

Therefore, as the polymerizable compound having a charge transport structure, a polymerizable compound having a single polymerizable functional group with a charge transport structure is preferable.

Any charge transport structure that can impart a charge transport feature is suitable. Triaryl amine structure is preferable to obtain an excellent charge transport feature.

As the polymerizable compound having a single polymerizable functional group with a charge transport structure, the compound represented by the following Chemical Structure 14 and the compound represented by the following Chemical Structure 15 are preferable in terms of improvement on the electrostatic characteristics such as the sensitivity, the residual voltage, and the chargeability.

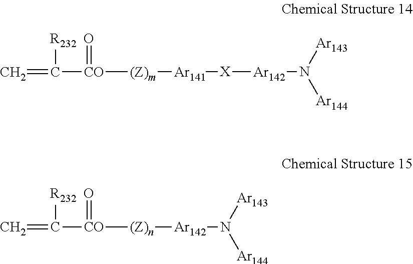

In the Chemical Structure 14 and 15, R₂₃₂ represents a hydrogen atom, a halogen atom, a substituted or non-substituted alkyl group, a substituted or non-substituted aralky group, a substituted or non-substituted aryl group, a cyano group, a nitro group, an alkoxy group, —COOR₂₄₁ (where R₂₄₁ represents a hydrogen atom, a substituted or non-substituted alkyl group, a substituted or non-substituted aralkyl group, or a substituted or non-substituted aryl group), a halogenated carbonyl group or CONR₂₄₂R₂₄₃ (wherein R₂₄₂ and R₂₄₃ independently represent hydrogen atoms, halogen atoms, substituted or non-substituted alkyl groups, substituted or non-substituted aralkyl groups or substituted or non-substituted aryl groups). Ar₁₄₁ and Ar₁₄₂ independently represent arylene groups. Ar₁₄₃ and Ar₁₄₄ independently represent substituted or non-substituted aryl groups. X represents a single bond, a substituted or non-substituted alkylene group, a substituted or non-substituted cycloalkylene group, a substituted or non-substituted alkylene ether group, an oxygen atom, a sulfur atom, or a vinylene group. Z represents a substituted or non-substituted alkylene group, a substituted or non-substituted divalent alkylene ether group, or a divalent alkyleneoxy carbonyl group. m and n independently represent 0 or integers of from 1 to 3.

In the Chemical Structures 14 and 15, specific examples of the alkyl groups of R₂₃₂ include, but are not limited to, a methyl group, an ethyl group, a propyl group, and a butyl group. Specific examples of the aryl groups of R₂₃₂ include, but are not limited to, a phenyl group and a naphtyl group. Specific examples of the aralkyl groups of R₂₃₂ include, but are not limited to, a benzyl group, a phenethyl group, a naphtyl methyl group. Specific examples of the alkoxy group of R₂₃₂ include, but are not limited to, a methoxy group, an ethoxy group, and a propoxy group. These can be substituted by a halogen atom, a nitro group, a cyano group, an alkyl group such as a methyl group and a ethyl group, an alkoxy group such as a methoxy group and an ethoxy group, an aryloxy group such as a phenoxy group, an aryl group such as a phenyl group and a naphtyl group, and an aralkyl group such as a benzyl group and a phenethyl group. A hydrogen atom and a methyl group are preferable as R₂₃₂.

Ar₁₄₃ and Ar₁₄₄ independently represent a substituted or non-substituted aryl group. Specific examples thereof include, but are not limited to, condensed polycyclic hydrocarbon groups, non-condensed cyclic hydrocarbon groups, and heterocyclic groups.

Specific examples of the condensed polycyclic hydrocarbon groups include, but are not limited to, a group which has a ring having 18 or less carbon atoms such as an indenyl group, a naphtyl group, an azulenyl group, a heptalenyl group, a biphenylenyl group, an as-indacenyl group, an s-indacenyl group, a fluorenyl group, an acenaphtylenyl group, a pleiadenyl group, an acenaphtenyl group, a phenalenyl group, a phenanthryl group, an anthryl group, a fluorantenyl group, an acephenantrirenyl group, an aceantrirenyl group, a triphenylene group, a pyrenyl group, a chrysenyl group, and a naphthacenyl group.

Specific examples of the non-condensed cyclic hydrocarbon groups include, but are not limited to, a single-valent group of a monocyclic hydrocarbon compound such as benzene, diphenyl ether, polyethylene diphenyl ether, diphenylthio ether, and phenylsulfon, a single-valent group of a non-condensed polycyclic hydrocarbon compound such as biphenyl, polyphenyl, diphenyl alkane, diphenyl alkene, diphenyl alkyne, triphenyl methane, distyryl benzene, 1,1-diphenyl cycloalkane, polyphenyl alkane, and polyphenyl alkene, and a single-valent group of a ring aggregated hydrocarbon compound such as 9,9-diphenyl fluorene.

Specific examples of the heterocyclic groups include, but are not limited to, a single-valent group such as carbazol, dibenzofuran, dibenzothiophene, oxadiazole, and thiadiazole.

The aryl groups represented by Ar₁₄₃ and Ar₁₄₄ can have a substitution group such as following.

(1) A halogen atom, a cyano group, a nitro group, etc.;

(2) An alkyl group, preferably a straight chained or side chained alkyl group having 1 to 12, more preferably 1 to 8, and furthermore preferably from 1 to 4 carbon atoms. These alkyl groups can have a fluorine atom, a hydroxyl group, a cyano group, an alkoxy group having 1 to 4 carbon atoms, a phenyl group, and a phenyl group substituted by a halogen atom, an alkyl group having 1 to 4 carbon atoms, and an alkoxy group having 1 to 4 carbon atoms. Specific examples of (2) include, but are not limited to, a methyl group, an ethyl group, an n-butyl group, an i-propyl group, a t-butyl group, an s-butyl group, an n-propyl group, a trifluoromethyl group, a 2-hydroxy ethyl group, a 2-ethoxyethyl group, a 2-cyanoethyl group, a 2-methoxyethyl group, a benzyl group, a 4-chlorobenzyl group, a 4-methyl benzyl group, and a 4-phenyl benzyl group;

(3) An alkoxy group (—OR₂₃₃), and R₂₃₃ represents the same alkyl group as defined in (2). Specific examples of (3) include, but are not limited to, a metoxy group, an ethoxy group, an n-propoxy group, an i-propoxy group, a t-butoxy group, an n-butoxy group, an s-butoxy group, an i-butoxy group, a 2-hydroxy ethoxy group, a benzyl oxy group, and a trifluoromethoxy group;

(4) An aryloxy group, and specific examples of the aryl group in the aryloxy group include, but are not limited to, a phenyl group and a naphtyl group. These can contain an alkoxy group having 1 to 4 carbon atoms, an alkyl group having a 1 to 4 carbon atoms, and a halogen atom as a substitution group. Specific examples of (4) include, but are not limited to, a phenoxy group, a 1-naphtyloxy group, a 2-naphtyloxy group, a 4-methoxyphenoxy group, and a 4-methylphenoxy group;

(5) An alkyl mercapto group or an aryl mercapto group; Specific examples thereof include, but are not limited to, a methylthio group, an ethylthio group, a phenylthio group, and a p-methylphenylthio group;

(6) Group represented by the following Chemical Structure 16:

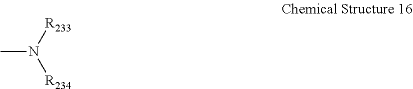

In the Chemical Structure 16, R₂₃₃ and R₂₃₄ independently represent a hydrogen atom, the same alkyl group as defined in (2), and an aryl group. Specific examples of the aryl groups include, but are not limited to, a phenyl group, a biphenyl group, and a naphtyl group. These can contain an alkoxy group having 1 to 4 carbon atoms, an alkyl group having 1 to 4 carbon atoms, and a halogen atom as a substitution group. R₂₃₃ and R₂₃₄ can share a linkage to form a ring.

Specific examples of the group represented by the Chemical Structure 16 include, but are not limited to, an amino group, a diethyl amino group, an N-methyl-N-phenyl amino group, an N,N-diphenyl amino group, an N,N-di(tolyl)amino group, a dibenzyl amino group, a piperidino group, a morpholino group, and a pyrrolidino group;

(7) An alkylene dioxy group such as a methylene dioxy group, an alkylene dithio such as a methylene dithio group, etc.; and

(8) A substituted or non-substituted styryl group, a substituted or non-substituted O-phenyl styryl group, diphenyl aminophenyl group, ditolyl aminophenyl group, etc.

The arylene group represented by Ar₁₄₁ and Ar₁₄₂ is a divalent group deriving from the aryl group represented by Ar₁₄₃ and Ar₁₄₄ specified above.

X represents a single bond, a substituted or non-substituted alkylene group, a substituted or non-substituted cycloalkylene group, a substituted or non-substituted alkylene ether group, an oxygen atom, a sulfur atom, or a vinylene group.

A straight chained or side chained alkyl group having 1 to 12, more preferably 1 to 8 and furthermore preferably from 1 to 4 carbon atoms is preferably specified as the substituted or non-substituted alkylene group. These alkyl groups can have a fluorine atom, a hydroxyl group, an alkoxy group having 1 to 4 carbon atoms, a phenyl group, and a phenyl group substituted by a halogen atom, an alkyl group having 1 to 4 carbon atoms, or an alkoxy group having 1 to 4 carbon atoms. Specific examples thereof include, but are note limited to, a methylene group, an ethylene group, an n-butylene group, an i-propylene group, a t-butylene group, an s-butylene group, an n-propylene group, a trifluoromethylene group, a 2-hydroxy ethylene group, a 2-ethoxyethylene group, a 2-cyanoethylene group, a 2-methoxyethylene group, a benzylidene group, a phenyl ethylene group, a 4-chlorophenyl ethylene group, a 4-methylpheny ethylene group, and a 4-biphenyl ethylene group.

Specific examples of the substituted or non-substituted cycloalkylene groups include, but are not limited to, cyclic alkylene groups having 5 to 7 carbon atoms. Such a cyclic alkylene group can have a fluorine atom, a hydroxyl group, an alkyl group having 1 to 4 carbon atoms, and an alkoxy group having 1 to 4 carbon atoms. Specific examples thereof include, but are not limited to, a cyclohexylidene group, a cyclohexylene group, and a 3,3-dimethyl cyclohexylidene group.

Specific examples of the substituted or non-substituted cycloalkylene groups include, but are not limited to, an ethyleneoxy, a propyleneoxy, an ethylene glycol, an propylene glycol, a diethylene glycol, a tetraethylene glycol, and a tripropylene glycol. The alkylene ether group may have a substitution group such as a hydroxyl group, a methyl group, and an ethyl group.

(1) A specific example of the vinylene group is the functional group represented by the following Chemical Structure 17.

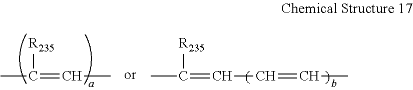

In the Chemical Structure 17, R₂₃₅ represents a hydrogen atom, an alkyl group {the same as the alkyl groups as defined in (2)}, and an aryl group (the same as the aryl group represented by Ar₁₄₃, and Ar₁₄₄). “a” represents 1 or 2. “b” denotes an integer of from 1 to 3.

Z represents a substituted or non-substituted alkylene group, a substituted or non-substituted divalent alkylene ether group, and a divalent alkyleneoxy carbonyl group in the Chemical Structures 14 and 15.

Specific examples of the substituted or non-substituted alkylene group include, but are not limited to, the same as the alkylene groups specified for X.

Specific examples of the substituted or non-substituted divalent alkylene ether group include, but are not limited to, the same as the divalent group of the alkylene ether group specified for X.

A specific example of the divalent alkyleneoxy carbonyl group is a divalent caprolactone modified group.

A further preferable example of the radical polymerizable compound having one functional group with a charge transport structure is the compound represented by the following Chemical Structure 18.

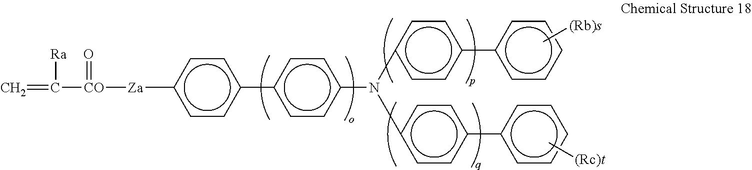

In the Chemical Structure 18, “o”, “p”, and “q” independently represent 0 or 1. Ra represents a hydrogen atom or a methyl group. Rb and Rc independently represent alkyl groups having one to six carbon atoms. “s” and “t” each, independently, represents an integer of from 0 to 3. Za represents a single bond, a methylene group, an ethylene group, and a group represented by the following Chemical Structure 19.

—CH₂CH₂O—, CH₃CHCH₂O—. or C₆H₅CH₂CH₂— Chemical Structure 19

As the compound represented by the Chemical Structure 18, a compound is preferable in which Rb and Rc are methyl groups or ethyl groups.

The polymerizable compound having a single functional group with a charge transport structure represented by the Chemical Structures 14, 15, and in particular 18, is polymerized in a manner that both sides of the carbon-carbon double bond are open. Therefore, the polymerizable compound does not constitute an end of the structure but is set in a chained polymer. The polymerizable compound having a functional group is present in a main chain of a polymer in which cross-linking is formed by polymerization with a polymerizable compound having at least three functional groups or a cross-linking chain between main chains.

There are two kinds of the cross-linking chains. One is the cross-linking chain between a polymer and another polymer, and the other is the cross-linking chain formed by cross-linking a portion in the main chain present in a folded state in a polymer with a moiety deriving from a monomer polymerized away from the portion. Regardless of whether or not the radical polymerizable compound having a functional group with a charge transport structure is present in the main chain or in the cross-linking chain, the triaryl amine structure suspends from the chain portion. The triaryl amine structure has at least three aryl groups disposed in the radial directions relative to the nitrogen atom therein. Such a triaryl amine structure is bulky but does not directly joint with the chain portion and suspends from the chain portion via the carbonyl group, etc. That is, the triaryl amine structure is stereoscopically fixed in a flexible state. Therefore, these triaryl amine structures can be adjacent to each other with a moderate space in the polymer.

Therefore, the structural distortion in the molecule is slight. In addition, the protective layer of the image bearing (photoreceptor) drum having such a structure is deduced to have an internal molecular structure relatively free from disconnections in the charge transport route.

The particular acrylic acid ester compound represented by the following Chemical Structure 20 can be suitably used as the polymerizable compound having a charge transport structure.

B₁-Ar₅-CH═CH—Ar₆-B₂ Chemical Structure 20

In the chemical Structure 20, Ar₅ represents a mono-valent or divalent group formed of a substituted or non-substituted aromatic hydrocarbon skeleton. Specific examples of the aromatic hydrocarbon skeleton include, but are not limited to, benzene, naphthalene, phenanthrene, and biphenyl.

Specific examples of the substiution group include, but are not limited to, an alkyl group having 1 to 12 carbon atoms, an alkoxy group having a 1 to 12 carbon atoms, a benzyl group, and a halogen atom. In addition, the alkyl group and the alkoxy group may have halogen atoms and phenyl groups as substitution groups.

Ar₆ represents a mono-valent or divalent group formed of an aromatic hydrocarbon skeleton having at least one tertiary amino group and a mono-valent or divalent group formed of a heterocyclic compound skeleton having at least one tertiary amino group. The heterocyclic compound skeleton having a tertiary amino group is the skeleton represented by the following Chemical Structure 21.

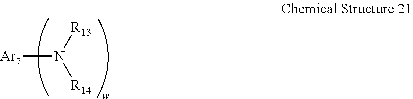

In the Chemical Structure 21, R₁₃ and R₁₄ independently represent acyl groups, substituted or non-substituted alkyl groups, and substituted or non-substituted aryl groups. Ar₇ represents an aryl group. “w” represents an integer of from 1 to 3.

Specific examples of the acyl group of R₁₃ and R₁₄ include, but are not limited to, an acetyl group, a propionyl group, and benzoyl group.

The substituted or non-substituted alkyl group specified for R₁₃ and R₁₄ is the same as that of the alkyl group specified in the substitution group for Ar₅.

Specific examples of the substituted or non-substituted aryl group specified for R₁₃ and R₁₄ include, but are not limited to, a phenyl group, a naphtyl group, a biphenylyl group, a terphenylyl group, a pyrenyl group, a fluorenyl group, a 9,9-dimethyl-2-fluorenyl group, an azulenyl group, an anthryl group, a triphenylenyl group, a crycenyl group, and the group represented by the following Chemical Structure 22.

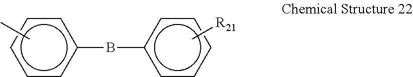

In the Chemical Structure 22, B represents —O—, —S—, —SO—, —SO₂—, —CO—, and the following divalent groups:

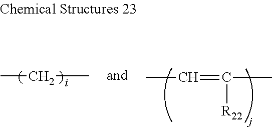

R₂₁ represents a hydrogen atom, a substituted or non-substituted alkyl group defined in Ar₅, an alkoxy group, a halogen atom, a substituted or non-substituted aryl group defined in R₁₃, an amino group, a nitro group, and a cyano group. R₂₂ represents a hydrogen atom, a substituted or non-substituted alkyl group defined in Ar₅, and a substituted or non-substituted aryl group defined in R₁₃. “i” represents an integer of from 1 to 12 and “j” represents an integer of from 1 to 3.

Specific examples of R₂₁ include, but are not limited to, a methoxy group, an ethoxy group, an n-propoxy group, an i-propoxy group, a t-butoxy group, an n-butoxy group, an s-butoxy group, an i-butoxy group, a 2-hydroxy ethoxy group, a 2-cyano ethoxy group, a benzyl oxy group, a 4-methylbenzyloxy group, and a trifluoromethoxy group.

Specific examples of the halogen atom for R₂₁ include, but are not limited to, a fluorine atom, a chlorine atom, a bromine atom, and an iodine atom.

Specific examples of the amino group of R₂₁ include, but are not limited to, a diphenyl amino group, a ditoyl amino group, a dibenzyl amino group, and a 4-methyl benzyl group.

Specific examples of the aryl group in Ar₇ include, but are not limited to, a phenyl group, a naphtyl group, a biphenyl group, a terphenyl group, a pyrenyl group, a fluorenyl group, a 9,9-dimethyl-2-fluorenyl group, an azulenyl group, an anthryl group, a triphenylenyl group, and a crycenyl group.

Ar₇, R₁₃, and R₁₄ may have the alkyl group, the alkoxy group, and the halogen atom defined in Ar₅ as the substitution group.

Specific examples of the heterocyclic compound skeleton having at least one tertiary amino group include, but are not limited to, skeletons deriving from heterocyclic compounds having amino structures such as pyrrol, pyrazole, imidazole, triazol, dioxazole, indol, isoindol, benzimidazole, benzo triazole, benzoisoxazine, carbazole, and phenoxazine. These can contain the alkyl group, the alkoxy group, and the halogen atom defined in Ar₅ as a substitution group.

B₁ and B₂ represent acryloyloxy groups, methacryloyloxy groups, vinyl groups, alkyl groups having acryloyloxy groups, methacryloyloxy groups, or vinyl groups, and alkoxy groups having acryloyloxy groups, methacryloyloxy groups, or vinyl groups. The alkyl groups and the alkoxy groups are the same as those specified for Ar₅. Only one of B₁ and B₂ exists and both do not exist at the same time.

As in the case of the acrylic acid ester compound represented by the following Chemical Structure 20, the acrylic acid ester compound represented by the Chemical Structure 24 can be suitably used.

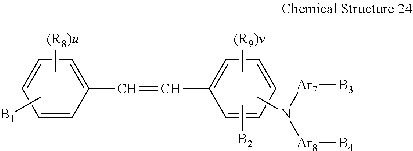

In the Chemical Structure 24, R₈ and R₉ independently represent substituted or non-substituted alkyl groups, substituted or non-substituted alkoxy groups, and halogen atoms. Ar₇ and AR₈ independently represent substituted or non-substituted aryl groups, substituted or non-substituted arylene groups, and substituted or non-substituted benzyl groups. The alkyl groups, the alkoxy groups, and the halogen atoms are the same as those specified for Arₛ.

The aryl groups are the same as the aryl group defined in R₁₃ and R₁₄ in the Chemical Structure 21. The arylene groups are divalent groups deriving from the aryl groups.

B₁ to B₄ represent the same groups as B₁ and B₂ in the Chemical Structure 20 and only one of them is present at the same time.

“u” represents 0 and an integer of from 1 to 5, and “v” represents 0 and an integer of from 1 to 4.

The particular acrylic acid ester compounds, for example, the acrylic acid ester represented by the Chemical Structure 20 and the acrylic acid ester compounds represented by the Chemical Structure 24 have the following characteristics. The particular acrylic acid ester compound is a tertiary amine compound having a stilbene type conjugate structure and has a developed conjugate system. By using such a charge transport compound having such a developed conjugate system, the charge infusion property at the interface of the protective layer becomes extremely improved.

Furthermore, even when the compound is fixed between cross-linking, the intermolecular interaction is hardly inhibited so that the charge mobility is good. In addition, since the compound has an acryloyloxy or a methacryloyloxy group having a high radical polymerization property, gelatinization proceeds quickly during the radical polymerization and no excessive cross-linking distortion occurs.

Since part of the double bonding in the stilbene structure in the molecule is taken in the polymerization and the polymerization degree thereof is relatively low in comparison with the acyloyloxy group and the methacyloyloxy group, there is a time difference in the cross-linking reaction, thereby avoiding maximizing the distortion. In addition, since the double bonding in the molecule is used, the number of cross-linking reaction per molecular weight increases so that the cross-linking density increases, thereby further improving the abrasion resistance.

In addition, this double bonding can be adjusted with regard to the polymerization degree by the cross-linking condition. Therefore, an optimal cross-linked layer can be easily formed. Such a participation in cross-linking during the radical polymerization is characteristic to the acrylic acid ester compound and does not occur to the α-phenyl stilbene type structure.

Therefore, the acrylic acid ester compound represented by the Chemical Structure 20, in particular the Chemical Structure 24, can be suitably used as the polymerizable compound having a single functional group with a charge transport structure to form a layer having an extremely high cross-linking density while maintaining good electrical characteristics and avoiding occurrence of cracking.

Therefore, the obtained image bearing member has satisfying characteristics and silica particulates and etc. contained in toner is prevented from sticking onto the image bearing member, thereby reducing the occurrence of the image deficiency such as white spots.

The polymerizable compound having one polymerizable functional group with a charge transport structure is preferably contained to impart the charge transport power to the protective layer. The component ratio thereof in the protective layer is preferably from 20% by weight to 80% by weight and more preferably from 30% by weight to 70% by weight based on the total amount of the entire protective layer. A component ratio of the polymerizable compound having a charge transport structure that is excessively small easily degrades the charge transport power of the protective layer, which causes deterioration of electrostatic characteristics such as sensitivity and a rise of the residual voltage over repetitive use. A component ratio of the polymerizable compound having a charge transport structure that is excessively large easily leads to reduction of the content of the compound having no charge transport structure. This easily leads to a decrease in the cross linking density, which prevents demonstration of a high abrasion resistance and durability.

Desired electrical characteristics and abrasion resistance vary depending on the process and accordingly the thickness of the protective layer of the image bearing drum changes. Therefore, it is difficult to jump to any conclusion but considering the balance of both, the content ratio is more preferably from 30% by weight to 70% by weight. The polymerizable compound having a charge transport structure is not isolated because it is cured. However, the charge transport structure can be quantified using a method such as FT-IR. Therefore, the content ratio of the polymerizable compound having one functional group with a charge transport structure in the protective layer can be quantified.

### Other Components

As the other components, resins other than cured resins can be specified.

### Resin

There is no specific limitation to the selection of the other resins except for cured resins. Specific examples thereof include, but are not limited to, acrylic resins and polycarbonate resins.

Method of Forming Protective layer

There is no specific limitation to the method of forming the protective layer. For example, the protective layer can be formed by applying a liquid application for protective layer containing the polymerizable compound having three or more polymerizable functional groups with no charge transport structure, the polymerizable compound having one polymerizable functional group with a charge transport structure, and the filler with other optional components such as a polymerization initiator and a solvent to the photosensitive layer followed by drying and curing (cross-linking).

### Polymerization Initiator

Specific examples of the polymerization initiators include, but are not limited to, thermal polymerization initiators and photopolymerization initiators.

Specific examples of the thermal polymerization initiators include, but are not limited to, peroxide based initiators such as 2,5-dimethyl hexane-2,5-dihydroperoxide, dicumyl peroxide, benzoyl peroxide, t-butylcumyl peroxide, 2,5-dimethyl-2,5-di(peroxybenzoyl)hexine-3, di-t-butyl peroxide, t-butylhydro peroxide, cumenehydro peroxide, lauroyl peroxide, and 2,2-bis(4,4-di-t-butylperoxy cyclohexy)propane; and azo based initiators such as azobis isobutyl nitrile, azobis cyalohexane carbonitrile, azobis iso methyl butyrate, azobis isobutyl amidine hydrochloride, and 4,4′-azobis-4-cyano valeric acid.

Specific examples of photopolymerization initiators include, but are not limited to, acetophenon based or ketal based photopolymerization initiators such as diethoxy acetophenone, 2,2-dimethoxy-1,2-diphenyl ethane-1-on, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenyl propane-1-on, and 1-phenyl-1,2-propane dion-2-(o-ethoxycarbonyl)oxime; benzoine ether based photopolymerization initiators such as benzoine, benzoine methyl ether, benzoine ethyl ether, benzoine isobutyl ether, and benzoine isopropyl ether; benzophenone based photopolymerization initiators such as benzophenone, 4-hydroxy benzophenone, o-benzoyl methyl benzoate, 2-benzoyl naphthalene, 4-benzoyl biphenyl, 4-benzoyl phenyl ether, acrylized benzophenone, and 1,4-benzoyl benzene; thioxanthone based photopolymerization initiators such as 2-isopropyl thioxanthone, 2-chlorothioxanthone, 2,4-dimethyl thioxanthone, 2,4-diethyl thioxanthone, and 2,4-dichloro thioxanthone; and other photopolymerization initiators such as ethyl anthraquinone, 2,4,6-trimethyl benzoyl diphenyl phosphine oxide, 2,4,6-trimethyl benzoyl phenyl ethoxy phosphine oxide, bis(2,4,6-trimethyl benzoyl)phenyl phosphine oxide, bis(2,4-dimethoxybenzoyl)-2,4,4-trimethyl pentyl phosphine oxide, a methylphenyl glyoxy ester, 9,10-phenanthrene, an acridine based compound, a triadine based compound, and an imidazole based compound.

In addition, a compound having an acceleration effect on photopolymerization can be used alone or in combination with the photopolymerization initiator. Specific examples of such a compound having an acceleration effect on photopolymerization include, but are not limited to, triethanol amine, methyl diethanol amine, 4-dimethyl amino ethyl benzoate, 4-dimethyl amino isoamyl benzoate, ethyl benzoate (2-dimethyl amino), and 4,4′-dimethyl amino benzophenone. These can be used alone or in combination.

In addition, there is no specific limitation to the content of the polymerization initiator but the content is preferably from 0.5 parts by weight to 40 parts by weight and more preferably from 1 part by weight to 20 parts by weight based on 100 parts of the total of the contained polymerizable materials.

### Solvent

Specific examples of the solvents include, but are not limited to, alcohol solvents such as methanol, ethanol, propanol, and butanol; ketone solvents such as acetone, methyl ethyl ketone, methyl isobutyl ketone, cyclopentanone, and cyclohexanone; ester solvents such as ethyl acetate and butyl acetate; ether solvents such as tetrahydrofuran, dioxane, and propyl ether; halogen based solvents such as dichloromethane, dichloroethane, trichloroethane, and chlorobenzene; aromatic series based solvents such as benzene, toluene, and xylene; and cellosolve solvent such as methyl cellosolve, ethyl cellosove, and cellosolve acetate. These can be used alone or in combination.

Since the solvent occupies most of the liquid application for protective layer, to prevent the solvent from remaining in the protective layer, it is preferable to use a highly volatile solvent and reduce the amount of the solvent that easily remains in the protective layer as least as possible. The solvent that easily remains in the protective layer tends to cause a rise of the residual voltage and inhibit curing, resulting in non-uniform curing and a decrease in the curing density.

Specific examples of the solvent include, but are not limited to, tetrahydrofuran, methylethyl ketone, and alcohol solvents. Among these, tetrahydrofuran is more preferable.

### Other Components

Specific examples of the other components include, but are not limited to, plasticizers, leveling agents, compounds having alkylamino groups, anti-oxidants, low molecular weight charge transport materials having no radical reactivity.

There is no specific limitation to the selection of the plasticizers. Specific examples thereof include, but are not limited to, dibutyl phthalate and dioctyl phthalate.

There is no specific limitation to the content of the plasticizer. The content thereof is preferably 20% by weight or less and more preferably from 10% by weight or less based on the total amount of the solid portion in the liquid application for protective layer.

There is no specific limitation to the leveling agents. Specific examples thereof include, but are not limited to, silicone oils such as dimethyl silicone oils and methyl phenyl silicone oils, polymers or oligomers including perfluoroalkyl groups in their side chain, and leveling agents having functional groups for polymerization.

In addition, there is no specific limitation to the content of the leveling agent. The content thereof is preferably 1% by weight or less based on the total amount of the solid portion in the liquid application for protective layer. When the content is too large, the friction coefficient of the surface of the image bearing drum tends to decrease excessively so that the lubricant materials are not stably supplied.

As the compound having an alkyl amino group, the compound having an alkyl amino group specified for the charge transport layer is suitably used. Adding the compound having an alkyl amino group to the protective layer situated at the uppermost of the image bearing drum is suitable in some cases. However, an excessive addition of the compound may inhibit curing. Therefore, it is preferable to limit the addition amount thereof as least as possible.

There is no specific limitation to the content of the compound having an alkyl amino group. The content thereof is preferably 3% by weight or less and more preferably 2% by weight or less based on the total amount of the solid portion in the liquid application for the protective layer.

There is no specific limitation to the anti-oxidants. Specific examples of the anti-oxidants include, but are not limited to, phenol-based compounds, paraphenylene diamines, hydroquinones, organic sulfur compounds, organic phosphorus compounds, and hindered amines. Among the antioxidants, the anti-oxidants represented by the Chemical Structures 13 in the charge transport layer are preferable.

It is suitable to contain the anti-oxidant in the protective layer in some cases. However, an excessive addition thereof may inhibit curing and raise the residual voltage significantly.

There is no specific limitation to the addition amount of the anti-oxidants. The content thereof is preferably 3% by weight or less and more preferably 2% by weight or less based on the total amount of the solid portion in the liquid application for the protective layer.

There is no specific limitation to the application method of the liquid application for the protective layer. For example, a spray coating (application) is suitable.

The protective layer can be formed while suitably controlling the prescription of the liquid application for the protective layer and the application conditions. In the spray coating method, the coated film state and the surface texture can be controlled by the spraying conditions during spray coating such as the atomization air pressure, the amount of discharging, the distance between the spray gun and the substrate (sleeve), and the number of applications of the liquid. The detail is as described above.

After applying the liquid application for the protective layer, for example, it is preferable to supply energy from outside to cure the polymerizable compound. Specific example of the energy include, but are not limited to, heat, light, and radioactive ray.

Heat energy can be applied to the protective layer from the application surface side or the substrate (sleeve) side using a gas such as air and nitrogen, vapor, various kinds of heat media, infra-red radiation, and electromagnetic wave.

The heating temperature is preferably from 100° C. to 170° C. When the heating temperature is too low, the reaction speed tends to be slow so that the curing reaction may not be complete when forming the cured resin. A heating temperature that is too high tends to cause non-uniform curing reaction, which leads to significant distortion of the inside of the protective layer and occurrence of a great number of non-reacted residual groups and reaction terminated ends. A method of heating the protective layer at a relatively low temperature, for example lower than 100° C., followed by heating to a relatively high temperature, for example, higher than 100° C., is suitable to uniformly conduct curing reaction when forming cured resins.

As the light energy, a UV exposing light source such as a high pressure mercury lamp or a metal halide lamp having a main emission wavelength in the ultraviolet area is used. A visible light source can be selected according to the absorption wavelength of the polymerizable compound and the photopolymerization initiator. The exposure amount is preferably from 50 mW/cm² to 1,000 mW/cm². When the exposure amount is too small, it tends to take a long time to complete the curing reaction. An exposure light amount that is too large tends to prevent a uniform curing reaction speed, which results in local wrinkling on the surface of the protective layer and a great number of non-reacted residual groups and reaction terminated ends.

In addition, the internal stress increases by the rapid cross-linking, which leads to the occurrence of cracking and peeling-off of the layer. Beams of electron can be used as the radioactive ray energy.

Among these forms of energies, thermal (heat) or light energy is suitably used in terms of easiness of reaction speed control and simplicity of the device.

When the protective layer is cured by the light energy or the radioactive ray energy, it is preferable to dry the protective layer to remove the residual solvent after curing. The temperature and the time for drying can be selected depending on the boiling point of the solvent for use in the liquid application for the protective layer and preferably range from about 100° C. to about 150° C. and about 10 minutes to 30 minutes, respectively.

There is no specific limitation to the average thickness of the protective layer. The protective layer preferably has an average thickness of from 1.0 μm to 8.0 μm and more preferably from 2.0 μm to 4.0 μm. When the average thickness is too thin, the filming deficiency tends to occur. In addition, there may be an area that is not covered by the protective layer in the area having the lowest surface roughness, meaning that the abrasion resistance, etc. may not be improved as expected.

In addition, when the average thickness is too thick, problems arise such that cracking or peeling-off tends to occur, the remaining voltage tends to rise significantly, and the surface texture is not easily controlled due to occurrence of filming deficiency. Moreover, the obtained image bearing member is easily affected by the impact (shock such as vibration) by the filler during image formation over repetitive use.

In the present disclosure, the binder resin contained in the protective layer situated uppermost is preferably a cured resin. The protective layer containing the cured resin is insoluble in an organic solvent.

In the method of testing the solubility of the protective layer in an organic solvent, a single droplet of an organic solvent that has a highly dissolution property, such as tetrahydrofuran and dichloromethane, is dropped onto the surface of an image bearing member (drum) and subsequent to natural drying, the change in the surface texture of the image bearing member is observed by a stereomicroscope for determination.

An image bearing member that is dissolved in an organic solvent changes such that concave portions are formed at the center portion of the droplet with the surrounding portion thereof swollen, the charge transport material precipitates, which causes clouding, and the surface swells and then shrinks, which causes wrinkle. By contrast, an image bearing member that is not dissolved in an organic solvent is free from such phenomena and remains unchanged to the droplet of the organic solvent.

In the structure of the present disclosure, to make the protective layer insoluble in an organic solvent, there are factors such as: (1) components of the liquid application for the protective layer and adjustment of the containing ratio thereof; (2) diluting solvent of the liquid application for the protective layer and adjustment of the density of the solid portion; (3) selection of the application method of the protective layer; and (4) control of the curing conditions of the protective layer. This is not achieved by a single factor of them.

### Other Layers

As the other layers, an undercoating layer and an intermediate layer can be specified.

### Undercoating Layer

In the image bearing (photoreceptor) drum of the present disclosure, an undercoating layer can be provided between the hollow cylinder sleeve member and the photosensitive layer.

Typically, such an undercoating layer is mainly made of a resin. Considering that the photosensitive layer is formed on such an undercoating layer (i.e., resin) by applying a solvent such as a known organic solvent thereto, the resin is preferably insoluble or little soluble in such a solvent. Specific examples of such resins include, but are not limited to, water soluble resins such as polyvinyl alcohol, casein, and sodium polyacrylate, alcohol soluble resins such as copolymerized polyamide (copolymerized nylon) and methoxymethylated polyamide (nylon) and cured resins which form a three dimensional network structure, such as polyurethane, melamine resins, phenol resins, alkyd-melamine resins, epoxy resins, and cured resins that form three dimensional network structures.

In addition, it is possible and suitable to contain metal oxides in the undercoating layer to prevent the occurrence of moirè fringe and reduce the residual voltage. The moirè fringe is a kind of image deficiency reflecting a fringe (interference) pattern referred to as a moirè due to the optical interference in the photosensitive layer when an image is written by a coherent light beam such as a laser beam. Basically, the moirè fringe is prevented because the undercoating layer scatters the incident laser beam.

Therefore, the undercoating layer preferably contains a material having a large refraction index. A mixture in which an inorganic pigment is dispersed in the resin is most suitable to prevent the moirè fringe. One of usable inorganic pigments is white pigment and specific examples thereof include, but are not limited to, metal oxide such as titanium oxide, zinc oxide, calcium oxide, silicon oxide, magnesium oxide, aluminum oxide, tin oxide, zirconium oxide, and indium oxide.

Furthermore, the undercoating layer preferably has a feature of transferring charges having the same polarity as that of the charges on the surface of the image bearing drum from the photosensitive layer to the hollow cylinder sleeve member to reduce the residual voltage and the inorganic pigment mentioned above bears that features.

For example, when an image bearing drum of a negative charging type is used, the undercoating layer can reduce the residual voltage by having electron conductivity. The metal oxides mentioned above are suitably used as these inorganic pigments.

However, although the residual voltage is reduced by the existence of inorganic pigments having a low resistance and an increase in the addition ratio thereof, the background fouling may worsen. Therefore, the inorganic pigment and the addition amount thereof are selected and adjusted depending on the layer structure and the layer thickness of the undercoating layer in the image bearing drum to have a good combination of the reduction on the background fouling and the decrease in the residual voltage.

In consideration of the prevention of moirè fringes, the decrease in the residual voltage, the reduction of the background fouling, and prevention of a decrease in the charging at a first round, titanium oxide is most suitable among the metal oxides mentioned above.

The undercoating layer is mainly formed of the resin and the inorganic pigment (metal oxide) and by applying a liquid dispersion for the undercoating layer obtained by wet dispersion in a state in which a solvent is contained. Acetone, methylethylketone, methanol, ethanol, butanol, cyclohexanone, dioxane, and a solvent mixture thereof are suitably used as the solvent.

The inorganic pigments are dispersed in the solvent together with the resin by a typical method using such as a ball mill, a sand mill, and an attritor.

The resin can be added to the liquid application for the undercoating layer before the dispersion or after the dispersion as a resin solution.

In addition, an agent, an additive, a curing promoter, etc. required for curing (cross-linking) can be optionally added and a dispersant to improve the dispersion property of the inorganic pigment can be also added.

Using such a liquid application for the undercoating layer, the undercoating layer is formed on he hollow cylinder sleeve member by using a known method such as a dip coating method, a spray coating method, a ring coating method, a bead coating method, and a nozzle coating method.

Subsequent to the application, the undercoating layer is subjected to drying, heating, and optional curing treatment such as exposure to light.

The average thickness of the undercoating layer varies depending on the kind of the inorganic pigment contained therein and is preferably 20 μm or less and more preferably from 2 μm to 10 μm.

### Intermediate Layer

The photoreceptor drum of the present disclosure may have an intermediate layer between the hollow cylinder sleeve member and the undercoating layer and/or between the undercoating layer and the photosensitive layer.

The intermediate layer is provided to reduce the infusion of positive holes from the hollow cylinder sleeve member and the main purpose of the intermediate layer is to reduce the background fouling.

The intermediate layer is mainly formed of a resin. Specific examples of the resins include, but are not limited to, polyamide, alcohol soluble polyamide (soluble nylon), water soluble polyvinylbutyral, polyvinyl butyral, and polyvinyl alcohol. There is no specific limitation to the forming method of the intermediate layer and any known forming method can be suitably selected.

The average thickness of the intermediate layer is preferably from 0.05 μm to 2 μm.

The two-layer structure of the intermediate layer and the undercoating layer drastically reduces the background fouling but has an adverse impact with regard to a rise in the residual voltage. In addition, the impact of the charging at the first round increases by the laminate structure of the intermediate layer and the undercoating layer in some cases. Therefore, the structure should be determined fully considering the composition and the thickness of the intermediate layer and the undercoating layer.

In the present disclosure, it is preferable to add at least one of an anti-oxidant, a plasticizer, a lubricant, an ultraviolet absorber, and a leveling agent to at least one of the protective layer, the charge generating layer, the charge transport layer, the single-layered photosensitive layer, the undercoating layer, and the intermediate layer to improve the environmental resistance, particularly to prevent the degradation of the sensitivity, the rise in residual potential, and the decrease in charging. The following materials are typically used as these compounds.

Specific examples of the anti-oxidants that can be added to each layer include, but are not limited to, the following.

(a) Phenolic Compounds

2,6-di-t-butyl-p-cresol, butylated hydroxyanisol, 2,6-di-t-butyl-4-ethylphenol, n-octadcyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, and tocopherols.

(b) Paraphenylene Diamines

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

(c) Hydroquinones

2,5-di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

(d) Organic Sulfur Compounds

dilauryl-3,3-thiodipropionate, distearyl-3,3′-thiodipropionate, and ditetradecyle-3,3 [symbol] f-thiodipropionate.

(e) Organic Phosphorous Compounds

triphenyl phosphine, tri(nonylphenyl)phosphine, tri(dinonylphenyl)phosphine, tricresyl phosphine, and tri(2,4-dibutylphenoxy)phosphine.

Specific examples of the plasticizers that can be added to each layer include, but are not limited to, the following

(a) Phosphoric Ester Based Plasticizer

Triphenyl phosphate, tricresyl phosphate, trioctyl phosphate, octyldiphenyl phosphate, trichloroethyl phosphate, cresyl diphenyl phosphate, tributyl phosphate, tri-2-ethylhexyl phosphate, and triphenyl phosphate.

(b) Phthalate-based Plasticizers

dimethyl phthalate, diethyl phthalate, diisobutyl phthalate, dibutyl phthalate, diheptyl phthalate, di-2-ethylhexyl phthalate, diisooctyl phthalate, di-n-octyl phthalate, dinonyl phthalate, diisononyl phthalate, diisodecyl phthalate, diundecyl phthalate, ditridecyl phthalate, dicyclohexyl phthalate, butylbenzil phthalate, butyllauryl phthalate, methyloleyl phthalate, octyldecyl phthalate, dibutyl fumarate, and dioctyl fumarate.

(c) Aromatic Carboxyl Ester Based Plasticizer

Trioctyl trimellitic acid, tri-n-octyl trimellitic acid, and octyloxy benzoate.

(d) Aliphatic Dibasic Acid Ester Based Plasticizer

Dibutyl adipate, n-hexyl adipate, di-2-ethylhexyl adipate, di-n-octyl adipate, n-octyl-n-decyl adipate, diisodecyl adipate, dicapryl adipate, di-2-ethyl-ethylhexyl azelate, dimethyl sebacate, diethyl sebacate, dibutyl sebacate, di-n-octyl sebacate, di-2-ethylhexyl sebacate, di-2-ethoxyethyl sebacate, dioctyl succinate, diisodecyl succinate, dioctyl tetrahydrophyalate, and di-n-octyl tetrahydrophtalate.

(e) Aliphatic Ester Derivative

Butyl oleate, glycerin monoloeic acid ester, methyl acetyl ricinolate, pentaerythritol ester, dipentaerythritol hexaester, and triacetine, and tributyrin.

(f) Oxic Acid Ester Based Plasticizer

Methyl acetyl ricinoleate, butyl acetyl ricinoleate, butylphthalyl butyl glicolate, and tributyl acetyl citrate.

(g) Epoxy Plastic Agent

Epoxidized soy bean oil, epoxidized linseed oil, butyl epoxy stearate, decyl epoxy stearate, octyl epoxy stearate, benzyl epoxy stearate, dioctyl epoxy hexahydrophthalate, and didecyl epoxyhexahydrophyalate.

(h) Diol Ester Based Plasticizer

Diethylene glycol dibenzoate, and triethylene glycol di-2-ethyl butylate.

(i) Choline Containing Plasticizer

Clorinated paraffin, chlorinated diphenyl, chlorinated aliphatic methyl, and methoxychlorinated aliphatic methyl.

(j) Polyestel Based Plasticizer

Polypropylene adipate, polypropylene cebacate, polyester, and acetylized polyester.

(k) Sulfuric Acid Derivatives

p-toluene sulfone amide, o-toluene sulfone amide, p-toluene sulfone ethyl amide, o-toluene sulfone ethyl amide, toluene sulfone-N-ethyl amide, and p-toluene sulfone-N-cyclohexyl amide.

(i) Citricc Acid Derivatives

Triethyl citrate, triethyl acetyl citrate, tributyl citrate, tributyl acetyl citrate, tri-2-ethyl hexyl acetyl citrate, and acetyl citrate-n-octyl decyl.

(m) Others

Terphenyl, partially hydrogenerated terphenyl, camphort, 2-nitrodiphenyl, dinonyl naphthaline, and methyl abietate.

Specific examples of the lubricants that can be added to each layer include, but are not limited to, the following.

(a) Hydrocarbon-Based Compounds

Liquid paraffin, paraffin wax, microwax, and low polymerized polyethylene.Liquid paraffin, paraffin wax, microwax, and low polymerized polyethylene.

(b) Aliphatic-Based Compounds

Lauric acid, myristic acid, paltimic acid, stearic acid, arachidic acid, and behenic acid.

(c) Aliphatic Amide-Based Compounds

Stearyl amide, palmitic amide, oleic amide, methylene bisstearoamide, and ethylene bisstaroamide.

(d) Ester Compounds

Lower alcohol ester of an aliphatic acid, multi-valent alcohol ester of an aliphatic acid, and aliphatic acid polyglycol esters.

(e) Alcohol-Based Compounds

Cetyl alcohol, stearyl alcohol, ethylene glycol, polyethylene glycol, and polyglycerol.

(f) Metal Soap

Lead stearate, cadmium stearate, barium stearate, calcium stearate, zinc stearate, and magnesium stearate.

(g) Natural Waxes

Carnauba wax, candelila wax, bees wax, whale wax, insect wax and montan wax

(h) Others

Silicone compounds and fluorinated compounds

Specific examples of the ultraviolet abosorber that can be added to each layer include, but are not limited to, the following.

(a) Benzophenone-Based Compounds

2-hydrosybenzophenone, 2,4-dihydroxybenzophenone, 2,2′,4-trihydroxybenzophenone,
2,2′,4,4′-tetrahydroxy benzophenone, and 2,2′-dihydroxy-4-methoxy dibenzophenone.

(b) Salkylate-Based Compounds

Phenylsalicylate, and 2,4-di-t-butylphenyl-3,5-di-t-butyl-4-hydroxybenzoate.

(a) Benzotriazoles

(2′-hydroxyphenyl)benzotriazole, (2′-hydroxy-5′-methylphenyl)benzotriazole, (2′-hydroxy-5′-methyl phenyl)benzotriazole, and (2′-hydroxy-3′-tertiary butyl-5′-methylphenyl)-5-chlorobenzotriazole.

(d) Cyanoacylate-Based Compounds

Ethyl-2-cyano-3,3-diphenylacrylate, and methyl-2-carbomethoxy-3-(paramethoxy)acrylate.

(e) Quencher (Metal Complex-Based Compounds)

Nickel (2,2′-thiobis(4-t-octyl)phenolate)normalbutyl amine, nickeldibutyldithiocarbamate, nickel dibutyldithiocarbamate, and cobalt dicyclohexyldithiophosphate.

(f) HALS (Hindered Amine)

Bis(2,2,6,6-tetramethyl-4-piperidyl)cebacate, bis(1,2,2,6,6-pentamethyl-4-piperidyl)cebacate, 1-[2-[3-(3,5-di-t-butyl-4-hydroxyphenyl)propionyloxy]ethyl]-4-[3-(3,5-di-t-butyl-4-hydroxyphenyl)propionyloxy-2,2,6,6-tetramethylpyridine, 8-benzil-7,7,9,9-tetramethyl-3-octyl-1,3,8-triazaspiro[4,5]undecane-2,4-dione, and 4-benzoyloxy-2,2,6,6-tetramethyl piperidine.

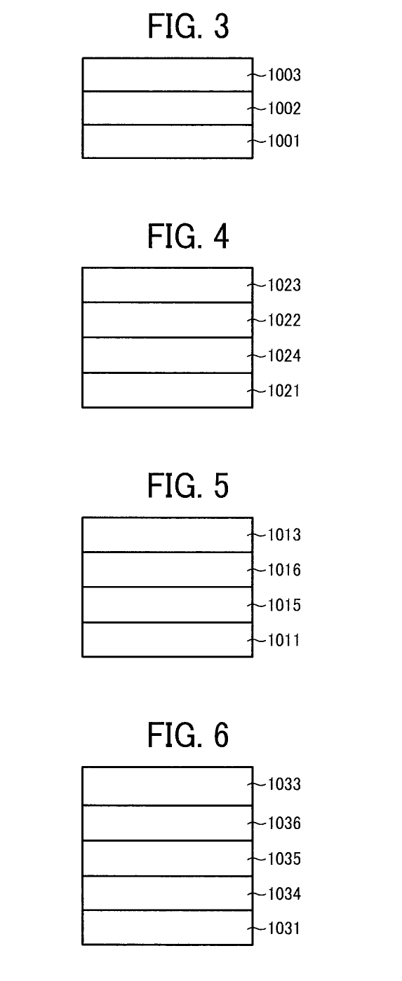

As the laminate structure of the image bearing drum, for example, FIG. 3 is a diagram illustrating an example of the structure in which a photosensitive layer 1002 and an uppermost surface layer (protective layer) 1003 are sequentially laminated on a hollow cylinder sleeve member 1001. In addition, a structure is suitable which has an undercoating layer 1024 between a photosensitive layer 1022 and a hollow cylinder sleeve member 1021, as illustrated in FIG. 4.

An uppermost surface layer (protective layer) 1023 is provided on the photosensitive layer 1022 in FIG. 4. The undercoating layer may have a two layer structure. Furthermore, another structure, as illustrated in FIG. 5, is suitable in which a charge generating layer 1015, a charge transport layer 1016, and an uppermost surface layer (protective layer) 1013 are sequentially formed on a hollow cylinder sleeve member 1011. Moreover, another structure, as illustrated in FIG. 6, is suitable in which an undercoating layer 1034, a charge generating layer 1035, a charge transport layer 1036, and an uppermost surface layer (protective layer) 1033 are sequentially formed on a hollow cylinder sleeve member 1031.

### Flange Member

The flange member has: an attachment unit which can be attached to the open axial end at the end of the hollow cylinder sleeve member relative to the direction of the shaft of the hollow cylinder sleeve member; a shaft hole unit having a shaft hole into which a shaft member is inserted at the position of the center axis of the hollow cylinder sleeve member (when the attachment unit is attached to the open axial end); and a linking unit that extends in the direction parallel to the circular cross section of the hollow cylinder sleeve member and links the shaft hole unit to the attachment unit.

The linking unit has at least one shock-absorbing hole located on a virtual line segment drawn to the shaft hole unit from the circumference of a virtually projected circle formed by projecting the outer periphery of the attachment unit relative to the direction of the shaft of the hollow cylinder sleeve member on a virtual plane which contains the linking unit and is orthogonal to the shaft direction.

There is no specific limitation to the materials for the flange member. Specific examples thereof include, but are not limited to, phenolic resins, amino resins, polyester resins, epoxy resins, ABS resins, acrylic resins, vinyl chloride resins, polystyrene resins, polyamide resins, polyimide resins, polycarbonate resins, polyacetal resins, polyphenylene oxide resins, polyethylene terephthalate resins, polyarylate resins, polybutylene terephthalte resins, polysulfone resins, and polyether sulfone resins.

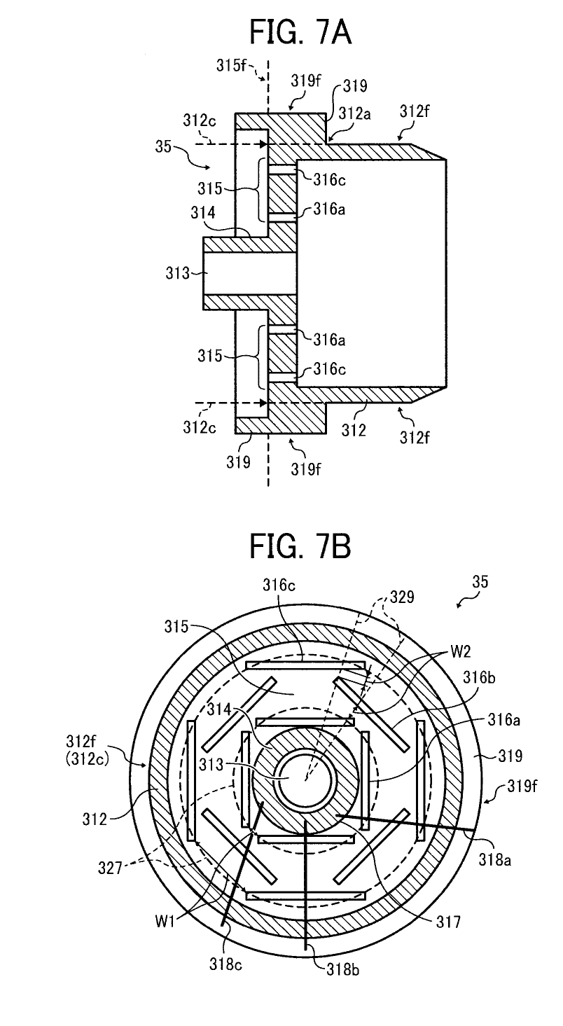

The flange member is described with reference to drawings. FIGS. 7A and 7B are diagrams illustrating a flange member 35. FIG. 7A is a cross section by A-A of the flange member 35 illustrated in FIG. 2 and FIG. 7B is a cross section by B-B of the flange member 35 illustrated in FIG. 2

The flange member 35 has an attachment unit 312, a shaft hole unit 314, a linking unit 315, and an outer periphery portion 319. The attachment unit 312 is pressed into the end opening portion 34 of the image bearing sleeve 30 so that a pressed-in outer periphery 312f, which is the outer periphery of the attachment unit 312, contacts the inner periphery of the hollow cylinder sleeve member 32 of the image bearing sleeve 30.

The shaft hole unit 314 has a shaft hole 313 into which a shaft member is inserted and forms the shaft hole 313. The outer periphery portion 319 forms an outer periphery 319f that forms the outermost periphery of the flange member 35 relative to the radius direction thereof. The linking unit 315 links the shaft hole unit 314, the attachment unit 312, and the outer periphery portion 319.

The linking unit 315 has multiple shock-absorbing holes 316a to 316a (hereinafter represented by the shock-absorbing hole 316). In addition, the shaft hole unit 314 is a portion inside a circle 317 having a radius which is the distance between the center of the shaft and the shock-absorbing hole 316a, which is the closest to the center excluding the portion of the shaft hole 313.

The linking unit 315 has at least one shock-absorbing hole 316 located on a virtual line segment drawn from the shaft hole unit 314 to the outer periphery portion 319. 318a, 318b, and 318c (hereinafter referred to as the virtual line segment 318) are shown in FIG. 7B as examples of the arbitrary virtual line segment.

There are provided three shock-absorbing holes 316 on the virtual line segment 318a, two shock-absorbing holes 316 on the virtual line segment 318b, and one shock-absorbing holes 316 on the virtual line segment 318c.

The virtual line segment 318 is an arbitrary segment drawn to the shaft hole unit 314 from the circumference of a virtually projected circle 312c formed by projecting the pressed-in outer periphery 312f of the attachment unit 312 along the shaft direction (from left to light in FIG. 7A) on a virtual plane 315f which contains the linking unit 315 and is orthogonal to the shaft direction.

The pressed-in outer periphery 312f is formed in parallel with the shaft direction in the flange member 35 shown in FIGS. 7A and 7B. When the pressed-in outer periphery 312f is slanted relative tot the shaft direction, the position of the virtually projected circle 312c is determined based on the position (312a in FIG. 7A) of the pressed-in outer periphery 312f at the base of the attachment unit 312.

With regard to the flange member 35 of the present disclosure, when the attachment unit 312 is pressed in the image bearing sleeve 30 and if the attachment unit 312 receives a stress from the hollow cylinder sleeve member 32 of the image bearing sleeve 30, the shock-absorbing hole 316 absorbs the stress. Therefore, the shaft hole 313 is distorted or moved less than a mechanism having no shock-absorbing hole 316

The linking unit 315 has at least one shock-absorbing hole 316 on a arbitrary virtual line segment 318 drawn from the shaft hole unit 314 to the outer periphery portion 319. Therefore, even if the attachment unit 312 receives a stress in any direction from the hollow cylinder sleeve member 32, at least one of the shock-absorbing holes 316 receives the stress.

Therefore, the stress received at the pressed-in outer periphery 312f of the attachment unit 312 is not directly transmitted to the shaft hole unit 314, thereby reducing distortion and shift of the shaft hole 313.

One of the ends relative to the shaft direction of the image bearing drum 1 is a driving force transmission end to which the driving force is input from the image forming apparatus and the other end is a driven end that supports the image bearing drum 1 to rotate in the image forming apparatus. A driving force transmission gear is provided to the flange member 35 arranged at the driving force transmission end.

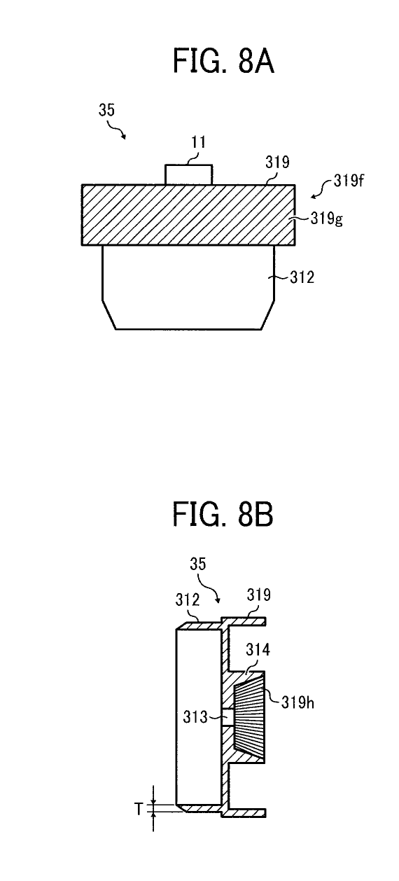

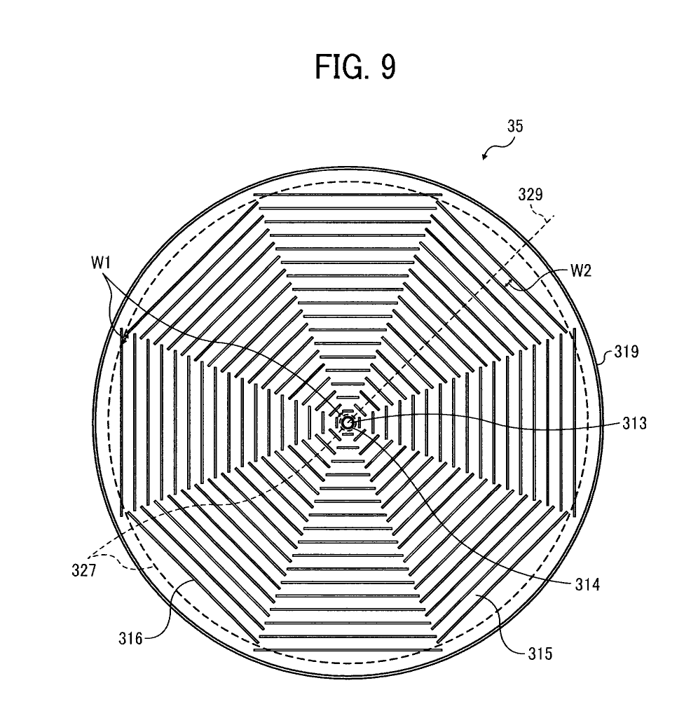

FIGS. 8A and 8B are diagrams illustrating the driving force transmission gear provided to the flange member 35 arranged at the driving force transmission end. FIG. 8A is a side view of the flange member 35 and FIG. 8B is a cross section illustrating the flange member 35. As illustrated in FIG. 8A, the outer periphery 319f of the outer periphery portion 319 of the flange member 35 has an outer edge gear 319g and the shaft hole 313 of the shaft hole unit 314 has a driving force input gear 319h. A reference numeral 11 represents a gear unit in FIG. 8A. A symbol T represents a thickness of the flange member 35 pressed in the image bearing drum 1.

A driving force input gear provided to the shaft member that transmits the rotation driving force from a driving motor provided in the image forming apparatus is engaged with the driving force input gear 319h. The outer periphery 319f is engaged with a series of gears at the image forming unit.

In such a structure, the rotation driving force from the driving motor provided on the image forming apparatus is input from the driving force input gear 319h to the flange member 35 to rotate the image bearing drum 1.

Furthermore, by the rotation of the image bearing drum 1, the driving force is transmitted from the outer edge gear 319g to the series of gears at the image forming unit and the rotation driving force is transmitted to other units forming the image forming devices such as the development device.

While repeating receiving such a driving force, the impact (shock such as vibration) occurs due to the presence of the filler in the protective layer. However, the flange member 35 reduces such an impact by the shock-absorbing holes 316.

The vibration of the image bearing member can be reduced by the flange member 35. The mechanism of reducing the vibration of the image bearing member ascribable to the micro-vibration of the cleaning unit is inferred that the linking unit 315 having the shock-absorbing holes 316 absorbs the vibration. Therefore, the vibration of the image bearing member is reduced, thereby reducing the non-uniform image density.

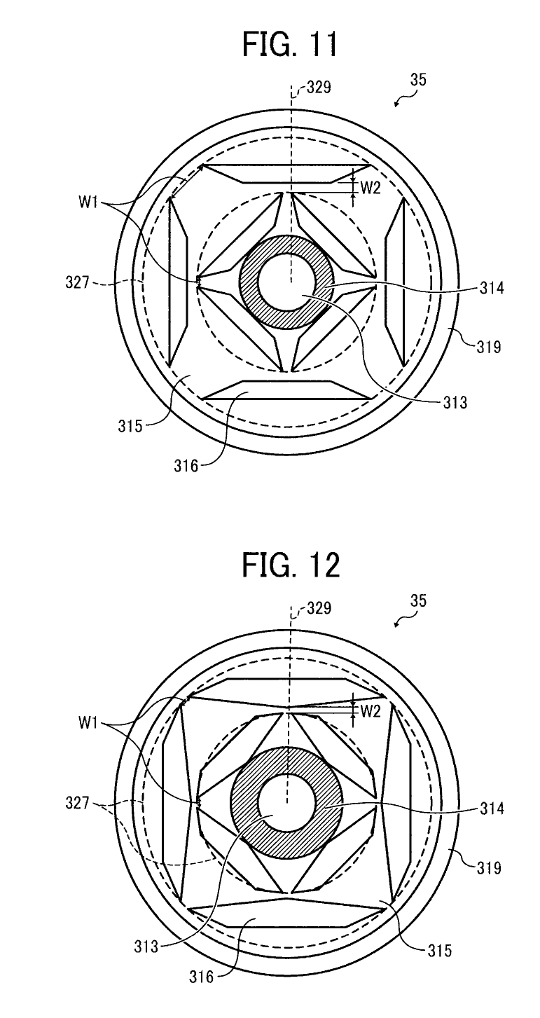

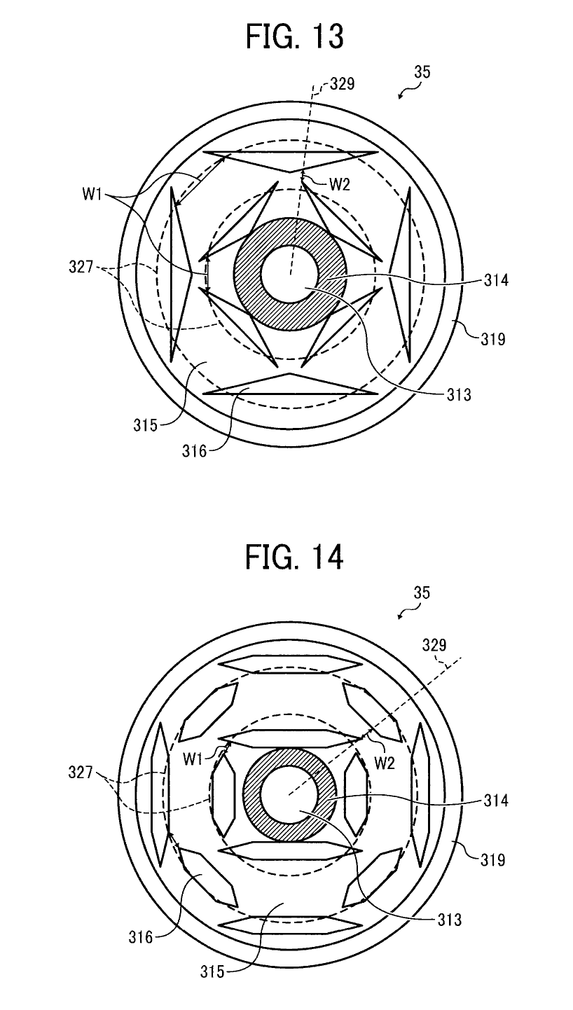

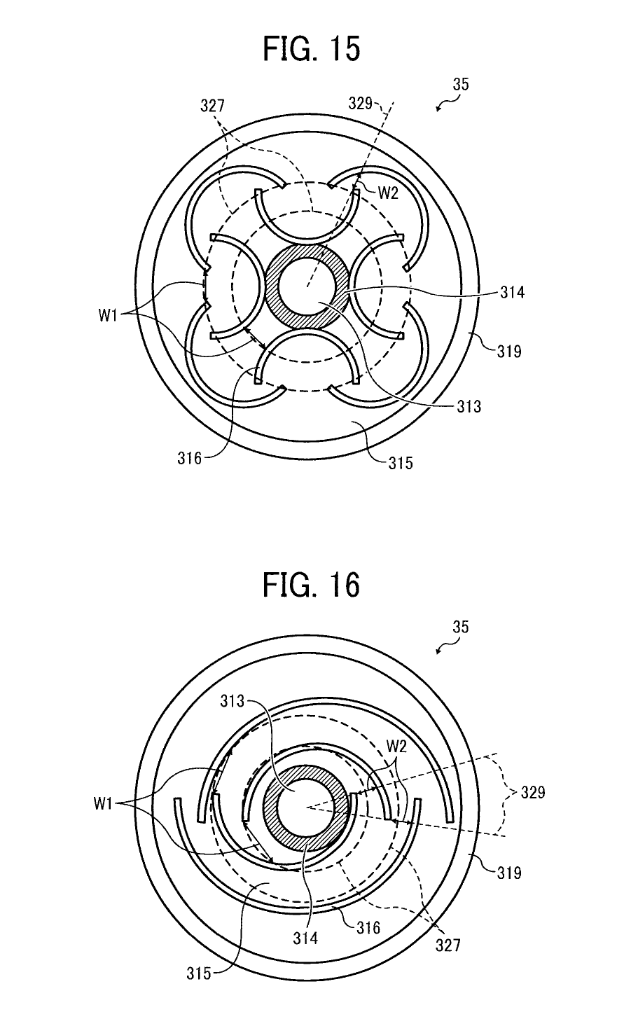

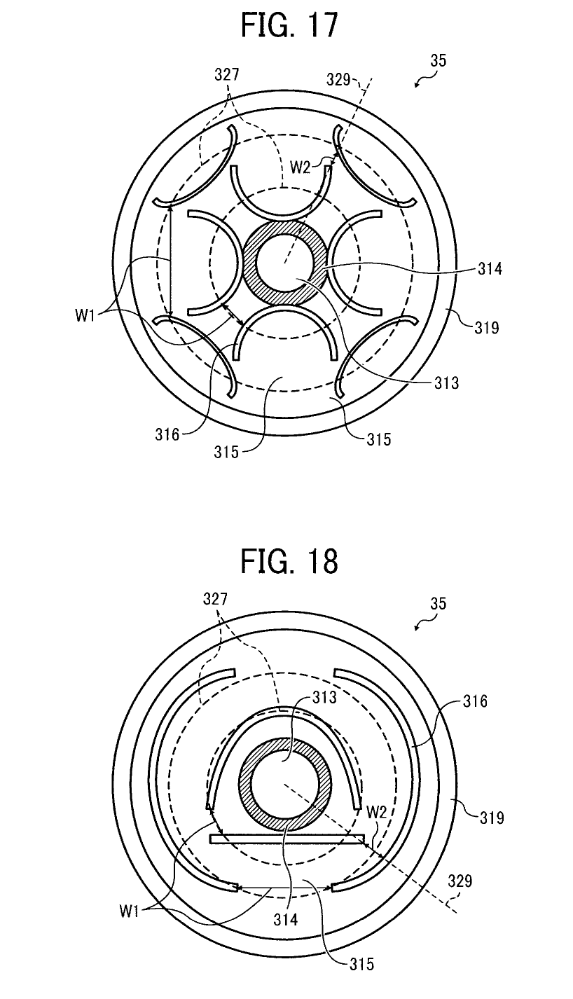

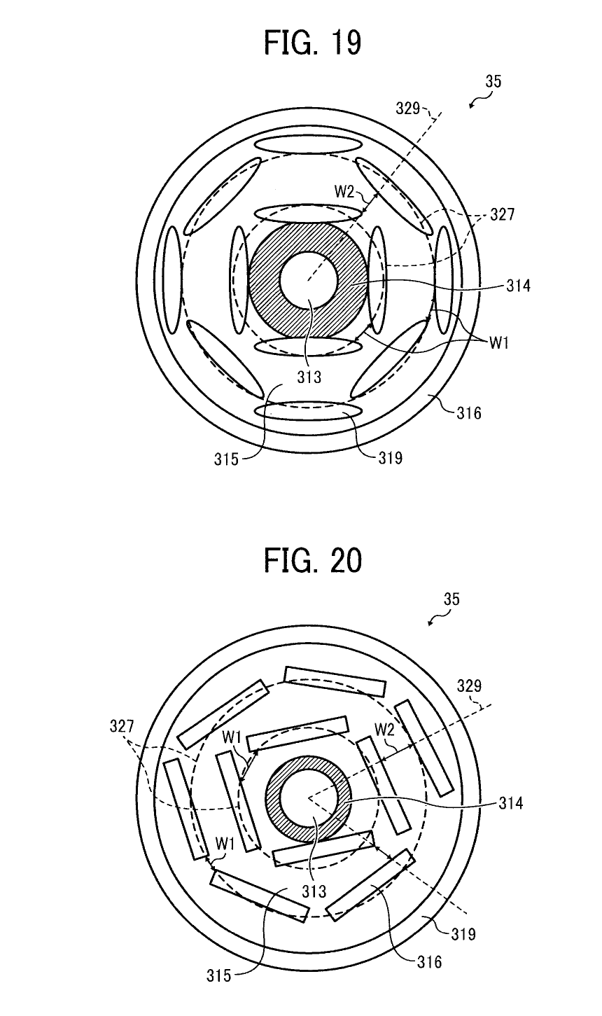

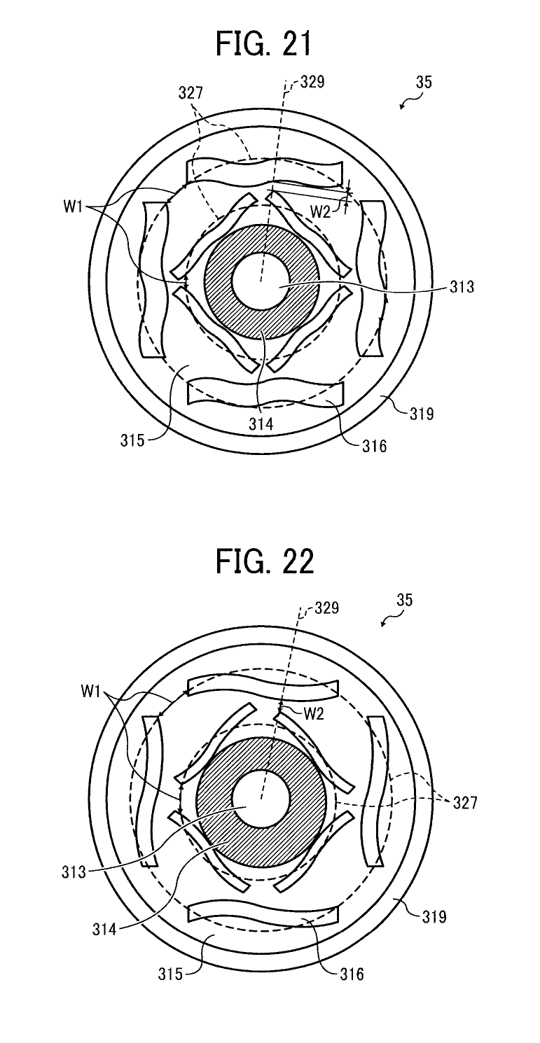

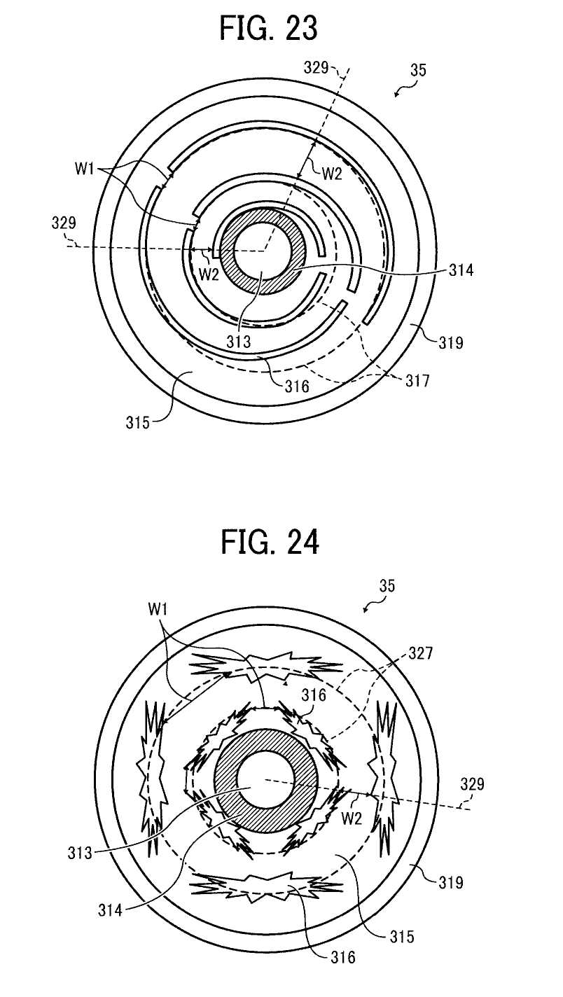

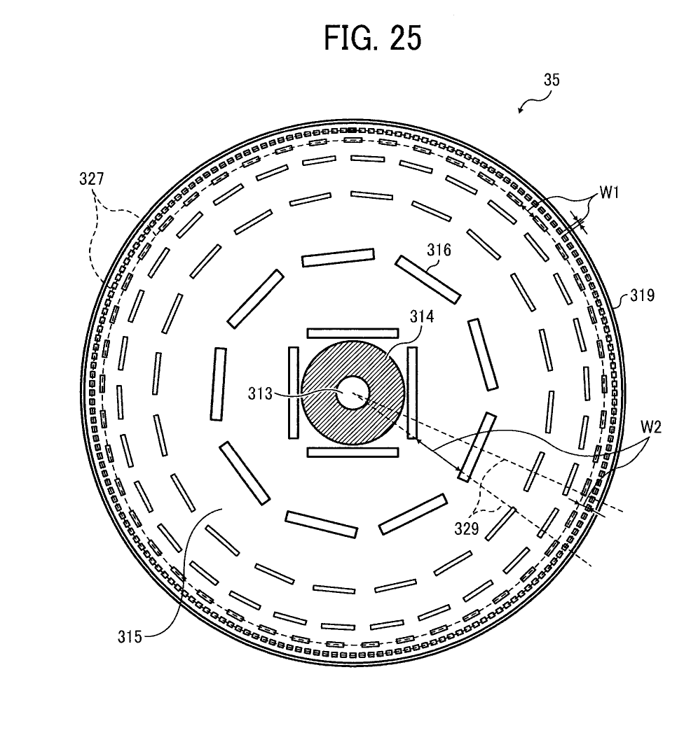

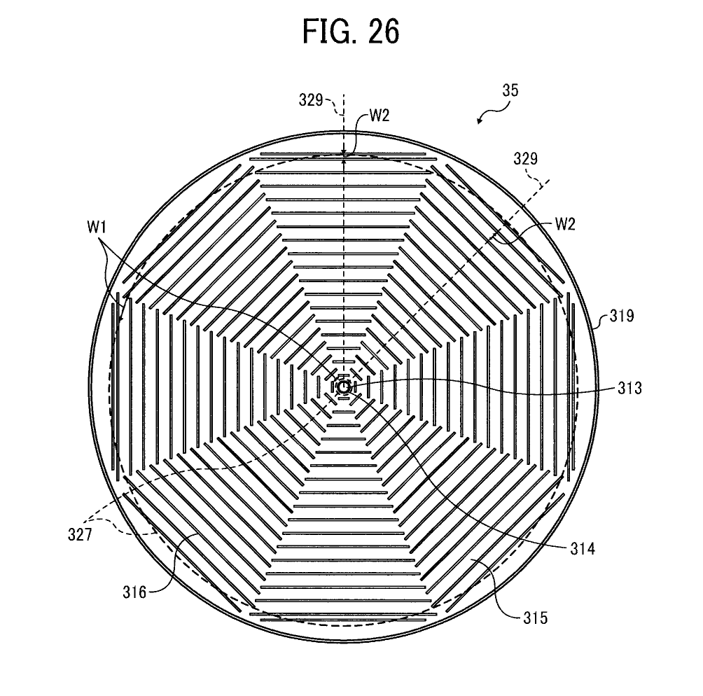

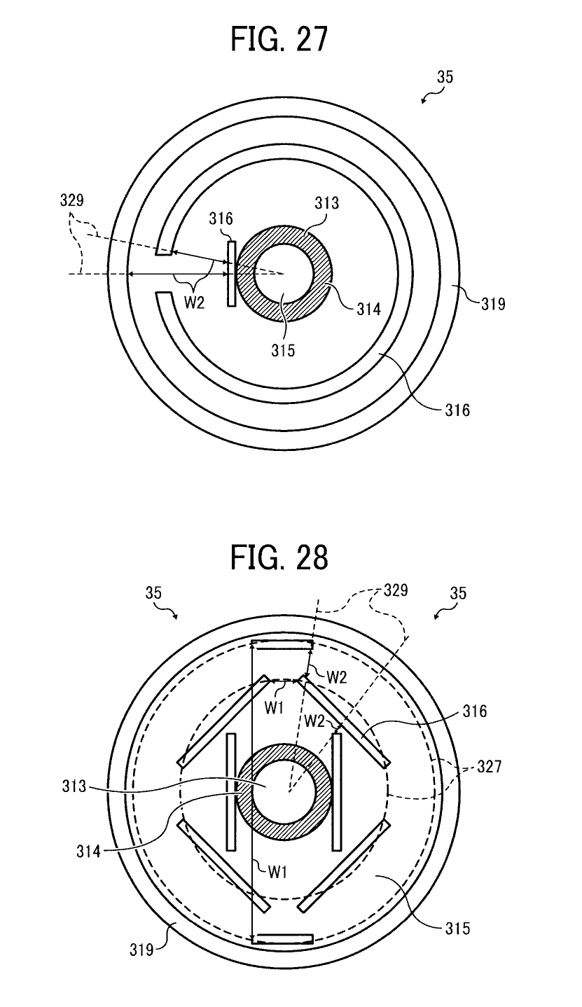

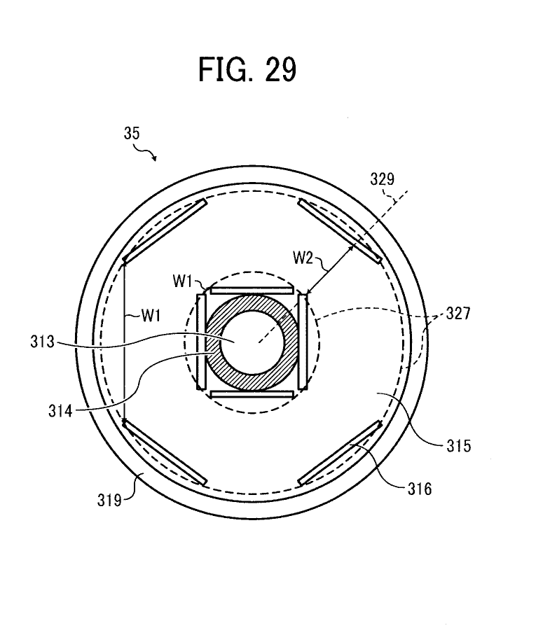

FIGS. 9 to 29 are diagrams illustrating other examples of the flange members. The reference numerals therein are the same as those in FIGS. 7A and 7B.

The shock-absorbing hole preferably has one side having a substantially straight line orthogonalizing the virtual line segment extending in the radius direction of the circular cross section when the shock-absorbing hole is pressed-in the hollow cylinder sleeve member. By having such a form, when a stress is applied in the direction along the virtual line segment, the linking unit around the shock-absorbing hole tends to distort so that the stress is securely prevented from being transmitted to the shaft hole unit.

Since the shock-absorbing hole 316 has the one side crossing a radius 329 in the flange member 35, the stress applied during pressing-in is efficiently absorbed so that the distortion and shift (moving) of the shaft hole 313 are further reduced. Furthermore, since the linking unit 315 having the shock-absorbing hole 316 absorbs the vibration of the image bearing member ascribable to the micro-vibration of the cleaning unit, the vibration of the image bearing drum is reduced, thereby reducing the non-uniform image density.

The linking unit preferably has at least two shock-absorbing holes and more preferably at least four arranged around the circumference of a circle concentric with the center of the shaft hole in the virtual plane, which has the same distance from the center of the shaft hole. The upper limit is preferably 180.

If the maximum number of the shock-absorbing holes in the circumference direction is at least two, the distortion and shift (moving) of the shaft hole is furthermore reduced. The circumference is, in other words, a circle formed by the group of points situated at the same distance from the center of the shaft hole and, for example, shown as a virtual circle 327 in FIG. 7B.

The linking unit preferably has at least two shock-absorbing holes on an arbitrary line segment drawn from the center of the shaft hole to the circumference of the virtually projected circle in the virtual plane.

When the inner diameter of the hollow cylinder sleeve member 32 for the image bearing drum 1 is less than 40 mm, the maximum number of the shock-absorbing holes 316 along the circumference direction is preferably from 2 to 30. To strike the balance between prevention of the distortion and shifting of the shaft hole 313 and difficulty of manufacturing, the maximum number is more preferably from 3 to 12.

When the inner diameter of the hollow cylinder sleeve member 32 for the image bearing drum 1 is from 40 mm to 150 mm, the maximum number of the shock-absorbing holes 316 in the circumference direction is preferably from 2 to 100. To strike the balance between prevention of the distortion and shifting of the shaft hole 313 and difficulty of manufacturing, the maximum number is more preferably from 12 to 24.

When the inner diameter of the hollow cylinder sleeve member 32 for the image bearing drum 1 is greater than 150 mm, the maximum number of the shock-absorbing holes 316 along the circumference direction is preferably from 2 to 180. To strike the balance between prevention of the distortion and shifting of the shaft hole 313 and difficulty of manufacturing, the maximum number is more preferably from 24 to 48.

If the maximum number of the shock-absorbing holes on an arbitrary radius 329 ranges from 2 to 33, the distortion and shift (moving) of the shaft hole is furthermore reduced. The radius 329 means a line segment formed by linking the center and one point on the circumference. Since the linking unit 315 has at least one shock-absorbing hole 316 located on a virtual line segment 318 between the shaft hole 314 and the virtually projected circle 312c, the number of the shock-absorbing hole 316 along the radius direction is at least one.

When the inner diameter of the hollow cylinder sleeve member 32 for the image bearing drum 1 is less than 40 mm, the maximum number of the shock-absorbing holes 316 along the radius direction is preferably from 2 to 5. To strike the balance between prevention of the distortion and shifting of the shaft hole 313 and difficulty of manufacturing, the maximum number is more preferably from 3 to 5.

When the inner diameter of the hollow cylinder sleeve member 32 for the image bearing drum 1 is from 40 mm to 150 mm, the maximum number of the shock-absorbing holes 316 along the radius direction is preferably from 2 to 20. To strike the balance between prevention of the distortion and shifting of the shaft hole 313 and difficulty of manufacturing, the maximum number is more preferably from 4 to 10.

When the inner diameter of the hollow cylinder sleeve member 32 for the image bearing drum 1 is greater than 150 mm, the maximum number of the shock-absorbing holes 316 along the radius direction is preferably from 2 to 33. To strike the balance between prevention of the distortion and shifting of the shaft hole 313 and difficulty of manufacturing, the maximum number is more preferably from 6 to 20.

If the gap between the shock-absorbing holes 316 adjacent in the circumference direction ranges from 1 mm to 280 mm, the distortion and shift (moving) of the shaft hole 313 is reduced. The gap between the shock-absorbing holes 316 adjacent in the circumference direction means the value of a gap W1 along the circumference direction shown in FIGS. 7B and 9 to 29 and the minimum distance between the shock-absorbing holes 316 adjacent in the circumference direction. In the flange member 35 illustrated in FIG. 28, no W1 exists.

When the inner diameter of the hollow cylinder sleeve member 32 for the image bearing drum 1 is less than 40 mm, a gap W1 along the circumference direction is preferably from 1 mm to 30 mm. To strike the balance between prevention of the distortion and shifting of the shaft hole 313 and difficulty of manufacturing, the gap W1 is more preferably from 1 mm to 10 mm.

When the inner diameter of the hollow cylinder sleeve member 32 for the image bearing drum 1 is from 40 mm to 150 mm, the gap W1 along the circumference direction is preferably from 1 mm to 50 mm. To strike the balance between prevention of the distortion and shifting of the shaft hole 313 and difficulty of manufacturing, the gap W1 is more preferably from 1 mm to 30 mm.

When the inner diameter of the hollow cylinder sleeve member 32 for the image bearing drum 1 is greater than 150 mm, the gap W1 along the circumference direction is preferably from 1 mm to 280 mm. To strike the balance between prevention of the distortion and shifting of the shaft hole 313 and difficulty of manufacturing, the gap W1 is more preferably from 1 mm to 50 mm.

If the gap between the shock-absorbing holes 316 adjacent in the radius direction ranges from 1 mm to 130 mm, the distortion and shift (moving) of the shaft hole 313 is reduced. The gap between the shock-absorbing holes 316 adjacent in the radius direction means the value of a gap W2 along the radius direction shown in FIGS. 7B and 9 to 29 and the minimum distance between the shock-absorbing holes 316 adjacent in the radius direction.

When the inner diameter of the hollow cylinder sleeve member 32 for the image bearing drum 1 is less than 40 mm, the gap W2 along the radius direction is preferably from 1 mm to 10 mm. To strike the balance between prevention of the distortion and shifting of the shaft hole 313 and difficulty of manufacturing, the gap W2 is more preferably from 1 mm to 5 mm.

When the inner diameter of the hollow cylinder sleeve member 32 for the image bearing drum 1 is from 40 mm to 150 mm, the gap W2 along the radius direction is preferably from 1 mm to 70 mm. To strike the balance between prevention of the distortion and shifting of the shaft hole 313 and difficulty of manufacturing, the gap W2 is more preferably from 1 mm to 30 mm.

When the inner diameter of the hollow cylinder sleeve member 32 for the image bearing drum 1 is greater than 150 mm, the gap W2 along the radius direction is preferably from 1 mm to 130 mm. To strike the balance between prevention of the distortion and shifting of the shaft hole 313 and difficulty of manufacturing, the gap W2 is more preferably from 1 mm to 80 mm.

The flange members are attached to the open axial ends at the ends of the hollow cylinder sleeve member. The flange members can be attached to the hollow cylinder sleeve member before or after the photosensitive layer and the protective layer are provided. There is no specific limitation to the selection of the attachment method. Pressing-in is preferable in terms of easiness of attachment. The assembly deviation of the image bearing member after the attachment of the flange member is preferably 20 μm or less and more preferably 10 μm or less.

By using a combination of the flange member and the protective layer containing the cured resin for the image bearing drum, the flange member can reduce the assembly deviation occurring during pressing-in and demonstrate other features.

Typically, it is considered that the protective layer containing the cured resin is hardly scraped, thereby achieving an excellent durability. However, as a result of the analysis made by the present inventors, it is confirmed that a simple use of the protective layer containing the cured resin causes non-uniform abrasion to the image bearing member so that the degree of the durability is not so high as expected.

However, the present inventors have found that, by a combinational use of the flange member and the protective layer containing the cured resin for the image bearing drum, the image bearing drum demonstrates a furthermore excellent durability.

Reduction of the non-uniform abrasion greatly contributes to this furthermore excellent durability. According to the investigation made by the present invention, the cause of such non-uniform abrasion of the protective layer is inferred to be the repeated occurrences of the minute impact (shock such as vibration) ascribable to the filler in the surface of the protective layer during repetitive image formation by the image bearing drum.

Once the impact (shock such as vibration) occurs, the displacement (deviation) of the image bearing drum varies relative to the shaft direction, which creates the difference in hazard depending on the contact portions between the image bearing drum and the cleaning unit (cleaning blade) during image formation.

This leads to the difference in the scraped amount of the protective layer, resulting in non-uniform abrasion. To solve this, the flange member is used to reduce the non-uniform abrasion by absorbing the deviation of the image bearing drum during repetitive image formation.

### Image Forming Apparatus and Image Forming Method

The image forming apparatus of the present disclosure includes an image bearing drum, a charging device, an exposure device, a development device, a transfer device, a cleaning device, and other optional devices.

The image forming method of the present disclosure includes a development process, an exposure process, a development process, a transfer process, a cleaning process, and other optional processes. The image bearing drum is the one described above.

The image forming method of the present disclosure is suitably performed by the image forming apparatus of the present disclosure. The charging process is performed by the charging device. The exposure process is performed by the exposure device. The development process is performed by the development device. The transfer process is performed by the transfer device. The cleaning process is performed by the cleaning device. The other optional processes are performed by the corresponding optional devices.

### Charging Device and Charging Process

There is no specific limitation to the charging device and any known charging device can be selected. For example, a known contact type charger having an electroconductive or semi-electroconductive roller, a brush, a film, a rubber blade, etc. can be used.

There is no specific limitation to the charging process and any known charging process that charges the surface of the image bearing drum can be selected. For example, the charging process can be conducted by the charging device described above. The contact type charging system and the vicinity type charging system can be employed as the charging system of the image bearing drum. The vicinity type charging system includes, for example, the vicinity type charging roller system.

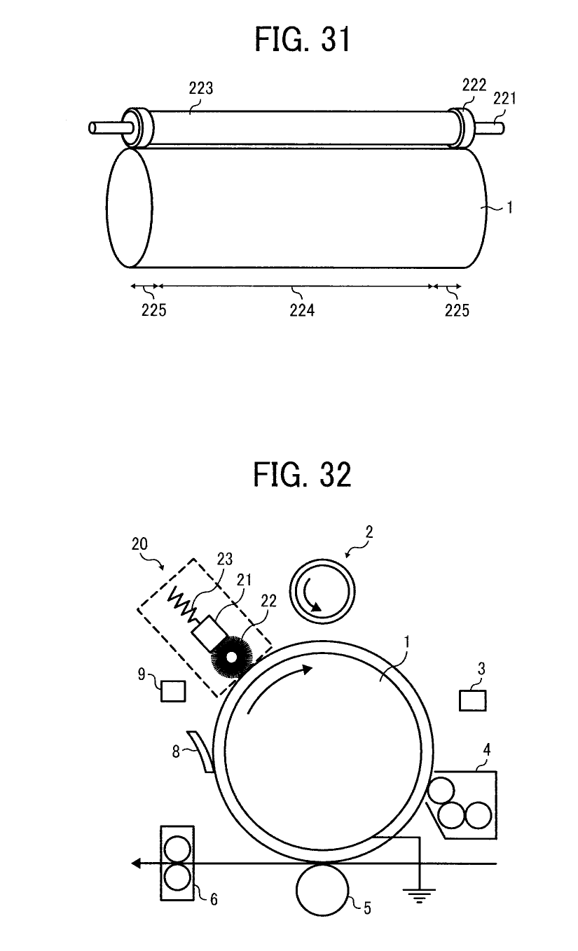

FIG. 31 is a diagram illustrating an example of the vicinity type charging roller system.

In the vicinity type charging roller system illustrated in FIG. 31, gap forming members 222 are provided at both ends of a charging roller 223 relative to the shaft direction of a metal shaft 221 serving as the rotation shaft of the charging roller 223.

The charging roller 223 is arranged facing the image bearing drum 1. The distance between an image formation area 224 of the image bearing member drum 1 and the surface of the charging roller 223 can be kept constant by the gap forming member 222 contacting a non-image formation area 225 at both ends of the image bearing drum 1 relative to the shaft direction thereof.

### Exposure Device and Irradiation Process

There is no specific limitation to the selection of the exposure device and any exposure device that exposes the surface of a charged image bearing drum with light to form a latent electrostataic image thereon can be suitably used. Specific examples of such exposure devices include, but are not limited to, any known exposure devices such as a photocopying optical system, a rod lens array system, a laser optical system, and a liquid crystal shutter optical system.

There is no specific limitation to the esposure process and any known exposure process that exposes the surface of a charged image bearing drum with light to form a latent electrostataic image thereon can be suitably used. For example, the exposure process can be conducted by the exposure device described above. As to the present disclosure, the rear side exposure system in which the image bearing drum is exposed from the rear side can be also employed.

### Development Device and Development Process

There is no specific limitation to the development device and any known development device that develops a latent electrostatic image with toner to obtain a toner image can be used. For example, a development device which accommodates and supplies the toner or the development agent to the latent electrostatic image in a contact or non-contact manner is suitably used.

There is no specific limitation to the exposure process and any known development process that develops a latent electrostatic image with toner or a development agent to obtain a toner image can be suitably used. For example, the development process can be conducted by the development device described above.

The development device employs a dry development type or a wet development type and a single color development type or a multi-color development type. The development device preferably includes, for example, a stirrer that triboelectrically charges the toner or the development agent, and a rotatable magnet roller.

In the development device, the toner and a carrier are mixed and stirred to triboelectrically charge the toner. The toner is then held on the surface of the rotating magnet roller in a filament manner to form a magnet brush. Since the magnet roller is provided in the vicinity of the image bearing drum, part of the toner forming the magnet brush borne on the surface of the magnet roller is transferred to the surface of the image bearing drum by electric attraction force. As a result, the latent electrostatic image is developed with the toner to form a visual toner image on the surface of the image bearing drum.

### Toner

There is no specific limitation to the toner and any known toner can be suitably selected.

There is no specific limitation to the method of manufacturing the toner. Specific examples thereof include, but are not limited to, a pulverization and classification method, a suspension polymerization method, an emulsification polymerization method, and a polymer suspension method.

With regard to the toner, for example, toner that contains a binder resin mainly formed of a thermoplastic resin, a coloring agent, and particulates with optional other components such as a charge control agent and a releasing agent is suitably used.

This toner is irregular-shaped or spherical toner manufactured by a toner manufacturing method such as a polymerization method and a granulation method. Both magnetic toner and non-magnetic toner are suitable.

There is no specific limitation to the volume average particle diameter (Dv) of the toner.

The volume average particle diameter (Dv) is preferably from 3 μm to 8 μm, more preferably from 4 μm to 7 μm, and particularly preferably from 5 μm to 6 μm. The volume average particle diameter (Dv) is defined as: Dv=(Σ(nD³)/Σn)^{1/3}. In the relationship, “n” represents the number of particles and “D” represents the particle diameter.

When the volume average particle diameter (Dv) is too small, toner tends to adhere to the surface of the carrier while stirring in the development device over an extended period of time, thereby degrading the charging power of the carrier in the case of a two component development agent and the toner tends to form filming on the development roller or adhere to members such as the blade by regulating the layer thickness of the toner in the case of a single component development agent. When the volume average particle diameter (Dv) is too large, it tends to be difficult to obtain quality images with high definition and the particle diameter of the toner tends to vary significantly by replenishing the toner in the development agent.

The volume average particle diameter (Dv) can be measured by using, for example, a particle size measuring instrument (MultiSizer II, manufactured by Beckman Coulter Co., Ltd.).

### Transfer Device and Transfer Process

Any transfer device that can transfer the toner image to a recording (transfer) medium is suitably used. For example, a transfer device including a primary transfer device that forms a complex transfer image on an intermediate transfer body by transferring the toner image thereto and a secondary transfer device that transfers the complex transfer image to the recording medium.

Any transfer process that can transfer the toner image to a recording medium is suitably used. It is preferred that the toner image is primarily transferred to an intermediate transfer body and thereafter secondarily transferred to the recording medium. Further, it is more preferable to use a two or more color toner, preferably a full color toner in the processes in which the visual image is primarily transferred to the intermediate transfer body to form a complex transfer image and the complex transfer image is thereafter secondarily transferred to the recording medium.

There is no specific limitation to the intermediate transfer body and any known transfer body can be suitably selected. For example, a transfer belt is preferably used.

The image bearing drum can also serve as an intermediate transfer body for use in image formation according to the intermediate transfer system in which a toner image formed on the image bearing drum is primarily transferred and superimposed followed by secondary transfer of the image to a recording medium.

The transfer device (the primary transfer body, the secondary transfer body) preferably has a transfer unit which charges and peels off the toner image formed on the image bearing drum to the side of the recording medium. One or more transfer units may be used. Specific examples of the transfer units include, but are not limited to, a corona transfer unit using corona discharging, a transfer belt, a transfer roller, a pressure transfer roller, and an adhesive transfer unit.

There is no specific limitation to the recording medium and any known recording medium (recording paper) can be suitably used.

### Cleaning Device and Cleaning Process

There is no specific limitation to the selection of the cleaning device and any known cleaner that can remove the toner remaining on the image bearing member is suitably used. Specific examples of such cleaners include, but are not limited to, a magnetic brush cleaner, an electrostatic brush cleaner, a magnetic roller cleaner, a blade cleaner, a brush cleaner, and a web cleaner.

Any cleaning process that can remove the toner remaining on the image bearing member is suitably used. For example, the cleaning process can be conducted by the cleaning device mentioned above.

The cleaning device is preferably provided downstream from the transfer device and upstream from the protective agent applicator relative to the rotation direction of the image bearing drum.

In addition to the residual toner, development agent, paper dust, etc. are attached to the image bearing member after the transfer process. These may cause production of defective images in the next image formation processes. Therefore, the cleaning process conducted by the cleaning device is required.

To remove the foreign objects mainly including the residual toner attached to the image bearing member, a cleaning blade that directly contacts the image bearing member is suitable. The cleaning performance is further improved by the combination of such a cleaning blade and the image bearing member of the present disclosure.

The surface of the image bearing drum is contaminated with various kinds of foreign objects such as development agent components, paper dust, and corona products in addition to the toner remaining on the image bearing member. This has a large adverse impact on the image quality. Therefore, the cleaning device and the cleaning process serve to remove these. In light of this, the cleaning blade is excellent.

By using the flange member and the protective layer for the image bearing drum, the burden on the cleaning device is reduced and the occurrence of the cleaning device turning inward and outward or chip-off of the edge decreases, thereby preventing the toner from slipping through the cleaning blade.

### Cleaning Blade

There is no specific limitation to the cleaning blade. The hardness (defined in JIS-A hardness/JIS K 6253 hardness test) of the cleaning blade is preferably of from 70° to 80° and more preferably from 72° to 76°. When the hardness is too small, the cleaning blade is excessively soft and easily abraded so that the toner slips through the gap created by abrasion, thereby degrading the cleaning performance over time. When the hardness is too large, the cleaning blade is excessively hard and easily chips off, thereby degrading the cleaning performance over time.

There is no specific limit to the impact resilience (defined in the JIS K6255 impact resilience test) of the cleaning blade. The impact resilience thereof is preferably from 10% to 35% at 25° C. When the impact resilience is too small, the cleaning blade tends to allow the toner to slip through the cleaning blade. When the impact resilience is too large, the stick-slip movement of the blade edge micro-vibrating tends to be violent so that the blade edge chips off over time and the toner slips through the chipped off portion, thereby degrading the cleaning performance.

### Other Device and Other Process

The other devices include a protection film forming device, a discharger, etc. The other processes include a protection film forming process, a discharging process, etc.

Protective layer Forming Device and Protection Film Forming Process

Any known protection film forming device such as a protective agent application blade that supplies a protective agent to the surface of the image bearing drum to form a protection film thereon can be suitably used.

Any known protection film forming process that supplies a protective agent to the surface of the image bearing drum to form a protection film thereon can be suitably used. For example, the protection film forming process can be conducted by the protection film forming device described above.

There is no specific limitation to the protective agent and any known protective agent can be suitably used. For example, a protective agent having metal soap with other optional components is suitably used.

There is no specific limitation to the selection of the metal soap. For example, soap formed of zinc stearate is suitably used. As the other components, boron nitride can be contained in the protective agent.

FIG. 32 is a diagram illustrating the method of applying the protective agent to the image bearing drum. In the image forming apparatus illustrated in FIG. 32, a reference numeral 1 represents the image bearing drum.

The reference numeral 2 represents a charger employing a roller charging system. However, the charging system is not limited to the roller charging system and, for example, a corona charging system can be also employed.

The reference numeral 3 represents an exposing device. The reference numeral 4 represents a development device, the reference numeral 5 is a transfer device, and the reference numeral 6 is a fixing device.

Any known device can be suitably used. The reference numeral 8 represents a cleaning device and the cleaning blade in FIG. 32 but is not limited thereto. The reference numeral 9 represents a discharging device and the reference numeral 20 represents a protective agent forming device. In FIG. 32, a system in which a solid protective agent 21 is pressed by a pressure spring 23 and applied to the surface of the image bearing drum 1 via a fur brush 22 is illustrated as an example of the protective agent forming process.

The protective agent 21, which is solidified by molding to have a bar form, is pressed by a predetermined pressure by the pressing spring (pressure imparting mechanism) 23, scraped by the rotation by the fur brush 23, and applied to the surface of the image bearing drum 1.

The pressing spring 23 is advantageous to constantly scrape the protective agent 21 in the same amount by the fur brush 22 and supply it to the surface of the image bearing drum 1 even when the protective agent 21 diminishes over time.

### Discharging Device and Discharging Process

There is no specific limitation to the discharging device and any known discharging device such as a discharging lamp that can apply a discharging bias to the image bearing drum is suitable.

The discharging process is a process in which a discharging bias is applied to the image bearing drum to discharge it and suitably conducted by a discharging device.

Since the image bearing drum is of high precision with little deviation and has an excellent abrasion resistance and durability, the cleaning performance is significantly improved, which is advantageous to output images having a large image area. n light of this point, the image bearing drum is suitable to print a document mainly formed of images instead of texts, i.e., full color images.

In particular, since the image bearing drum is of high precision with little deviation and has an excellent abrasion resistance and durability, the variation among the image bearing drums decreases. Therefore, the image bearing drum is suitably used in an image forming apparatus and an image forming method employing a tandem system using multiple image bearing drums to produce full color images. That is, the image forming apparatus can be suitably used as a tandem type image forming apparatus and the image forming method can be used as a tandem type image forming method.

The tandem system image forming apparatus includes the same number of image bearing drums as development units separately provided for corresponding color toners, thereby independently conducting development of each color toner in parallel followed by superimposing each color toner image to obtain a full color image. To be specific, at least four color development units and image bearing drums for yellow (Y), magenta (M), cyan (C), and black (K) required for full color printing are provided, thereby achieving extremely high speed full color printing in comparison with a single drum system in which processes are repeated four times to obtain a full color image.

### Process Cartridge

The process cartridge of the present disclosure includes an image bearing drum and at least one device selected from the group consisting of other optional devices such as a charging device, an exposure device, a development device, a transfer device, and a cleaning device, and is detachably attachable to an image forming apparatus. The image bearing drum is the one described above.

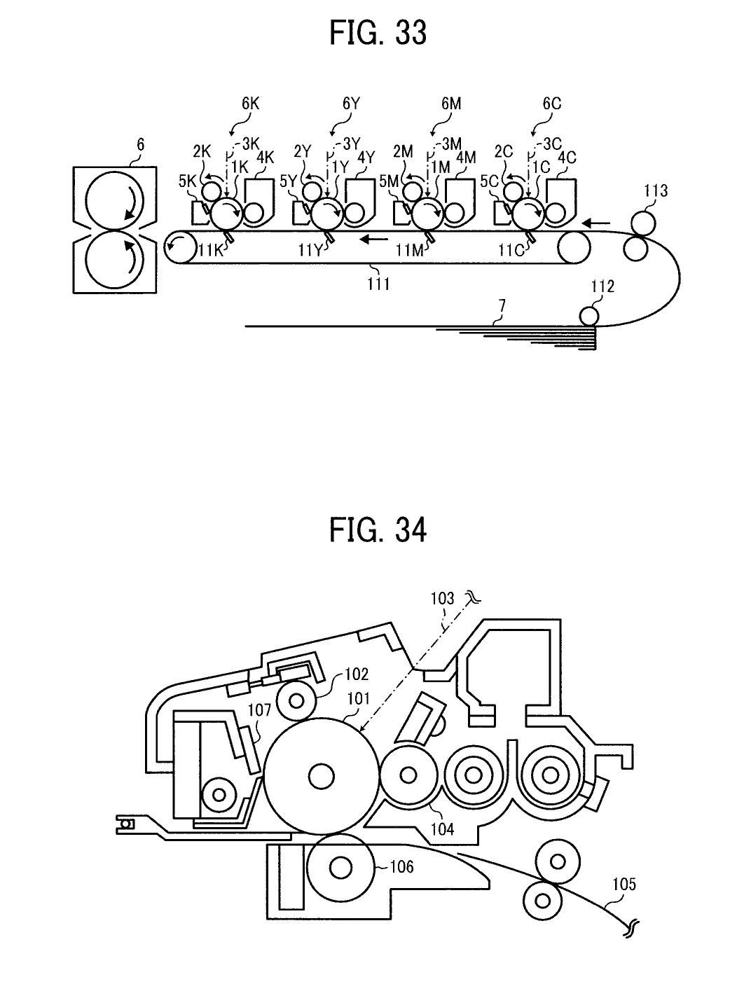

FIG. 33 is a schematic diagram illustrating an example of the tandem type image forming apparatus of the present invention. In FIG. 33, reference numerals 1C, 1M, 1Y, and 1K represent image bearing members having a drum form. The image bearing members (drums) 1C, 1M, 1Y, and 1K rotate in the direction indicated by the arrows indicated in FIG. 33 and there are provided around the image bearing drums 1C, 1M, 1Y, and 1K at least charging devices 2C, 2M, 2Y, and 2K, development devices 4C, 4M, 4Y, and 4K, and cleaning devices 5C, 5M, 5Y, and 5K arranged according to the rotation direction of the image bearing drums 1C, 1M, 1Y, and 1K.

An exposure device emits laser beams 3C, 3M, 3Y, and 3K to expose the image bearing drums 1C, 1M, 1Y, and 1K between the charging devices 2C, 2M, 2Y, and 2K and the development device 4C, 4M, 4Y, and 4K from the rear side of the image bearing drums 1C, 1M, 1Y, and 1K to form latent electrostatic images thereon. Four image formation components 6C, 6M, 6Y, and 6K including the image bearing drums 1C, 1M, 1Y, and 1K are arranged along a transfer belt 111 serving as a transfer medium conveying device. The transfer belt 111 is in contact with the image bearing drums 1C, 1M, 1Y, and 1K between the development device 4C, 4M, 4Y, and 4K and the corresponding cleaning devices 5C, 5M, 5Y, and 5K of each image formation components 6C, 6M, 6Y, and 6K. Transfer brushes 11C, 11M, 11Y, and 11K that apply a transfer bias are provided on the side of the transfer belt 111 reverse to the side on which the image bearing members 1C, 1M, 1Y, and 1K are in contact with the transfer belt 111.

Each image formation component 6C, 6M, 6Y, and 6K has the same structure except that toners contained in the development devices 4C, 4M, 4Y, and 4K have different colors from each other.

The full color image forming apparatus having the structure illustrated in FIG. 33 forms images as follows. In the image formation component 6C, 6M, 6Y, and 6K, the image bearing members 1C, 1M, 1Y, and 1K are charged by the charging devices 2C, 2M, 2Y, and 2K that rotate in the direction indicated by the arrow in FIG. 33 (the following direction to the rotation direction of the image bearing members 1C, 1M, 1Y, and 1K) and exposed with the laser beams 3C, 3M, 3Y, and 3K by the exposure device situated outside the image bearing drums 1C, 1M, 1Y, and 1K to form latent electrostatic images corresponding to the image of each color. Then, the latent electrostatic images are developed by the development devices 4C, 4M, 4Y, and 4K to form toner images. That is, the development devices 4C, 4M, 4Y, and 4K develop the latent electrostatic images with toner of C (cyan), M (magenta), Y (yellow), and K (black), respectively.

Respective toner images formed on the four image bearing drums 1, 1M, 1Y, and 1K are superimposed on a transfer medium 7. The transfer medium 7 is sent out from a tray by a feeding roller 112, temporarily held at a pair of registration rollers 113, and fed to the transfer belt 111 in synchronization with image formation on the image bearing drums 1C, 1M, 1Y, and 1K. The transfer medium 7 held on the transfer belt 111 is transferred to the contact point (transfer portion) with the image bearing drums 1C, 1M, 1Y, and 1K from which each color toner image is transferred.

The toner images on the image bearing drums 1C, 1M, 1Y, and 1K are transferred to the transfer medium 7 by an electric field formed by a potential difference between the transfer bias applied to the transfer brushes 11C, 11M, 11Y, and 11K and the voltage of the image bearing drums 1C, 1M, 1Y, and 1K. The transfer medium 7 on which four color toner images have been superimposed while the transfer medium 7 passes through the four transfer portions is conveyed to a fixing device 6, where the toner is fixed and thereafter discharged to a discharging portion. In addition, toner which has not been transferred at the transfer portions to the transfer belt 111 and remains on the image bearing members 1C, 1M, 1Y is collected by the cleaning devices 5C, 5M, 5Y, and 5K.

In FIG. 33, the image formation elements are arranged in the sequence of C (cyan), M (magenta), Y (yellow), and K (black) from upstream to downstream relative to the transfer direction of the transfer medium, but the sequence of the image formation elements is not limited thereto. The sequence of the color is arbitrarily determinable. In addition, when a document of only black color is output, providing a mechanism that suspends the image formation elements 6C, 6M, and 6Y other than the black color is particularly suitable for the present disclosure.

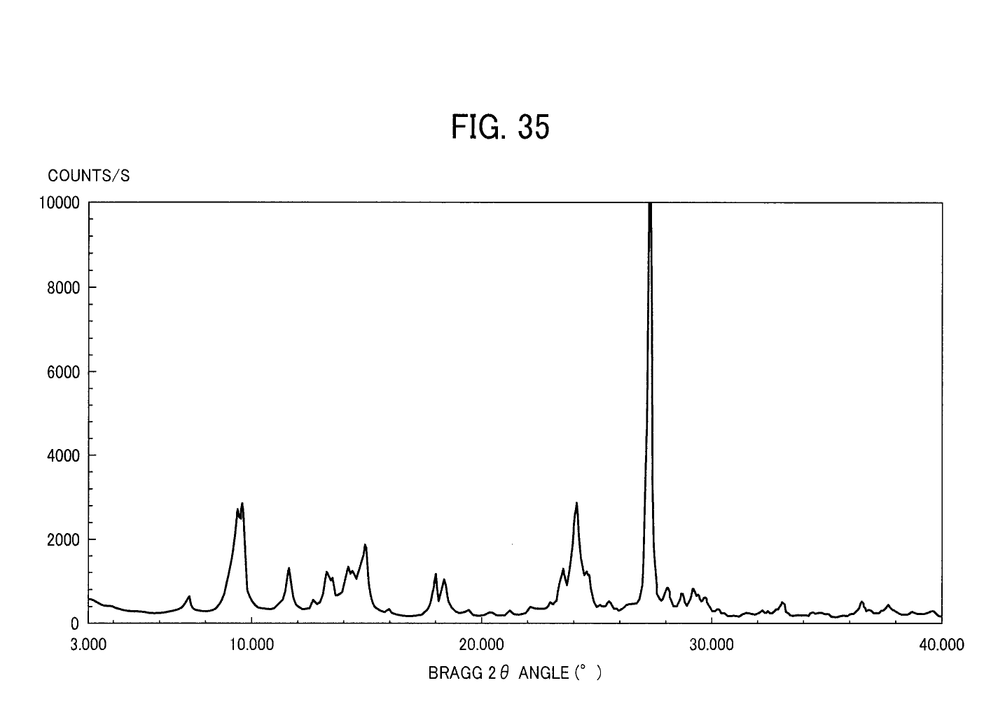

As illustrated in FIG. 34, the process cartridge includes an image bearing drum 101 and at least one of devices of a group consisting of a charger 102, a development device 104, a transfer device 106, a cleaner 107, and a discharger and is detachably mounted to the image forming apparatus.

Next, the image formation process by the process cartridge illustrated in FIG. 34 is described. The image bearing drum 101 is charged by the charger 102 and exposed with beams of light 103 by an exposure device to form a latent electrostatic image corresponding to the exposure image on the surface of the image bearing drum 101 while the image bearing drum 101 is rotating.

This latent electrostatic image is developed with toner by the development device 104 and the obtained toner image is transferred by the transfer device 106 to a recording medium 105 and printed out. The surface of the image bearing drum 101 after the image is transferred is cleaned by the cleaner 107 and discharged by the discharger in order to be ready for the next image formation, which repeats the processes described above.

Having generally described (preferred embodiments of) this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but not limited thereto.

### Example A-1

### Manufacturing of Image Bearing Drum A-1

The liquid application for an undercoating layer having the following recipe, the liquid application of a charge generating layer having the following recipe, and the liquid application of a charge transport layer having the following recipe are applied to an aluminum cylinder having a diameter of 60 mm in this order and dried to form an undercoating layer having an average thickness of about 3.0 μm, a charge generating layer having an average thickness of about 0.2 μm, and a charge transport layer having an average thickness of about 20 μm.

### Liquid Application for Undercoating Layer

| | | |
|---|---|---|
| Alkyd resin (Beckozole 1307-60-EL, manufactured by | 6 | parts |
| DIC Corporation) | | |
| Melamine resin (Super Beckamine G-821-60, | 4 | parts |
| manufactured by DIC Corporation) | | |
| Titanium oxide (CR-EL, manufactured by ISHIHARA | 40 | parts |
| SANGYO KAISHA, LTD): | | |
| Methylethylketone: | 50 | parts |
| Liquid Application for Charge Generating Layer | | |
| Titanyl phthalocyanine pigment represented by | 1.5 | parts |
| Chemical Structure 25 | | |
| Polyvinyl butyral {XYHL, manufactured by Union | 1.0 | part |
| Carbide Corporation (UCC)} | | |
| Methylethylketone: | 80 | parts |

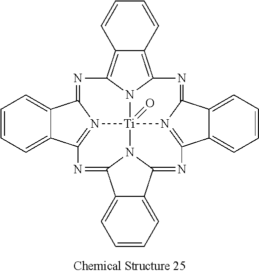

FIG. 35 is a graph illustrating the result of X ray diffraction of the titanyl phthalocyanine pigment represented by Chemical Structure 25. The measuring conditions are as follows.

### Measuring Conditions of X Ray Diffraction Spectrum

X ray tube: Cu

Voltage: 50 kV

Current: 30 mA

Scanning speed: 2°/min

Scanning range: 3° to 40°

Time constant: 2 seconds

Liquid Application for Charge Transport Layer

| | | |
|---|---|---|
| Bisphenol Z polycarbonate (PanLite TS-2050, manufactured | 10 | parts |
| by Teijin Chemicals Ltd.): | | |
| Charge transport material having a low molecular weight | 10 | parts |
| represented by the following Chemical Structure 26 | | |
| Tetrahydrofuran: | 100 | parts |
| Tetrahydrofuran solution of 1% by weight Silicone oil (KF- | 0.2 | parts |
| 50-100 CS, manufactured by Shin-Etsu Chemical Co., Ltd.) | | |

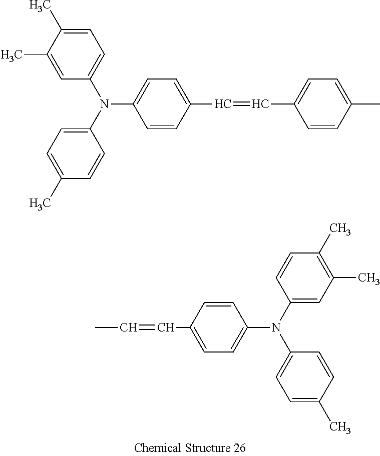

Liquid Application for Protective layer

| | | |
|---|---|---|
| Bisphenol Z type polycarbonate resin (PANLITE | 4 | parts |
| TS2050, manufactured by Teijin Chemicals Ltd.) | | |
| Alumina (Sumicorumdum AA03, average primary | 3 | parts |
| particle diameter: 0.3 μm, manufactured by | | |
| Sumitomo Chemical Co., Ltd.) | | |
| Tetrahydrofuran: | 170 | parts |
| Cyclohexanone | 50 | parts |

The liquid application of the protective layer prescribed above is applied to the charge transport layer by a spray gun. The spray gun is A100, manufactured by MEIJI AIR COMPRESSOR MFG. CO., LTD. The spraying application conditions are as follows:

Distance between nozzle and sleeve: 50 mm

Atomization air pressure: 1.0 kg/cm²

Air flowing amount: 17.0 L/min

Discharging amount: 0.06 ml/s

Moving speed of spray gun: 3.5 mm/s

Number of rotation of drum: 180 rpm

Finger touch drying time: three minutes

In the present disclosure, 1 kg/cm² is equal to 98.07 kPa.

After applying the liquid application of the protective layer, the protective layer is dried at 130° C. for 20 minutes to form a protective layer having an average thickness of 3 μm.

The flange members illustrated in FIGS. 7A and 7B (hereinafter referred to as FIG. 7) are pressed in (pressing-in time: five seconds) the opening portions of the aluminum drum of the thus-manufactured sleeve as described above to which the photosensitive layer and the protective layer are provided to manufacture an image bearing drum A-1. The flange members are made of polycarbonate.

### Example A-2

### Manufacturing of Image Bearing Drum A-2

The image bearing drum A-2 is manufactured in the same manner as in Example A-1 except that the atomization air pressure when spraying the liquid application of the protective layer is changed to 0.9 kg/cm².

### Example A-3

### Manufacturing of Image Bearing Drum A-3

The image Bearing Drum A-3 is manufactured in the same manner as in Example A-1 except that the atomization air pressure when spraying the liquid application of the protective layer is changed to 0.8 kg/cm².

### Example A-4

### Manufacturing of Image Bearing Drum A-4

The image bearing drum A-4 is manufactured in the same manner as in Example A-1 except that the atomization air pressure when spraying the liquid application of the protective layer is changed to 0.7 kg/cm².

### Example A-5

### Manufacturing of Image Bearing Drum A-5

The image bearing drum A-5 is manufactured in the same manner as in Example A-1 except that the atomization air pressure when spraying the liquid application of the protective layer is changed to 0.6 kg/cm².

### Example A-6

### Manufacturing of Image Bearing Drum A-6

The image bearing drum A-6 is manufactured in the same manner as in Example A-1 except that the amount of the solvent of the liquid application of the protective layer is changed to 54 parts (36 parts of tetrahydrofuran and 18 parts of cyclohexanone) and the oscillating speed (moving speed of the spray gun) when applying the liquid application of the protective layer by the spray gun is changed to 7.0 mm/s.

### Example A-7

### Manufacturing of Image Bearing Drum A-7

The image bearing drum A-7 is manufactured in the same manner as in Example A-6 except that the atomization air pressure when spraying the liquid application of the protective layer is changed to 0.9 kg/cm².

### Example A-8

### Manufacturing of Image Bearing Drum A-8

The image bearing drum A-8 is manufactured in the same manner as in Example A-6 except that the atomization air pressure when spraying the liquid application of the protective layer is changed to 0.8 kg/cm².

### Example A-9

### Manufacturing of Image Bearing Drum A-9

The image bearing drum A-9 is manufactured in the same manner as in Example A-3 except that the filler in the liquid application of the protective layer is changed to silica particulates (KMPX-100; average primary particle diameter: 0.1 μm, manufactured by Shin-Etsu Chemical Co., Ltd.).

### Example A10

### Manufacturing of Image Bearing Drum A-10

The image bearing drum A-10 is manufactured in the same manner as in Example A-3 except that the following materials are added to the liquid application of the protective layer.
Radical polymerizable monomer having three or more functional groups with no charge transport structure: [dipentaerythritol caprolactone modified hexaacrylate (KAYARAD DPCA-120, manufactured by Nippon Kayaku Co., Ltd.; molecular weight: 1,947, Number of functional groups: 6)]: 10 parts

### Example A-11

### Manufacturing of Image Bearing Drum A-11

The image bearing drum A-11 is manufactured in the same manner as in Example A-3 except that the filler in the liquid application of the protective layer is changed to alumina particulates (Sumicorundum AA07, average primary particle diameter: 0.7 μm, manufactured by Sumitomo Chemical Co., Ltd.).

### Example A-12

### Manufacturing of Image Bearing Drum A-12

The image bearing drum A-12 is manufactured in the same manner as in Example A-3 except that the filler in the liquid application of the protective layer is changed to melamine formaldehyde condensed organic particulates (EPOSTAR S-6; average primary particle diameter: 0.6 μm, manufactured by Nippon Shokubai Co., Ltd.)

### Example A-13 Manufacturing of Image Bearing Drum A-13

The image bearing drum A-13 is manufactured in the same manner as in Example A-3 except that the photopolymerization initiator of the liquid application for protective layer is changed to the following thermopolymerization initiator, the amount of the solvent of the liquid application of the protective layer is changed to 34 parts (20 parts of tetrahydrofuran and 14 parts of cyclohexanone), the atomization air pressure when spraying the liquid application of the protective layer is changed to 1.0 kg/cm², the atomization air flowing amount is changed to 15.0 L/min., and the protective layer is dried at 130° C. for 30 minutes without exposure to ultraviolet after the application by spraying.
Thermopolymerizaion initiator: 2,2-bis(4,4-di-t-butylperoxy cyclohexy) propane (Perkadox 12-EB-20, manufactured by Kayak Akzo Corporation)

### Example A-14

### Manufacturing of Image Bearing Drum A-14

The image bearing drum A-14 is manufactured in the same manner as in Example A-3 except that the amount of the solvent for the liquid application of the protective layer is halved for each and acentone is mixed instead.

### Example A-15

### Manufacturing of Image Bearing Drum A-15

The image bearing drum A-15 is manufactured in the same manner as in Example A-1 except that the amount of the solvent of the liquid application of the protective layer is changed to 54 parts (36 parts of tetrahydrofuran and 18 parts of cyclohexanone) and the oscillating speed (moving speed of the spray gun) when applying the liquid application of the protective layer by the spray gun is changed to 10.0 mm/s.

### Example A-16

### Manufacturing of Image Bearing Drum A-16

The image bearing drum A-16 is manufactured in the same manner as in Example A-1 except that the flange members are changed to the flange members illustrated in FIG. 9.

### Example A-17

### Manufacturing of Image Bearing Drum A-17

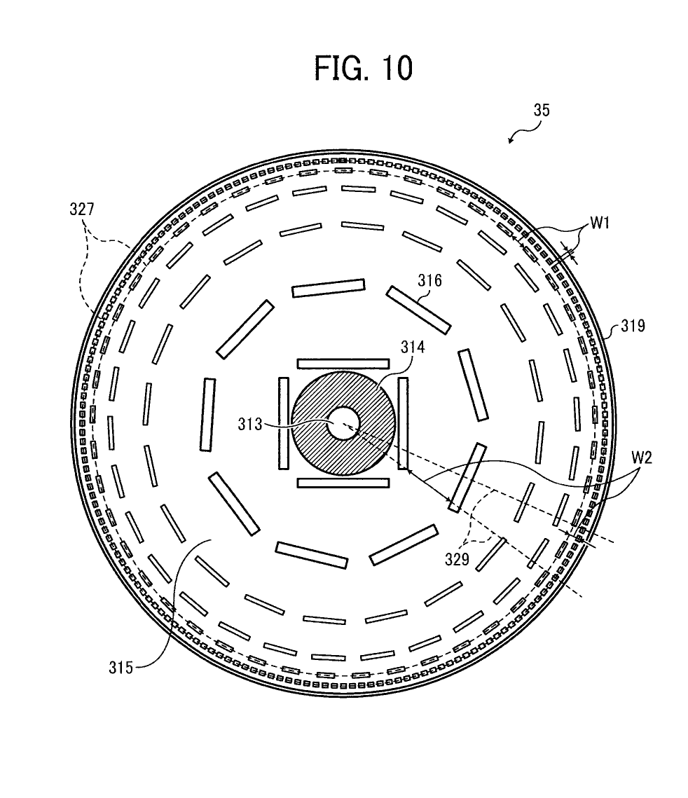

The image bearing drum A-17 is manufactured in the same manner as in Example A-1 except that the flange members are changed to the flange members illustrated in FIG. 10.

### Example A-18

### Manufacturing of Image Bearing Drum A-18

The image bearing drum A-18 is manufactured in the same manner as in Example A-1 except that the flange members are changed to the flange members illustrated in FIG. 16.

### Example A-19

### Manufacturing of Image Bearing Drum A-19

The image bearing drum A-19 is manufactured in the same manner as in Example A-1 except that the flange members are changed to the flange members illustrated in FIG. 14.

### Example A-20

### Manufacturing of Image Bearing Drum A-20

The image bearing drum A-20 is manufactured in the same manner as in Example A-1 except that the flange members are changed to the flange members illustrated in FIG. 18.

### Example B-1

### Manufacturing of Image Bearing Drum B-1

The image bearing drum B-1 is manufactured in the same manner as in Example A-1 except that the following liquid application of the protective layer is applied under the following application conditions instead when forming the protective layer.

Liquid Application of Protective layer

Place alumina balls having a diameter of 5 mm in a glass pot followed by placing the following filler, a polycarbonate compound, and cyclopentanone and disperse the mixture for 24 hours (150 rpm) by a ball mill to disperse the filler.

Thereafter, tetrahydrofuran is added thereto followed by stirring to obtain a mill base (having the following blending).

The mill base is mixed with a solution in which other materials are preliminarily mixed to prepare a liquid application of the protective layer.

### Mill Base

| | | |
|---|---|---|
| Alumina (Sumicorumdum AA03, average primary | 8 | parts |
| particle diameter: 0.3 μm, manufactured by | | |
| Sumitomo Chemical Co., Ltd.): | | |
| Polycarbonate compound (polymer solution of | 0.2 | parts |
| low molecular weight unsaturated polycarbonate: | | |
| BYK-P104; non-volatile portion: 50% by weight, | | |
| manufactured by Byk Chemie) | | |
| Cyclopentanone | 8 | parts |
| Tetrahydrofuran: | 12 | parts |

Liquid Application of Protective layer

| | | |
|---|---|---|
| Mill Base: | 6.5 | parts |
| Radical polymerizable monomer having three or | 10 | parts |
| more functional groups with no charge transport | | |
| structure: Trimethylol propane triacrylate | | |
| (KAYARAD TMPTA, molecular weight: 296; | | |
| number of functional groups: 3, manufactured by | | |
| Nippon Kayak Co., Ltd.) | | |
| Photopolymerization Initiator (Irgacure 184, | 1 | part |
| molecular weight: 204, manufactured by Nippon | | |
| Kayak Co., Ltd.) | | |
| Leveling agent (BYK-UV-3570, manufactured by | 0.2 | parts |
| Byk Chemie): | | |
| Tetrahydrofuran: | 115 | parts |

The liquid application of the protective layer prescribed above is applied to the charge transport layer by spraying.

The spray gun is A100, manufactured by MEIJI AIR COMPRESSOR MFG. CO., LTD. The spraying application conditions are as follows:

Distance between nozzle and sleeve: 50 mm

Atomization air pressure: 1.0 kg/cm²

Air flowing amount: 17.0 L/min

Discharging amount: 0.06 ml/s

Moving speed of spray gun: 3.5 mm/s

Number of rotation of drum: 180 rpm

Finger touch drying time: three minutes

After applying the liquid application of the protective layer, the sleeve is cured by UV exposure by an ultraviolet exposing device (UV lamp system, manufactured by Fusion UV Systems Inc.) while rotating the sleeve at 30 rpm. A V valve is used for the lamp for the UV exposure with a distance between the UV lamp and the surface of the photoreceptor drum of 53 mm, an exposure intensity of 500 mW/cm², and a UV exposure time of 60 seconds to cure the applied film.

After UV exposure, the protective layer is dried at 130° C. for 20 minutes to form a protective layer having an average thickness of 3 μm.

### Example B-2

### Manufacturing of Image Bearing Drum B-2

The image bearing drum B-2 is manufactured in the same manner as in Example B-1 except that the atomization air pressure of the spray when forming the protective layer is changed to 0.9 kg/cm².

### Example B-3

### Manufacturing of Image Bearing Drum B-3

The image bearing drum B-3 is manufactured in the same manner as in Example B-1 except that the atomization air pressure of the spray when forming the protective layer is changed to 0.8 kg/cm².

### Example B-4

### Manufacturing of Image Bearing Drum B-4

The image bearing drum B-4 is manufactured in the same manner as in Example B-1 except that the atomization air pressure of the spray when forming the protective layer is changed to 0.7 kg/cm².

### Example B-5

### Manufacturing of Image Bearing Drum B-5

The image bearing drum B-5 is manufactured in the same manner as in Example B-1 except that the atomization air pressure of the spray when forming the protective layer is changed to 0.6 kg/cm².

### Example B-6

### Manufacturing of Image Bearing Drum B-6

The image bearing drum B-6 is manufactured in the same manner as in Example B-1 except that the amount of the solvent of the liquid application of the protective layer is changed to 54 parts (36 parts of tetrahydrofuran and 18 parts of cyclohexanone) and the oscillating speed (moving speed of the spray gun) when applying the liquid application of the protective layer by the spray gun is changed to 7.0 mm/s.

### Example B-7

### Manufacturing of Image Bearing Drum B-7

The image bearing drum B-7 is manufactured in the same manner as in Example B-6 except that the atomization air pressure when spraying the liquid application of the protective layer is changed to 0.9 kg/cm².

### Example B-8

### Manufacturing of Image Bearing Drum B-8

The image bearing drum B-8 is manufactured in the same manner as in Example B-6 except that the atomization air pressure when spraying the liquid application of the protective layer is changed to 0.8 kg/cm².

### Example B-9

### Manufacturing of Image Bearing Drum B-9

The image bearing drum B-9 is manufactured in the same manner as in Example B-3 except that the filler in the liquid application of the protective layer is changed to silica particulates (KMPX-100; average primary particle diameter: 0.1 μm, manufactured by Shin-Etsu Chemical Co., Ltd.).

### Example B-10

### Manufacturing of Image Bearing Drum B-10

The photoreceptor of Example B-10 is manufactured in the same manner as in Example B-3 except that the radical polymerizable monomer having three or more functional groups without a charge transport structure contained in the liquid application for protective layer is replaced with the following material.

Radical polymerizable monomer having three or more functional groups with no charge transport structure: dipentaerythritol caprolactone modified hexaacrylate (KAYARAD DPCA-120, molecular weight of 1,947, number of functional groups: 6, manufactured by Nippon Kayaku Co., Ltd.)]

### Example B-11

### Manufacturing of Image Bearing Drum B-11

The image bearing drum B-11 is manufactured in the same manner as in Example B-3 except that the filler in the liquid application of the protective layer is changed to alumina particulates (Sumicorundum AA07, average primary particle diameter: 0.7 μm, manufactured by Sumitomo Chemical Co., Ltd.).

### Example B-12

### Manufacturing of Image Bearing Drum B-12

The image bearing drum B-12 is manufactured in the same manner as in Example B-3 except that the filler in the liquid application of the protective layer is changed to melamine formaldehyde condensed organic particulates (EPOSTAR S-6; average primary particle diameter: 0.6 μm, manufactured by Nippon Shokubai Co., Ltd.)

### Example B-13

### Manufacturing of Image Bearing Drum B-13

The image bearing drum B-13 is manufactured in the same manner as in Example B-3 except that the photopolymerization initiator of the liquid application for protective layer is changed to the following thermopolymerization initiator, the amount of the solvent of the liquid application of the protective layer is changed to 34 parts (20 parts of tetrahydrofuran and 14 parts of cyclohexanone), the atomization air pressure when applying the liquid application of the protective layer is changed to 1.0 kg/cm², the atomization air flowing amount is changed to 15.0 L/min., and the protective layer is dried at 130° C. for 30 minutes without exposure to ultraviolet after the application by spraying.

Thermopolymerizaion initiator: Perkadox 12-EB-20, 2,2-bis(4,4-di-t-butylperoxycyclohexy) propane, manufactured by Kayak Akzo Corporation)

### Example B-14

### Manufacturing of Image Bearing Drum B-14

The image bearing drum B-14 is manufactured in the same manner as in Example B-3 except that the amount of the solvent for the liquid application of the protective layer is halved for each and acentone is mixed instead.

### Example B-15

### Manufacturing of Image Bearing Drum B-15

The image bearing drum B-15 is manufactured in the same manner as in Example B-1 except that the amount of the solvent of the liquid application of the protective layer is changed to 54 parts (36 parts of tetrahydrofuran and 18 parts of cyclohexanone) and the oscillating speed (moving speed of the spray gun) when applying the liquid application of the protective layer by the spray gun is changed to 10.0 mm/s.

### Example B-16

### Manufacturing of Image Bearing Drum B-16

The image bearing drum B-16 is manufactured in the same manner as in Example B-1 except that the flange members are changed to the flange members illustrated in FIG. 9.

### Example B-17

### Manufacturing of Image Bearing Drum B-17

The image bearing drum B-17 is manufactured in the same manner as in Example B-1 except that the flange members are changed to the flange members illustrated in FIG. 10.

### Example B-18

### Manufacturing of Image Bearing Drum B-18

The image bearing drum B-18 is manufactured in the same manner as in Example B-1 except that the flange members are changed to the flange members illustrated in FIG. 16.

### Example B-19

### Manufacturing of Image Bearing Drum B-19

The image bearing drum B-19 is manufactured in the same manner as in Example B-1 except that the flange members are changed to the flange members illustrated in FIG. 14.

### Example B-20

### Manufacturing of Image Bearing Drum B-20

The image bearing drum B-20 is manufactured in the same manner as in Example B-1 except that the flange members are changed to the flange members illustrated in FIG. 18.

### Example C-1

### Manufacturing of Image Bearing Drum C-1

The image bearing drum C-1 is manufactured in the same manner as in Example A-1 except that the following liquid application of the protective layer is applied under the following application conditions instead when forming the protective layer.

### Liquid Application of Protective Layer

Place alumina balls having a diameter of 5 mm in a glass pot followed by placing the following filler, a polycarbonate compound, and cyclopentanone and disperse the mixture for 24 hours (150 rpm) by a ball mill to disperse the filler.

Thereafter, tetrahydrofuran is added thereto followed by stirring to obtain a mill base (having the following blending). The mill base is mixed with a solution in which other materials are preliminarily mixed to prepare a liquid application of the protective layer.

| Mill Base | | |
|---|---|---|
| Alumina (Sumicorumdum AA03, average primary | 8 | parts |
| particle diameter: 0.3 μm, manufactured by | | |
| Sumitomo Chemical Co., Ltd.): | | |
| Polycarbonate compound (polymer solution of | 0.2 | parts |
| low molecular weight unsaturated polycarbonate: | | |
| BYK-P104; non-volatile portion: 50% by weight, | | |
| manufactured by Byk Chemie): | | |
| Cyclopentanone | 8 | parts |
| Tetrahydrofuran: | 12 | parts |

Liquid Application of Protective layer

| | | |
|---|---|---|
| Mill Base: | 6.5 | parts |
| Radical polymerizable compound having a charge | 10 | parts |
| transport structure represented by the following | | |
| Chemical Structure 27: | | |

| | |
|---|---|
| 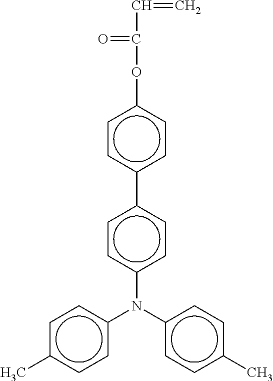 | Chemical Structure 27 |

| | | |
|---|---|---|
| Radical polymerizable monomer having three or more | 10 | parts |
| functional groups with no charge transport structure: | | |
| Trimethylol propane triacrylate (KAYARAD TMPTA, | | |
| molecular weight: 296; number of functional groups: 3, | | |
| manufactured by Nippon Kayak Co., Ltd.): | | |
| Photopolymerization Initiator (Irgacure 184, molecular | 1 | part |
| weight: 204, manufactured by Nippon Kayak Co., Ltd.) | | |
| Leveling agent (BYK-UV-3570, manufactured by Byk | 0.2 | parts |
| Chemie): | | |
| Tetrahydrofuran: | 115 | parts |

The liquid application of the protective layer prescribed above is applied to the charge transport layer by spraying. The spray gun is A100, manufactured by MEIJI AIR COMPRESSOR MFG. CO., LTD. The spraying conditions are as follows:

Distance between nozzle and sleeve: 50 mm

Atomization air pressure: 1.0 kg/cm²

Air flowing amount: 17.0 L/min

Discharging amount: 0.06 ml/s

Moving speed of spray gun: 3.5 mm/s

Number of rotation of drum: 180 rpm

Finger touch drying time: three minutes

After applying the liquid application of the protective layer, the sleeve is cured by UV exposure by an ultraviolet exposing device (UV lamp system, manufactured by Fusion UV Systems Inc.) while rotating the sleeve at 30 rpm. A V valve is used for the lamp for the UV exposure with a distance between the UV lamp and the surface of the photoreceptor drum of 53 mm, an exposure intensity of 500 mW/cm², and a UV exposure time of 60 seconds to cure the applied film.

After UV exposure, the protective layer is dried at 130° C. for 20 minutes to form a protective layer having an average thickness of 3 μm.

### Example C-2

### Manufacturing of Image Bearing Drum C-2

The image bearing drum C-2 is manufactured in the same manner as in Example C-1 except that the atomization air pressure when spraying the liquid application of the protective layer is changed to 0.9 kg/cm².

### Example C-3

### Manufacturing of Image Bearing Drum C-3

The image bearing drum C-3 is manufactured in the same manner as in Example C-1 except that the atomization air pressure when spraying the liquid application of the protective layer is changed to 0.8 kg/cm².

### Example C-4

### Manufacturing of Image Bearing Drum C-4

The image bearing drum C-4 is manufactured in the same manner as in Example C-1 except that the atomization air pressure when spraying the liquid application of the protective layer is changed to 0.7 kg/cm².

### Example C-5

### Manufacturing of Image Bearing Drum C-5

The image bearing drum C-5 is manufactured in the same manner as in Example C-1 except that the atomization air pressure when spraying the liquid application of the protective layer is changed to 0.6 kg/cm².

### Example C-6

### Manufacturing of Image Bearing Drum C-6

The image bearing drum C-6 is manufactured in the same manner as in Example B-1 except that the amount of the solvent of the liquid application of the protective layer is changed to 54 parts (36 parts of tetrahydrofuran and 18 parts of cyclohexanone) and the oscillating speed (moving speed of the spray gun) when applying the liquid application of the protective layer by the spray gun is changed to 7.0 mm/s.

### Example C-7

### Manufacturing of Image Bearing Drum C-7

The image bearing drum C-7 is manufactured in the same manner as in Example C-6 except that the atomization air pressure when spraying the liquid application of the protective layer is changed to 0.9 kg/cm².

### Example C-8

### Manufacturing of Image Bearing Drum C-8

The image bearing drum C-8 is manufactured in the same manner as in Example C-6 except that the atomization air pressure when spraying the liquid application of the protective layer is changed to 0.8 kg/cm².

### Example C-9

### Manufacturing of Image Bearing Drum C-9

The image bearing drum C-9 is manufactured in the same manner as in Example C-3 except that the filler in the liquid application for protective layer is changed to silica particulates (KMPX-100; average primary particle diameter: 0.1 μm, manufactured by Shin-Etsu Chemical Co., Ltd.).

### Example C-10

### Manufacturing of Image Bearing Drum C-10

The photoreceptor of Example C-10 is manufactured in the same manner as in Example C-3 except that the radical polymerizable monomer having three or more functional groups without a charge transport structure contained in the liquid application of the protective layer is replaced with the following material.

Radical polymerizable monomer having three or more functional groups with no charge transport structure: [dipentaerythritol caprolactone modified hexaacrylate (KAYARAD DPCA-120, molecular weight of 1,947, number of functional groups: 6, manufactured by Nippon Kayaku Co., Ltd.)]

### Example C-11

### Manufacturing of Image Bearing Drum C-11

The image bearing drum C-11 is manufactured in the same manner as in Example C-3 except that the filler in the liquid application of the protective layer is changed to alumina particulates (Sumicorundum AA07, average primary particle diameter: 0.7 μm, manufactured by Sumitomo Chemical Co., Ltd.).

### Example C-12

### Manufacturing of Image Bearing Drum C-12

The image bearing drum C-12 is manufactured in the same manner as in Example C-3 except that the filler in the liquid application of the protective layer is changed to melamine formaldehyde condensed organic particulates (EPOSTAR S-6; average primary particle diameter: 0.6 μm, manufactured by Nippon Shokubai Co., Ltd.)

### Example C-13

### Manufacturing of Image Bearing Drum C-13

The image bearing drum C-13 is manufactured in the same manner as in Example C-3 except that the photopolymerization initiator of the liquid application for protective layer is changed to the following thermopolymerization initiator, the amount of the solvent of the liquid application of the protective layer is changed to 34 parts (20 parts of tetrahydrofuran and 14 parts of cyclohexanone), the atomization air pressure when applying the liquid application for protective layer is changed to 1.0 kg/cm², the atomization air flowing amount is changed to 15.0 L/min., and the protective layer is dried at 130° C. for 30 minutes without exposure to ultraviolet after the application by spraying.

Thermopolymerizaion initiator: Perkadox 12-EB-20, 2,2-bis(4,4-di-t-butylperoxycyclohexy) propane, manufactured by Kayak Akzo Corporation)

### Example C-14

### Manufacturing of Image Bearing Drum C-14

The image bearing drum C-14 is manufactured in the same manner as in Example C-3 except that the amount of the solvent for the liquid application of the protective layer is halved for each and acentone is mixed instead.

### Example C-15

### Manufacturing of Image Bearing Drum C-15

The image bearing drum C-15 is manufactured in the same manner as in Example C-1 except that the amount of the solvent of the liquid application of the protective layer is changed to 54 parts (36 parts of tetrahydrofuran and 18 parts of cyclohexanone) and the oscillating speed (moving speed of the spray gun) when applying the liquid application of the protective layer by the spray gun is changed to 10.0 mm/s.

### Example C-16

### Manufacturing of Image Bearing Drum C-16

The image bearing drum C-16 is manufactured in the same manner as in Example C-1 except that the flange members are changed to the flange members illustrated in FIG. 9.

### Example C-17

### Manufacturing of Image Bearing Drum C-17

The image bearing drum C-17 is manufactured in the same manner as in Example C-1 except that the flange members are changed to the flange members illustrated in FIG. 10.

### Example C-18

### Manufacturing of Image Bearing Drum C-18

The image bearing drum C-18 is manufactured in the same manner as in Example C-1 except that the flange members are changed to the flange members illustrated in FIG. 16.

### Example C-19

### Manufacturing of Image Bearing Drum C-19

The image bearing drum C-19 is manufactured in the same manner as in Example C-1 except that the flange members are changed to the flange members illustrated in FIG. 14.

### Example C-20

### Manufacturing of Image Bearing Drum C-20

The image bearing drum C-20 is manufactured in the same manner as in Example C-1 except that the flange members are changed to the flange members illustrated in FIG. 18.

### Comparative Examples D-1 to D-14

### Manufacturing of Image Bearing Drums D-1 to D-14

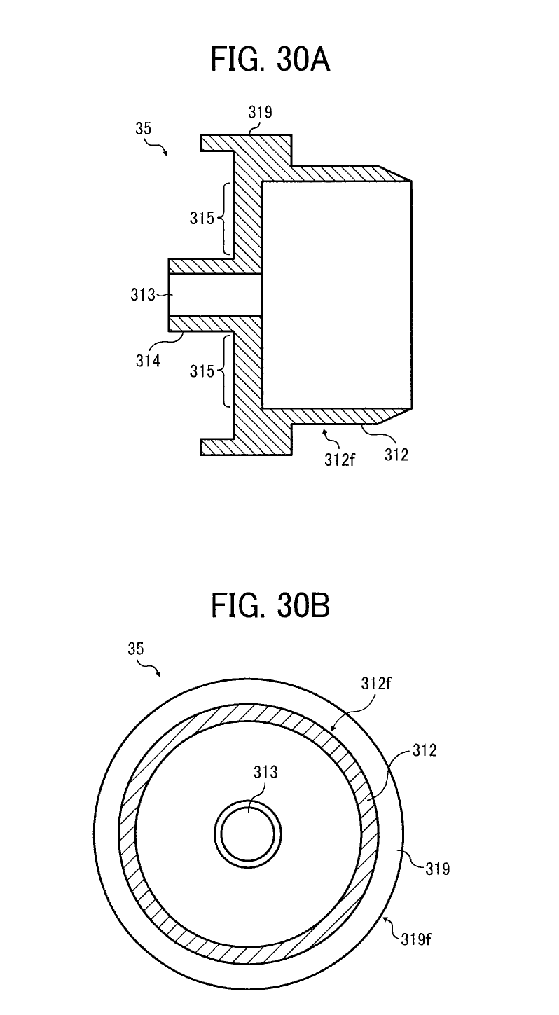

The image bearing drums D-1 to D14 are manufactured in the same manner as in Examples A-1 to A-14, respectively, except that the flange members are replaced with the flange members illustrated in FIGS. 30A and 30B (hereinafter referred to as FIG. 30).

### Comparative Examples D-15

### Manufacturing of Image Bearing Drum D-15

The image bearing drum D-15 is manufactured in the same manner as in Example A-1 except that the atomization air pressure when spraying the liquid application of the protective layer is changed to 1.1 kg/cm².

### Comparative Examples D-16

### Manufacturing of Image Bearing Drum D-16

The image bearing drum D-16 is manufactured in the same manner as in Example A-1 except that the atomization air pressure when spraying the liquid application of the protective layer is changed to 1.3 kg/cm².

### Comparative Examples D-17

### Manufacturing of Image Bearing Drum D-17

The image bearing drum D-17 is manufactured in the same manner as in Example A-1 except that the atomization air pressure when spraying the liquid application of the protective layer is changed to 0.5 kg/cm².

### Comparative Examples D-18

### Manufacturing of Image Bearing Drum D-18

The photoreceptor drum D-18 is manufactured in the same manner as in Example A-1 except that the amount of the solvent of the liquid application of the protective layer is changed to 54 parts (36 parts of tetrahydrofuran and 18 parts of cyclohexanone) and the oscillating speed (moving speed of the spray gun) and the atomization air pressure when applying the liquid application of the protective layer by the spray gun are changed to 7.0 mm/s and 0.6 kg/cm², respectively.

### Comparative Examples D-19

### Manufacturing of Image Bearing Drum D-19

The image bearing drum D-19 is manufactured in the same manner as in Example A-1 except that the amount of the solvent of the liquid application of the protective layer is changed to 208 parts (120 parts of tetrahydrofuran and 88 parts of cyclohexanone) and the oscillating speed (moving speed of the spray gun) and the atomization air pressure when applying the liquid application of the protective layer by the spray gun are changed to 2.3 mm/s and 0.5 kg/cm², respectively.

### Comparative Examples D-20

### Manufacturing of Image Bearing Drum D-20

The image bearing drum D-20 is manufactured in the same manner as in Example A-1 except that the amount of the solvent of the liquid application of the protective layer is changed to 208 parts (120 parts of tetrahydrofuran and 88 parts of cyclohexanone) and the oscillating speed (moving speed of the spray gun) and the atomization air pressure when applying the liquid application of the protective layer by the spray gun are changed to 2.3 mm/s and 1.3 kg/cm², respectively.

### Comparative Examples D-21

### Manufacturing of Image Bearing Drum D-21

The image bearing drum D-21 is manufactured in the same manner as in Example A-1 except that the filler is not blended in the liquid application of the protective layer.

### Comparative Examples D-22

### Manufacturing of Image Bearing Drum D-22

The image bearing drum D-22 is manufactured in the same manner as in Example A-2 except that the filler is not blended in the liquid application of the protective layer.

### Comparative Examples E-1 to E-14

### Manufacturing of Image Bearing Drums E-1 to E-14

The image bearing drums E-1 to E-14 are manufactured in the same manner as in Examples B-1 to B-14, respectively, except that the flange members are changed to the flange members illustrated in FIGS. 30A and 30B.

### Comparative Example E-15

### Manufacturing of Image Bearing Drum E-15

The image bearing drum E-15 is manufactured in the same manner as in Example B-1 except that the atomization air pressure when spraying the liquid application of the protective layer is changed to 1.1 kg/cm².

### Comparative Example E-16

### Manufacturing of Image Bearing Drum E-16

The image bearing drum E-16 is manufactured in the same manner as in Example B-1 except that the atomization air pressure when spraying the liquid application of the protective layer is changed to 1.3 kg/cm².

### Comparative Example E-17

### Manufacturing of Image Bearing Drum E-17

The image bearing drum E-17 is manufactured in the same manner as in Example B-1 except that the atomization air pressure when spraying the liquid application of the protective layer is changed to 0.5 kg/cm².

### Comparative Example E-18

### Manufacturing of Image Bearing Drum E-18

The image bearing drum E-18 is manufactured in the same manner as in Example B-1 except that the amount of the solvent of the liquid application of the protective layer is changed to 54 parts (36 parts of tetrahydrofuran and 18 parts of cyclopentanone) and the oscillating speed (moving speed of the spray gun) and the atomization air pressure when applying the liquid application of the protective layer by the spray gun are changed to 7.0 mm/s and 0.6 kg/cm², respectively.

### Comparative Example E-19

### Manufacturing of Image Bearing Drum E-19

The image bearing drum E-19 is manufactured in the same manner as in Example B-1 except that the amount of the solvent of the liquid application of the protective layer is changed to 208 parts (120 parts of tetrahydrofuran and 88 parts of cyclopentanone) and the oscillating speed (moving speed of the spray gun) and the atomization air pressure when applying the liquid application of the protective layer by the spray gun are changed to 2.3 mm/s and 0.5 kg/cm², respectively.

### Comparative Example E-20

### Manufacturing of Image Bearing Drum E-20

The image bearing drum E-20 is manufactured in the same manner as in Example B-1 except that the amount of the solvent of the liquid application of the protective layer is changed to 208 parts (120 parts of tetrahydrofuran and 88 parts of cyclopentanone) and the oscillating speed (moving speed of the spray gun) and the atomization air pressure when applying the liquid application of the protective layer by the spray gun are changed to 2.3 mm/s and 1.3 kg/cm², respectively.

### Comparative Example E-21

### Manufacturing of Image Bearing Drum E-21

The image bearing drum E-21 is manufactured in the same manner as in Example B-1 except that the filler is not blended in the liquid application for protective layer.

### Comparative Example E-22

### Manufacturing of Image Bearing Drum E-22

The image bearing drum E-22 is manufactured in the same manner as in Example B-2 except that the filler is not blended in the liquid application for protective layer.

### Comparative Examples F-1 to F-14

### Manufacturing of Image Bearing Drums F-1 to F-14

The image bearing drums F-1 to F-14 are manufactured in the same manner as in Examples C-1 to C-14 except that the flange members are changed to the flange members illustrated in FIGS. 30A and 30B.

### Comparative Examples F-15

### Manufacturing of Image Bearing Drum F-15

The image bearing drum F-15 is manufactured in the same manner as in Example C-1 except that the atomization air pressure when spraying the liquid application of the protective layer is changed to 1.1 kg/cm².

### Comparative Examples F-16

### Manufacturing of Image Bearing Drum F-16

The image bearing drum F-16 is manufactured in the same manner as in Example C-1 except that the atomization air pressure when spraying the liquid application of the protective layer is changed to 1.3 kg/cm².

### Comparative Examples F-17

### Manufacturing of Image Bearing Drum F-17

The image bearing drum F-17 is manufactured in the same manner as in Example C-1 except that the atomization air pressure when spraying the liquid application of the protective layer is changed to 0.5 kg/cm².

### Comparative Examples F-18

### Manufacturing of Image Bearing Drum F-18

The image bearing drum F-18 is manufactured in the same manner as in Example C-1 except that the amount of the solvent of the liquid application of the protective layer is changed to 54 parts (36 parts of tetrahydrofuran and 18 parts of cyclopentanone) and the oscillating speed (moving speed of the spray gun) and the atomization air pressure when applying the liquid application of the protective layer by the spray gun are changed to 7.0 mm/s and 0.6 kg/cm², respectively.

### Comparative Examples F-19

### Manufacturing of Image Bearing Drum F-19

The image bearing drum F-19 is manufactured in the same manner as in Example C-1 except that the amount of the solvent of the liquid application of the protective layer is changed to 208 parts (120 parts of tetrahydrofuran and 88 parts of cyclopentanone) and the oscillating speed (moving speed of the spray gun) and the atomization air pressure when applying the liquid application of the protective layer by the spray gun are changed to 2.3 mm/s and 0.5 kg/cm², respectively.

### Comparative Examples F-20

### Manufacturing of Image Bearing Drum F-20

The image bearing drum F-20 is manufactured in the same manner as in Example C-1 except that the amount of the solvent of the liquid application of the protective layer is changed to 208 parts (120 parts of tetrahydrofuran and 88 parts of cyclopentanone) and the oscillating speed (moving speed of the spray gun) and the atomization air pressure when applying the liquid application of the protective layer by the spray gun are changed to 2.3 mm/s and 1.3 kg/cm², respectively.

### Comparative Examples F-21

### Manufacturing of Image Bearing Drum F-21

The image bearing member drum F-21 is manufactured in the same manner as in Example C-1 except that the filler is not blended in the liquid application of the protective layer.

### Comparative Examples F-22

### Manufacturing of Image Bearing Drum F-22

The image bearing drum F-22 is manufactured in the same manner as in Example C-2 except that the filler is not blended in the liquid application of the protective layer.

### Evaluation

The image bearing drums are evaluated as follows.

### Measuring of Arithmetical Mean Deviation of Assessed Profile Wa and Mean Width of Profile Element WSm

The arithmetical mean deviation of the assessed profile Wa and the mean width of the profile elements WSm of the protective layer are measured by using a surface texture and contour measuring instrument (SURFCOM 1400D, manufactured by TOKYO SEIMITSU CO., LTD.). The cross-section curve is measured for wave filtration center line waviness with a measuring length of 12.5 mm, a cut-off wavelength of from 0.25 mm to 2.5 mm, and a measuring speed of 0.6 mm/s. The cut-off selection is Gaussian correction and the linear least square method is selected for slope corrections.

Three points of the top end, the center, and the bottom end relative to the longitudinal direction of the image bearing drum and four points with a gap of 90° for each of the three points relative to the circumference direction, i.e., 12 points in total, are measured to obtain the average value thereof. The measuring direction is along the shaft direction of the image bearing drum.

The results are shown in Tables 1-1 to 1-3.

TABLE 1-1

| | Image | Protective layer | | | |
|---|---|---|---|---|---|
| | bearing | | Wa | WSm | Flange |
| | drum | Filler | (μm) | (μm) | member |
| Example A-1 | A-1 | Alumina | 0.075 | 1.115 | FIG. 7 |
| Example A-2 | A-2 | Alumina | 0.131 | 0.999 | FIG. 7 |
| Example A-3 | A-3 | Alumina | 0.222 | 0.924 | FIG. 7 |
| Example A-4 | A-4 | Alumina | 0.279 | 0.879 | FIG. 7 |
| Example A-5 | A-5 | Alumina | 0.301 | 0.625 | FIG. 7 |
| Example A-6 | A-6 | Alumina | 0.221 | 1.123 | FIG. 7 |
| Example A-7 | A-7 | Alumina | 0.251 | 0.923 | FIG. 7 |
| Example A-8 | A-8 | Alumina | 0.291 | 0.801 | FIG. 7 |
| Example A-9 | A-9 | Silica | 0.199 | 0.789 | FIG. 7 |
| Example A-10 | A-10 | Alumina | 0.183 | 0.851 | FIG. 7 |
| Example A-11 | A-11 | Alumina | 0.211 | 1.451 | FIG. 7 |
| Example A-12 | A-12 | EPOSTAR S-6 | 0.195 | 0.899 | FIG. 7 |
| Example A-13 | A-13 | Alumina | 0.151 | 1.332 | FIG. 7 |
| Example A-14 | A-14 | Alumina | 0.058 | 0.642 | FIG. 7 |
| Example A-15 | A-15 | Alumina | 0.397 | 1.121 | FIG. 7 |
| Example A-16 | A-16 | Alumina | 0.075 | 1.115 | FIG. 9 |
| Example A-17 | A-17 | Alumina | 0.075 | 1.115 | FIG. 10 |
| Example A-18 | A-18 | Alumina | 0.075 | 1.115 | FIG. 16 |
| Example A-19 | A-19 | Alumina | 0.075 | 1.115 | FIG. 14 |
| Example A-20 | A-20 | Alumina | 0.075 | 1.115 | FIG. 18 |
| Comparative | D-1 | Alumina | 0.075 | 1.115 | FIG. 30 |
| Example D-1 | | | | | |
| Comparative | D-2 | Alumina | 0.131 | 0.999 | FIG. 30 |
| Example D-2 | | | | | |
| Comparative | D-3 | Alumina | 0.222 | 0.924 | FIG. 30 |
| Example D-3 | | | | | |
| Comparative | D-4 | Alumina | 0.279 | 0.879 | FIG. 30 |
| Example D-4 | | | | | |
| Comparative | D-5 | Alumina | 0.301 | 0.625 | FIG. 30 |
| Example D-5 | | | | | |
| Comparative | D-6 | Alumina | 0.221 | 1.123 | FIG. 30 |
| Example D-6 | | | | | |
| Comparative | D-7 | Alumina | 0.252 | 0.923 | FIG. 30 |
| Example D-7 | | | | | |
| Comparative | D-8 | Alumina | 0.291 | 0.801 | FIG. 30 |
| Example D-8 | | | | | |
| Comparative | D-9 | Silica | 0.199 | 0.789 | FIG. 30 |
| Example D-9 | | | | | |
| Comparative | D-10 | Alumina | 0.183 | 0.851 | FIG. 30 |
| Example D-10 | | | | | |
| Comparative | D-11 | Alumina | 0.211 | 1.451 | FIG. 30 |
| Example D-11 | | | | | |
| Comparative | D-12 | EPOSTAR S-6 | 0.195 | 0.899 | FIG. 30 |
| Example D-12 | | | | | |
| Comparative | D-13 | Alumina | 0.151 | 1.332 | FIG. 30 |
| Example D-13 | | | | | |
| Comparative | D-14 | Alumina | 0.058 | 0.642 | FIG. 30 |
| Example D-14 | | | | | |
| Comparative | D-15 | Alumina | 0.047 | 1.325 | FIG. 7 |
| Example D-15 | | | | | |
| Comparative | D-16 | Alumina | 0.027 | 1.623 | FIG. 7 |
| Example D-16 | | | | | |
| Comparative | D-17 | Alumina | 0.421 | 0.631 | FIG. 7 |
| Example D-17 | | | | | |
| Comparative | D-18 | Alumina | 0.478 | 0.454 | FIG. 7 |
| Example D-18 | | | | | |
| Comparative | D-19 | Alumina | 0.153 | 0.345 | FIG. 7 |
| Example D-19 | | | | | |
| Comparative | D-20 | Alumina | 0.019 | 1.589 | FIG. 7 |
| Example D-20 | | | | | |
| Comparative | D-21 | — | 0.015 | 2.221 | FIG. 7 |
| Example D-21 | | | | | |
| Comparative | D-22 | — | 0.139 | 0.898 | FIG. 7 |
| Example D-22 | | | | | |

TABLE 1-2

| | Image | | | | |
|---|---|---|---|---|---|
| | bearing | Protective layer | | | Flange |
| | drum | Filler | Wa (μm) | WSm (μm) | member |
| Example B-1 | B-1 | Alumina | 0.069 | 1.111 | FIG. 7 |
| Example B-2 | B-2 | Alumina | 0.131 | 0.999 | FIG. 7 |
| Example B-3 | B-3 | Alumina | 0.222 | 0.889 | FIG. 7 |
| Example B-4 | B-4 | Alumina | 0.271 | 0.903 | FIG. 7 |
| Example B-5 | B-5 | Alumina | 0.299 | 0.623 | FIG. 7 |
| Example B-6 | B-6 | Alumina | 0.225 | 1.125 | FIG. 7 |
| Example B-7 | B-7 | Alumina | 0.251 | 0.932 | FIG. 7 |
| Example B-8 | B-8 | Alumina | 0.291 | 0.811 | FIG. 7 |
| Example B-9 | B-9 | Silica | 0.199 | 0.789 | FIG. 7 |
| Example B-10 | B-10 | Alumina | 0.183 | 0.851 | FIG. 7 |
| Example B-11 | B-11 | Alumina | 0.211 | 1.459 | FIG. 7 |
| Example B-12 | B-12 | EPOSTAR | 0.195 | 0.899 | FIG. 7 |
| | | S-6 | | | |
| Example B-13 | B-13 | Alumina | 0.132 | 1.321 | FIG. 7 |
| Example B-14 | B-14 | Alumina | 0.057 | 0.643 | FIG. 7 |
| Example B-15 | B-15 | Alumina | 0.379 | 1.122 | FIG. 7 |
| Example B-16 | B-16 | Alumina | 0.069 | 1.111 | FIG. 9 |
| Example B-17 | B-17 | Alumina | 0.069 | 1.111 | FIG. 10 |
| Example B-18 | B-18 | Alumina | 0.069 | 1.111 | FIG. 16 |
| Example B-19 | B-19 | Alumina | 0.069 | 1.111 | FIG. 14 |
| Example B-20 | B-20 | Alumina | 0.069 | 1.111 | FIG. 18 |
| Comparative | E-1 | Alumina | 0.069 | 1.111 | FIG. 30 |
| Example E-1 | | | | | |
| Comparative | E-2 | Alumina | 0.131 | 0.999 | FIG. 30 |
| Example E-2 | | | | | |
| Comparative | E-3 | Alumina | 0.222 | 0.889 | FIG. 30 |
| Example E-3 | | | | | |
| Comparative | E-4 | Alumina | 0.271 | 0.903 | FIG. 30 |
| Example E-4 | | | | | |
| Comparative | E-5 | Alumina | 0.299 | 0.623 | FIG. 30 |
| Example E-5 | | | | | |
| Comparative | E-6 | Alumina | 0.225 | 1.125 | FIG. 30 |
| Example E-6 | | | | | |
| Comparative | E-7 | Alumina | 0.251 | 0.932 | FIG. 30 |
| Example E-7 | | | | | |
| Comparative | E-8 | Alumina | 0.291 | 0.811 | FIG. 30 |
| Example E-8 | | | | | |
| Comparative | E-9 | Silica | 0.199 | 0.789 | FIG. 30 |
| Example E-9 | | | | | |
| Comparative | E-10 | Alumina | 0.183 | 0.851 | FIG. 30 |
| Example E-10 | | | | | |
| Comparative | E-11 | Alumina | 0.211 | 1.459 | FIG. 30 |
| Example E-11 | | | | | |
| Comparative | E-12 | EPOSTAR | 0.195 | 0.899 | FIG. 30 |
| Example E-12 | | S-6 | | | |
| Comparative | E-13 | Alumina | 0.132 | 1.321 | FIG. 30 |
| Example E-13 | | | | | |
| Comparative | E-14 | Alumina | 0.057 | 0.643 | FIG. 30 |
| Example E-14 | | | | | |
| Comparative | E-15 | Alumina | 0.047 | 1.333 | FIG. 7 |
| Example E-15 | | | | | |
| Comparative | E-16 | Alumina | 0.027 | 1.625 | FIG. 7 |
| Example E-16 | | | | | |
| Comparative | E-17 | Alumina | 0.422 | 0.631 | FIG. 7 |
| Example E-17 | | | | | |
| Comparative | E-18 | Alumina | 0.474 | 0.456 | FIG. 7 |
| Example E-18 | | | | | |
| Comparative | E-19 | Alumina | 0.153 | 0.344 | FIG. 7 |
| Example E-19 | | | | | |
| Comparative | E-20 | Alumina | 0.019 | 1.578 | FIG. 7 |
| Example E-20 | | | | | |
| Comparative | E-21 | — | 0.017 | 2.224 | FIG. 7 |
| Example E-21 | | | | | |
| Comparative | E-22 | — | 0.066 | 1.234 | FIG. 7 |
| Example E-22 | | | | | |

TABLE 1-3

| | Image | Protective layer | | | |
|---|---|---|---|---|---|
| | bearing | | Wa | WSm | Flange |
| | drum | Filler | (μm) | (μm) | member |
| Example C-1 | C-1 | Alumina | 0.073 | 1.113 | FIG. 7 |
| Example C-2 | C-2 | Alumina | 0.125 | 0.986 | FIG. 7 |
| Example C-3 | C-3 | Alumina | 0.211 | 0.911 | FIG. 7 |
| Example C-4 | C-4 | Alumina | 0.255 | 0.855 | FIG. 7 |
| Example C-5 | C-5 | Alumina | 0.299 | 0.622 | FIG. 7 |
| Example C-6 | C-6 | Alumina | 0.221 | 1.121 | FIG. 7 |
| Example C-7 | C-7 | Alumina | 0.248 | 0.921 | FIG. 7 |
| Example C-8 | C-8 | Alumina | 0.289 | 0.799 | FIG. 7 |
| Example C-9 | C-9 | Silica | 0.199 | 0.785 | FIG. 7 |
| Example C-10 | C-10 | Alumina | 0.183 | 0.849 | FIG. 7 |
| Example C-11 | C-11 | Alumina | 0.208 | 1.453 | FIG. 7 |
| Example C-12 | C-12 | EPOSTAR S-6 | 0.194 | 0.899 | FIG. 7 |
| Example C-13 | C-13 | Alumina | 0.132 | 1.311 | FIG. 7 |
| Example C-14 | C-14 | Alumina | 0.058 | 0.642 | FIG. 7 |
| Example C-15 | C-15 | Alumina | 0.389 | 1.121 | FIG. 7 |
| Example C-1 6 | C-16 | Alumina | 0.073 | 1.113 | FIG. 9 |
| Example C-17 | C-17 | Alumina | 0.073 | 1.113 | FIG. 10 |
| Example C-18 | C-18 | Alumina | 0.073 | 1.113 | FIG. 16 |
| Example C-19 | C-19 | Alumina | 0.073 | 1.113 | FIG. 14 |
| Example C-20 | C-20 | Alumina | 0.073 | 1.113 | FIG. 18 |
| Comparative | F-1 | Alumina | 0.073 | 1.113 | FIG. 30 |
| Example F-1 | | | | | |
| Comparative | F-2 | Alumina | 0.125 | 0.988 | FIG. 30 |
| Example F-2 | | | | | |
| Comparative | F-3 | Alumina | 0.211 | 0.911 | FIG. 30 |
| Example F-3 | | | | | |
| Comparative | F-4 | Alumina | 0.255 | 0.855 | FIG. 30 |
| Example F-4 | | | | | |
| Comparative | F-5 | Alumina | 0.299 | 0.622 | FIG. 30 |
| Example F-5 | | | | | |
| Comparative | F-6 | Alumina | 0.221 | 1.121 | FIG. 30 |
| Example F-6 | | | | | |
| Comparative | F-7 | Alumina | 0.248 | 0.921 | FIG. 30 |
| Example F-7 | | | | | |
| Comparative | F-8 | Alumina | 0.289 | 0.799 | FIG. 30 |
| Example F-8 | | | | | |
| Comparative | F-9 | Silica | 0.199 | 0.785 | FIG. 30 |
| Example F-9 | | | | | |
| Comparative | F-10 | Alumina | 0.183 | 0.849 | FIG. 30 |
| Example F-10 | | | | | |
| Comparative | F-11 | Alumina | 0.208 | 1.453 | FIG. 30 |
| Example F-11 | | | | | |
| Comparative | F-12 | EPOSTAR S-6 | 0.194 | 0.899 | FIG. 30 |
| Example F-12 | | | | | |
| Comparative | F-13 | Alumina | 0.132 | 1.311 | FIG. 30 |
| Example F-13 | | | | | |
| Comparative | F-14 | Alumina | 0.058 | 0.642 | FIG. 30 |
| Example F-14 | | | | | |
| Comparative | F-15 | Alumina | 0.048 | 1.324 | FIG. 7 |
| Example F-15 | | | | | |
| Comparative | F-16 | Alumina | 0.028 | 1.621 | FIG. 7 |
| Example F-16 | | | | | |
| Comparative | F-17 | Alumina | 0.421 | 0.632 | FIG. 7 |
| Example F-17 | | | | | |
| Comparative | F-18 | Alumina | 0.474 | 0.453 | FIG. 7 |
| Example F-18 | | | | | |
| Comparative | F-19 | Alumina | 0.152 | 0.343 | FIG. 7 |
| Example F-19 | | | | | |
| Comparative | F-20 | Alumina | 0.019 | 1.589 | FIG. 7 |
| Example F-20 | | | | | |
| Comparative | F-21 | — | 0.015 | 2.221 | FIG. 7 |
| Example F-21 | | | | | |
| Comparative | F-22 | — | 0.078 | 1.123 | FIG. 7 |
| Example F-22 | | | | | |

### Deviation of Image Bearing Drum

Deviation of the image bearing drums is evaluated.

The deviation of the image bearing drum means the displacement range representing the distance between the surface of the image bearing drum and the fixed reference position facing the surface of the image bearing drum when the image bearing drum is rotated around the rotation axis thereof and is a value obtained by subtracting the minimum value from the maximum value of the distance between the reference position and the surface of the image bearing drum while the image bearing drum rotates one round.

This value is measured by instrument having a mechanism to hold and rotate the image bearing drum while positioning the centers of the axes of both ends of the image bearing drum to each other and laser measuring instrument (LS-7030, manufactured by KEYENCE CORPORATION).

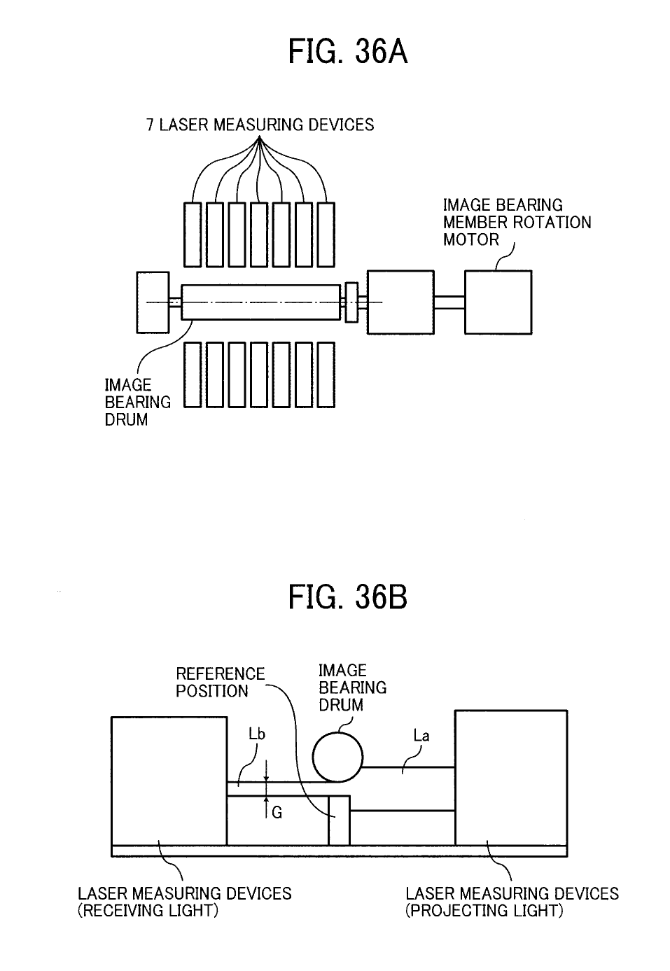

FIGS. 36A and 36B illustrate specific measuring instrument for use. FIGS. 36A and 36B are schematic diagrams illustrating the devices to measure the deviation of the image bearing drum. FIG. 36A is a top view and FIG. 36B is a side view thereof.

As illustrated in FIG. 36B, the laser measuring instrument exposes the gap between the bottom end of the image bearing drum and the reference position with beams La having a sufficient breadth relative to the vertical direction for the gap. Among the beams La, transmissive beams Lb that have passed through the gap between the bottom end of the image bearing drum and the reference position are received on the receiving side. By measuring the breadth (hereinafter referred to as top to bottom breadth G) of the transmissive beams Lb, the distance to the surface of the image bearing drum is detected.

Furthermore, the value of the top to bottom breadth G for one round of the image bearing drum is measured by seven of the laser measuring instrument arranged along the shaft direction of the image bearing drum with an equal gap (about 50 mm) and the difference between the maximum and the minimum among all the values of the top to bottom breadth G is determined as the deviation.

The results are shown in Tables 2-1 to 2-3.

The measuring of the deviation is conducted for the image bearing drums at initial and after a run length of 1,000,000. The machine running test is conducted for the following image evaluation.

### Abrasion Amount and Image Evaluation

The image bearing drums are evaluated with regard to the abrasion amount and the image.

For the image evaluation and the paper running test, a process cartridge containing the image bearing drum is mounted to a machine remodeled based on a digital full color photocopier (tandem type, imagio MP C7501) having a charger, an exposure device, a development device, a transfer device, a fixing device, a cleaner, a lubricant material applicator, and a discharger.

A scorotron charger is used for the black station and vicinity arrangement type charging rollers are used for the magenta, cyan, and yellow stations. The charging roller is a cured resin roller having a diameter of 10 mm and arranged to have a distance of 50 μm from the image bearing drum. In the charging condition, an alternate electric field in which a sine wave of an AC component having a Vpp of 3 kV and a frequency of 1.5 kHz is superimposed on a DC component of −600 V is applied.

As the exposure device, a semiconductor laser having a wavelength of 655 nm is used.

Toner filled in the development device is imagio MP P toner C7501 (manufactured by Ricoh Co., Ltd.).

The transfer device is an intermediate transfer belt.

The cleaner is a blade, which contacts the image bearing drum in the counter direction relative to the rotation direction of the image bearing drum.

As the lubricant material, solidified zinc stearate molded to have a bar form is used and a pressing spring and a fur brush are attached as illustrated in FIG. 32. The fur brush scrapes zinc stearate and supplies it to the surface of the image bearing drum.

Furthermore, an application blade is provided in order not to apply zinc stearete excessively to the surface of the image bearing drum after zinc stearate is attached thereto so that zinc stearate is uniformly applied to the surface of the image bearing drum.

The application blade contacts the image bearing drum in the trailing direction relative to the rotation direction of the image bearing drum.

The images at initial, after 500,000 outputs, and after 1,000,000 outputs are evaluated. In addition, after 500,000 outputs and 1,000,000 outputs, the abrasion amount and eccentric abrasion amount are evaluated.

The abrasion amount means the difference between the thickness of the image bearing drum at initial and the thickness of the image bearing drum after printing for each image evaluation. The abrasion amount is obtained by calculating the average of the abrasion amounts at 160 points in total {(40 points in the longitudinal direction (shaft direction) of the image bearing drum with an equal gap therebetween of about 8 mm) and 4 points along the circumferential direction with an equal gap therebetween}.

In addition, the eccentric abrasion is obtained by the difference between the maximum abrasion amount and the minimum abrasion amount of the measuring results at each measuring point. The results are shown in Tables 2-1 to 2-3.

The evaluation image is ISO/JIS-SCID image Ni (portrait) and the uneven image density is evaluated according to the following evaluation criteria. The results are shown in Tables 2-1 to 2-3.

5: No uneven Density
4: Uneven image density with no practical problem as image
3: Uneven image density that is allowable for all the images
2: Whether the image density is allowable depends on the image
1: Intolerable uneven image density for all the images

This image evaluation is conducted based on the offset printed image. Therefore, the evaluation is severer than for typical electrophotography images.

### Evaluation on Damage on Cleaning Blade

Images are printed on 1,000,000 sheets with an image density of 100% in an environment in which the cleaning performance tends to be poor, i.e., 10° C. and 15% RH.

The same image forming apparatus as used for the image evaluation is used. The transfer paper is MY Paper A4 (manufactured by NBS Ricoh Co., Ltd.) and proper toner and cleaning blade are used.

In addition, take out the cleaning blade from the process cartridge, observe the edge of the blade by a microscope to evaluate the damage thereof according to the following evaluation criteria.

The results are shown in Tables 2-1 to 2-3.

E (Excellent): No damage
G (Good): Slightly damaged (no impact on image)
B (Bad): Damaged (impact on image)
VB (Very Bad): Greatly damaged (impact on image)

TABLE 2-1

| | | | | | | After a | | |
|---|---|---|---|---|---|---|---|---|
| | | After a | | After a | | half | After a | |
| | Initial | million | Initial | half | After | million | million | Cleaning |
| | deviation | deviation | image | million | million | A/E * | A/E * | blade |
| | (μm) | (μm) | evaluation | evlauation | evlauation | (μm) | (μm) | evaluation |
| Example | 12 | 19 | 5 | 3 | 1 | 1.83/ | 3.53/ | G |
| A-1 | | | | | | 0.13 | 0.27 | |
| Example | 12 | 19 | 5 | 3 | 1 | 1.95/ | 4.00/ | E |
| A-2 | | | | | | 0.12 | 0.24 | |
| Example | 12 | 19 | 5 | 3 | 1 | 2.01/ | 4.02/ | E |
| A-3 | | | | | | 0.99 | 2.01 | |
| Example | 12 | 19 | 5 | 3 | 1 | 2.01/ | 4.02/ | E |
| A-4 | | | | | | 1.26 | 2.52 | |
| Example | 12 | 19 | 5 | 3 | 1 | 1.98/ | 3.99/ | E |
| A-5 | | | | | | 1.31 | 2.62 | |
| Example | 12 | 19 | 5 | 3 | 1 | 2.01/ | 4.21/ | E |
| A-6 | | | | | | 1.42 | 2.83 | |
| Example | 12 | 19 | 5 | 3 | 1 | 1.96/ | 4.02/ | E |
| A-7 | | | | | | 1.33 | 2.70 | |
| Example | 12 | 19 | 5 | 3 | 1 | 1.99/ | 4.02/ | E |
| A-8 | | | | | | 1.52 | 3.10 | |
| Example | 12 | 21 | 5 | 3 | 1 | 2.72/ | 5.43/ | G |
| A-9 | | | | | | 1.91 | 4.02 | |
| Example | 12 | 19 | 5 | 3 | 1 | 1.98/ | 4.03/ | E |
| A-10 | | | | | | 1.43 | 3.01 | |
| Example | 12 | 19 | 5 | 3 | 1 | 1.99/ | 4.00/ | E |
| A-11 | | | | | | 1.43 | 2.86 | |
| Example | 12 | 23 | 5 | 3 | 1 | 3.02/ | 6.01/ | G |
| A-12 | | | | | | 2.01 | 4.03 | |
| Example | 12 | 19 | 5 | 3 | 1 | 2.43/ | 4.86/ | E |
| A-13 | | | | | | 1.93 | 4.00 | |
| Example | 12 | 19 | 5 | 3 | 1 | 2.21/ | 4.43/ | G |
| A-14 | | | | | | 1.81 | 3.66 | |
| Example | 12 | 19 | 5 | 3 | 1 | 2.00/ | 4.00/ | G |
| A-15 | | | | | | 1.51 | 3.22 | |
| Example | 7 | 11 | 5 | 3 | 1 | 1.33/ | 2.66/ | E |
| A-16 | | | | | | 1.03 | 3.00 | |
| Example | 8 | 12 | 5 | 3 | 1 | 1.31/ | 2.62/ | E |
| A-17 | | | | | | 0.86 | 1.93 | |
| Example | 15 | 21 | 4 | 3 | 1 | 1.89/ | 3.99/ | G |
| A-18 | | | | | | 1.03 | 2.05 | |
| Example | 8 | 12 | 5 | 3 | 1 | 1.43/ | 2.85/ | E |
| A-19 | | | | | | 1.01 | 2.03 | |
| Example | 17 | 25 | 4 | 3 | 1 | 2.00/ | 4.03/ | G |
| A-20 | | | | | | 1.76 | 3.58 | |
| Comparative | 25 | 40 | 4 | 1 | 1 | 3.00/ | 6.02/ | G |
| Example | | | | | | 2.22 | 4.45 | |
| D-1 | | | | | | | | |
| Comparative | 25 | 40 | 4 | 1 | 1 | 2.99/ | 6.00/ | E |
| Example | | | | | | 2.10 | 4.31 | |
| D-2 | | | | | | | | |
| Comparative | 25 | 40 | 4 | 1 | 1 | 2.76/ | 5.86/ | E |
| Example | | | | | | 2.00 | 4.03 | |
| D-3 | | | | | | | | |
| Comparative | 25 | 40 | 4 | 1 | 1 | 3.02/ | 6.05/ | E |
| Example | | | | | | 2.43 | 4.86 | |
| D-4 | | | | | | | | |
| Comparative | 25 | 40 | 4 | 1 | 1 | 3.99/ | 8.00/ | E |
| Example | | | | | | 2.00 | 4.02 | |
| D-5 | | | | | | | | |
| Comparative | 25 | 40 | 4 | 1 | 1 | 2.86/ | 5.99/ | E |
| Example | | | | | | 2.22 | 4.44 | |
| D-6 | | | | | | | | |
| Comparative | 25 | 40 | 4 | 1 | 1 | 2.78/ | 5.21/ | E |
| Example | | | | | | 2.22 | 4.44 | |
| D-7 | | | | | | | | |
| Comparative | 25 | 40 | 4 | 1 | 1 | 3.01/ | 6.03/ | E |
| Example | | | | | | 2.22 | 4.45 | |
| D-8 | | | | | | | | |
| Comparative | 25 | 45 | 4 | 1 | 1 | 3.04/ | 6.08/ | G |
| Example | | | | | | 2.64 | 5.22 | |
| D-9 | | | | | | | | |
| Comparative | 25 | 40 | 4 | 1 | 1 | 2.99/ | 6.03/ | E |
| Example | | | | | | 2.00 | 4.03 | |
| D-10 | | | | | | | | |
| Comparative | 25 | 40 | 4 | 1 | 1 | 2.71/ | 5.47/ | E |
| Example | | | | | | 2.03 | 4.05 | |
| D-11 | | | | | | | | |
| Comparative | 25 | 37 | 4 | 1 | 1 | 3.78/ | 7.66/ | G |
| Example | | | | | | 2.45 | 5.01 | |
| D-12 | | | | | | | | |
| Comparative | 12 | 27 | 4 | 1 | 1 | 2.91/ | 6.01/ | E |
| Example | | | | | | 2.51 | 5.01 | |
| D-13 | | | | | | | | |
| Comparative | 12 | 29 | 4 | 1 | 1 | 2.01/ | 4.03/ | G |
| Example | | | | | | 1.31 | 2.63 | |
| D-14 | | | | | | | | |
| Comparative | 12 | 28 | 4 | 1 | 1 | 2.01/ | 4.03/ | VB |
| Example | | | | | | 1.32 | 2.64 | |
| D-15 | | | | | | | | |
| Comparative | 12 | 30 | 4 | 1 | 1 | 1.97/ | 4.00/ | VB |
| Example | | | | | | 1.33 | 2.66 | |
| D-16 | | | | | | | | |
| Comparative | 12 | 32 | 3 | 1 | 1 | 2.02/ | 4.05/ | G |
| Example | | | | | | 1.42 | 3.00 | |
| D-17 | | | | | | | | |
| Comparative | 12 | 30 | 3 | 1 | 1 | 1.99/ | 4.01/ | G |
| Example | | | | | | 1.21 | 2.42 | |
| D-18 | | | | | | | | |
| Comparative | 12 | 31 | 2 | 1 | 1 | 1.99/ | 4.02/ | VB |
| Example | | | | | | 1.31 | 2.65 | |
| D-19 | | | | | | | | |
| Comparative | 12 | 35 | 2 | 1 | 1 | 2.66/ | 5.31/ | VB |
| Example | | | | | | 1.99 | 4.03 | |
| D-20 | | | | | | | | |
| Comparative | 12 | 43 | 2 | 1 | 1 | 3.02/ | 6.10/ | VB |
| Example | | | | | | 2.83 | 5.66 | |
| D-21 | | | | | | | | |
| Comparative | 12 | 43 | 2 | 1 | 1 | 4.02/ | 8.10/ | VB |
| Example | | | | | | 3.83 | 6.66 | |
| D-22 | | | | | | | | |

A/E *: (Abrasion amount)/Eccentric (non-uniform) abrasion

TABLE 2-2

| | | | | | | After a | | |
|---|---|---|---|---|---|---|---|---|
| | | After a | | After a | | half | After a | |
| | Initial | million | Initial | half | After | million | million | Cleaning |
| | deviation | deviation | image | million | million | A/E * | A/E * | blade |
| | (μm) | (μm) | evaluation | evlauation | evlauation | (μm) | (μm) | evaluation |
| Example | 12 | 17 | 5 | 4 | 2 | 0.91/ | 1.89/ | G |
| B-1 | | | | | | 0.06 | 1.11 | |
| Example | 12 | 17 | 5 | 4 | 3 | 0.95/ | 1.91/ | E |
| B-2 | | | | | | 0.06 | 1.21 | |
| Example | 12 | 17 | 5 | 4 | 3 | 0.97/ | 1.95/ | E |
| B-3 | | | | | | 0.63 | 1.25 | |
| Example | 12 | 17 | 5 | 4 | 3 | 1.01/ | 2.01/ | E |
| B-4 | | | | | | 0.63 | 1.27 | |
| Example | 12 | 17 | 5 | 4 | 3 | 0.98/ | 1.87/ | E |
| B-5 | | | | | | 0.65 | 1.31 | |
| Example | 12 | 17 | 5 | 4 | 3 | 1.01/ | 2.02/ | E |
| B-6 | | | | | | 0.68 | 1.35 | |
| Example | 12 | 17 | 5 | 4 | 3 | 0.93/ | 1.87/ | E |
| B-7 | | | | | | 0.61 | 1.22 | |
| Example | 12 | 17 | 5 | 3 | 2 | 0.99/ | 1.98/ | E |
| B-8 | | | | | | 0.75 | 1.52 | |
| Example | 12 | 20 | 5 | 3 | 2 | 1.31/ | 2.56/ | G |
| B-9 | | | | | | 0.91 | 1.89 | |
| Example | 12 | 17 | 5 | 3 | 2 | 0.98/ | 1.87/ | E |
| B-10 | | | | | | 0.67 | 1.36 | |
| Example | 12 | 17 | 5 | 3 | 2 | 0.99/ | 1.98/ | E |
| B-11 | | | | | | 0.65 | 1.33 | |
| Example | 12 | 21 | 5 | 3 | 2 | 1.51/ | 2.98/ | G |
| B-12 | | | | | | 1.01 | 2.01 | |
| Example | 12 | 17 | 5 | 3 | 2 | 1.23/ | 2.43/ | E |
| B-13 | | | | | | 0.83 | 1.66 | |
| Example | 12 | 17 | 5 | 3 | 2 | 1.11/ | 2.22/ | G |
| B-14 | | | | | | 0.79 | 1.56 | |
| Example | 12 | 17 | 5 | 4 | 3 | 1.00/ | 1.98/ | G |
| B-15 | | | | | | 0.75 | 1.35 | |
| Example | 7 | 10 | 5 | 4 | 3 | 0.61/ | 1.23/ | E |
| B-16 | | | | | | 0.51 | 0.98 | |
| Example | 8 | 11 | 5 | 4 | 3 | 0.65/ | 1.31/ | E |
| B-17 | | | | | | 0.43 | 0.87 | |
| Example | 15 | 20 | 4 | 3 | 2 | 0.89/ | 1.78/ | G |
| B-18 | | | | | | 0.58 | 1.11 | |
| Example | 8 | 11 | 5 | 4 | 3 | 0.71/ | 1.43/ | E |
| B-19 | | | | | | 0.51 | 0.98 | |
| Example | 17 | 23 | 4 | 3 | 1 | 1.00/ | 2.01/ | G |
| B-20 | | | | | | 0.86 | 1.56 | |
| Comparative | 25 | 35 | 4 | 1 | 1 | 1.48/ | 2.78/ | G |
| Example | | | | | | 1.11 | 2.22 | |
| E-1 | | | | | | | | |
| Comparative | 25 | 35 | 4 | 1 | 1 | 1.49/ | 2.89/ | E |
| Example | | | | | | 1.10 | 2.21 | |
| E-2 | | | | | | | | |
| Comparative | 25 | 35 | 4 | 1 | 1 | 1.39/ | 2.77/ | E |
| Example | | | | | | 0.99 | 1.99 | |
| E-3 | | | | | | | | |
| Comparative | 25 | 35 | 4 | 1 | 1 | 1.51/ | 2.98/ | E |
| Example | | | | | | 1.21 | 2.25 | |
| E-4 | | | | | | | | |
| Comparative | 25 | 35 | 4 | 1 | 1 | 1.89/ | 2.78/ | E |
| Example | | | | | | 0.99 | 1.98 | |
| E-5 | | | | | | | | |
| Comparative | 25 | 35 | 4 | 1 | 1 | 1.43/ | 2.87/ | E |
| Example | | | | | | 1.11 | 2.23 | |
| E-6 | | | | | | | | |
| Comparative | 25 | 35 | 4 | 1 | 1 | 1.26/ | 2.45/ | E |
| Example | | | | | | 1.11 | 2.21 | |
| E-7 | | | | | | | | |
| Comparative | 25 | 35 | 4 | 1 | 1 | 1.49/ | 2.78/ | E |
| Example | | | | | | 1.11 | 2.22 | |
| E-8 | | | | | | | | |
| Comparative | 25 | 40 | 4 | 1 | 1 | 1.52/ | 3.05/ | G |
| Example | | | | | | 1.32 | 2.58 | |
| E-9 | | | | | | | | |
| Comparative | 25 | 35 | 4 | 1 | 1 | 1.45/ | 2.89/ | E |
| Example | | | | | | 0.99 | 1.99 | |
| E-10 | | | | | | | | |
| Comparative | 25 | 36 | 4 | 1 | 1 | 1.39/ | 2.78/ | E |
| Example | | | | | | 1.01 | 2.01 | |
| E-11 | | | | | | | | |
| Comparative | 25 | 36 | 4 | 1 | 1 | 1.74/ | 3.35/ | G |
| Example | | | | | | 1.22 | 2.35 | |
| E-12 | | | | | | | | |
| Comparative | 12 | 25 | 4 | 1 | 1 | 1.41/ | 2.78/ | E |
| Example | | | | | | 1.25 | 2.56 | |
| E-13 | | | | | | | | |
| Comparative | 12 | 27 | 4 | 1 | 1 | 0.95/ | 1.95/ | G |
| Example | | | | | | 0.65 | 1.25 | |
| E-14 | | | | | | | | |
| Comparative | 12 | 25 | 4 | 1 | 1 | 1.01/ | 2.01/ | VB |
| Example | | | | | | 0.62 | 1.27 | |
| E-15 | | | | | | | | |
| Comparative | 12 | 27 | 4 | 1 | 1 | 0.97/ | 1.87/ | VB |
| Example | | | | | | 0.66 | 1.31 | |
| E-16 | | | | | | | | |
| Comparative | 12 | 28 | 3 | 1 | 1 | 1.02/ | 2.02/ | G |
| Example | | | | | | 0.71 | 1.35 | |
| E-17 | | | | | | | | |
| Comparative | 12 | 25 | 3 | 1 | 1 | 0.99/ | 1.87/ | G |
| Example | | | | | | 0.61 | 1.22 | |
| E-18 | | | | | | | | |
| Comparative | 12 | 26 | 2 | 1 | 1 | 0.99/ | 1.98/ | VB |
| Example | | | | | | 0.64 | 1.52 | |
| E-19 | | | | | | | | |
| Comparative | 12 | 30 | 2 | 1 | 1 | 1.33/ | 2.56/ | VB |
| Example | | | | | | 0.99 | 1.89 | |
| E-20 | | | | | | | | |
| Comparative | 12 | 37 | 2 | 1 | 1 | 1.55/ | 3.05/ | VB |
| Example | | | | | | 1.41 | 2.78 | |
| E-21 | | | | | | | | |
| Comparative | 12 | 37 | 2 | 1 | 1 | 1.85/ | 3.25/ | VB |
| Example | | | | | | 1.61 | 2.98 | |
| E-22 | | | | | | | | |

TABLE 2-3

| | | | | | | After a | | |
|---|---|---|---|---|---|---|---|---|
| | | After a | | After a | | half | After a | |
| | Initial | million | Initial | half | After | million | million | Cleaning |
| | deviation | deviation | image | million | million | A/E * | A/E * | blade |
| | (μm) | (μm) | evlauation | evaluation | evlauation | (μm) | (μm) | evaluation |
| Example | 12 | 14 | 5 | 4 | 3 | 0.03/ | 0.07/ | G |
| C-1 | | | | | | 0.01 | 0.03 | |
| Example | 12 | 14 | 5 | 5 | 4 | 0.03/ | 0.05/ | E |
| C-2 | | | | | | 0.02 | 0.01 | |
| Example | 12 | 14 | 5 | 5 | 4 | 0.03/ | 0.06/ | E |
| C-3 | | | | | | 0.02 | 0.01 | |
| Example | 12 | 14 | 5 | 5 | 4 | 0.03/ | 0.06/ | E |
| C-4 | | | | | | 0.01 | 0.02 | |
| Example | 12 | 14 | 5 | 4 | 3 | 0.03/ | 0.06/ | E |
| C-5 | | | | | | 0.01 | 0.02 | |
| Example | 12 | 14 | 5 | 5 | 4 | 0.03/ | 0.06/ | E |
| C-6 | | | | | | 0.01 | 0.02 | |
| Example | 12 | 14 | 5 | 5 | 4 | 0.03/ | 0.06/ | E |
| C-7 | | | | | | 0.01 | 0.02 | |
| Example | 12 | 14 | 5 | 5 | 3 | 0.03/ | 0.06/ | E |
| C-8 | | | | | | 0.01 | 0.02 | |
| Example | 12 | 17 | 5 | 4 | 3 | 0.05/ | 0.09/ | G |
| C-9 | | | | | | 0.02 | 0.04 | |
| Example | 12 | 14 | 5 | 4 | 3 | 0.03/ | 0.06/ | E |
| C-10 | | | | | | 0.01 | 0.02 | |
| Example | 12 | 14 | 5 | 4 | 3 | 0.03/ | 0.07/ | E |
| C-11 | | | | | | 0.01 | 0.02 | |
| Example | 12 | 19 | 5 | 4 | 3 | 0.06/ | 0.12/ | G |
| C-12 | | | | | | 0.02 | 0.05 | |
| Example | 12 | 14 | 5 | 5 | 3 | 0.04/ | 0.08/ | E |
| C-13 | | | | | | 0.02 | 0.04 | |
| Example | 12 | 14 | 5 | 4 | 3 | 0.04/ | 0.08/ | G |
| C-14 | | | | | | 0.02 | 0.03 | |
| Example | 12 | 14 | 5 | 4 | 3 | 0.04/ | 0.03/ | G |
| C-15 | | | | | | 0.01 | 0.01 | |
| Example | 7 | 9 | 5 | 5 | 4 | 0.02/ | 0.03/ | E |
| C-16 | | | | | | 0.00 | 0.01 | |
| Example | 8 | 9 | 5 | 4 | 4 | 0.01/ | 0.03/ | E |
| C-17 | | | | | | 0.00 | 0.01 | |
| Example | 15 | 18 | 4 | 5 | 4 | 0.03/ | 0.06/ | G |
| C-18 | | | | | | 0.01 | 0.03 | |
| Example | 8 | 10 | 5 | 4 | 4 | 0.02/ | 0.03/ | E |
| C-19 | | | | | | 0.01 | 0.01 | |
| Example | 17 | 20 | 4 | 4 | 3 | 0.04/ | 0.08/ | G |
| C-20 | | | | | | 0.01 | 0.03 | |
| Comparative | 25 | 31 | 4 | 2 | 1 | 0.08/ | 0.17/ | G |
| Example | | | | | | 0.06 | 0.11 | |
| F-1 | | | | | | | | |
| Comparative | 25 | 31 | 4 | 3 | 1 | 0.08/ | 0.15/ | E |
| Example | | | | | | 0.05 | 0.09 | |
| F-2 | | | | | | | | |
| Comparative | 25 | 31 | 4 | 3 | 2 | 0.08/ | 0.15/ | E |
| Example | | | | | | 0.04 | 0.09 | |
| F-3 | | | | | | | | |
| Comparative | 25 | 31 | 4 | 2 | 2 | 0.08/ | 0.15/ | E |
| Example | | | | | | 0.04 | 0.09 | |
| F-4 | | | | | | | | |
| Comparative | 25 | 31 | 4 | 2 | 2 | 0.08/ | 0.15/ | E |
| Example | | | | | | 0.05 | 0.09 | |
| F-5 | | | | | | | | |
| Comparative | 25 | 31 | 4 | 3 | 1 | 0.08/ | 0.15/ | E |
| Example | | | | | | 0.05 | 0.09 | |
| F-6 | | | | | | | | |
| Comparative | 25 | 31 | 4 | 2 | 2 | 0.08/ | 0.15/ | E |
| Example | | | | | | 0.04 | 0.09 | |
| F-7 | | | | | | | | |
| Comparative | 25 | 31 | 4 | 2 | 2 | 0.08/ | 0.15/ | E |
| Example | | | | | | 0.04 | 0.09 | |
| F-8 | | | | | | | | |
| Comparative | 25 | 35 | 4 | 2 | 1 | 0.11/ | 0.21/ | G |
| Example | | | | | | 0.08 | 0.15 | |
| F-9 | | | | | | | | |
| Comparative | 25 | 31 | 4 | 2 | 1 | 0.08/ | 0.17/ | E |
| Example | | | | | | 0.06 | 0.12 | |
| F-10 | | | | | | | | |
| Comparative | 25 | 31 | 4 | 2 | 1 | 0.08/ | 0.16/ | E |
| Example | | | | | | 0.05 | 0.11 | |
| F-11 | | | | | | | | |
| Comparative | 25 | 34 | 4 | 2 | 1 | 0.13/ | 0.25/ | G |
| Example | | | | | | 0.09 | 0.18 | |
| F-12 | | | | | | | | |
| Comparative | 12 | 22 | 4 | 2 | 1 | 0.08/ | 0.17/ | E |
| Example | | | | | | 0.06 | 0.11 | |
| F-13 | | | | | | | | |
| Comparative | 12 | 21 | 4 | 2 | 1 | 0.08/ | 0.15/ | G |
| Example | | | | | | 0.04 | 0.09 | |
| F-14 | | | | | | | | |
| Comparative | 12 | 23 | 4 | 3 | 2 | 0.04/ | 0.08/ | VB |
| Example | | | | | | 0.02 | 0.05 | |
| F-15 | | | | | | | | |
| Comparative | 12 | 24 | 4 | 2 | 1 | 0.05/ | 0.09/ | VB |
| Example | | | | | | 0.03 | 0.06 | |
| F-16 | | | | | | | | |
| Comparative | 12 | 24 | 3 | 3 | 2 | 0.04/ | 0.08/ | G |
| Example | | | | | | 0.02 | 0.04 | |
| F-17 | | | | | | | | |
| Comparative | 12 | 21 | 3 | 3 | 2 | 0.04/ | 0.07/ | G |
| Example | | | | | | 0.02 | 0.05 | |
| F-18 | | | | | | | | |
| Comparative | 12 | 22 | 2 | 1 | 1 | 0.04/ | 0.08/ | VB |
| Example | | | | | | 0.02 | 0.04 | |
| F-19 | | | | | | | | |
| Comparative | 12 | 24 | 2 | 1 | 1 | 0.04/ | 0.09/ | VB |
| Example | | | | | | 0.02 | 0.05 | |
| F-20 | | | | | | | | |
| Comparative | 12 | 32 | 2 | 1 | 1 | 0.81/ | 1.51/ | VB |
| Example | | | | | | 0.64 | 1.31 | |
| F-21 | | | | | | | | |
| Comparative | 12 | 32 | 2 | 1 | 1 | 0.99/ | 1.81/ | VB |
| Example | | | | | | 0.764 | 1.51 | |
| F-22 | | | | | | | | |

When Examples are compared with Comparative Examples, as seen in the results, no damage is observed for the cleaning blade in the environment of 10° C. and 15% RH in Examples in which the protective layer contains at least fillers and the surface of the protective layer having waviness has an arithmetical mean deviation of the assessed profile Wa (μm) of from 0.050 μm or 0.400 μm and an mean width of the profile elements WSm (mm) of from 0.500 mm to 1.500 mm, which are obtained from a waviness profile in which roughness components are blocked off by a λc profile filter of 0.25 mm and wavelength components longer than the waviness are blocked off by λf profile filter of 2.5 mm and the flange members having shock-absorbing holes at the linking units.

Also, no defective images having uneven image density are produced with reference to the offset printing image. In addition, in Examples A-15, B-15, and C-15, it is confirmed that the productivity is improved by increasing the oscillating speed.

To the contrary, in the evaluation of Comparative Examples D-1 to D-14, E-1 to E-14, and F-1 to F-14 using the flange members having no shock-absorbing holes at the linking units, it is confirmed that these are inferior with regard to the deviation and the image density.

That is, the image bearing drum of the present disclosure is confirmed to have reached the level to satisfy the quality of images required in the production printing (offset printing) field into which the image bearing drum is thrown.

In addition, in Comparative Examples D-15 to D-21, E-15 to E-21, and F-15 to F-21, which do not satisfy at least one of the particular ranges of the arithmetical mean deviation of the assessed profile Wa and the mean width of the profile elements WSm (mm), the damage of the cleaning blade occurs or the image density is uneven. Moreover, in Comparative Examples in which no filler is contained, the image density is uneven from the start and the cleaning blade deteriorates after the machine running test.

Furthermore, the effect of the number of the shock-absorbing holes at the linking unit of the flange members is evaluated by comparing Example A1 and Examples A16 to A-20, Example B-1 and Examples B-16 to B-20, and Examples C-16 and C-20.

As seen in the results, it is confirmed that the linking unit having at least four shock-absorbing holes arranged around the circumference of a circle concentric with the center of the shaft hole in the virtual plane, which has the same distance from the center of the shaft hole, is good to reduce the unevenness of the image density furthermore.

As seen in the results, it is confirmed that the linking unit having at least two shock-absorbing holes on an arbitrary line segment drawn from the center of the shaft hole to the circumference of the virtually projected circle in the virtual plane is good to reduce the unevenness of the image density furthermore.

In comparison between Examples A-1 to A-20, Examples B-1 to B-20, and Examples C-1 to C-20, it is confirmed that the protective layer containing the cured resin and the cured resin formed by curing a radical polymerizable compound having a charge transport structure and a radical polymerizable compound having three or more functional groups with no charge transport structure are good to reduce the amount of scraped film and eccentric abrasion. Moreover, it is clear that the kind of filler has an impact as well.

As a result, the image bearing drum and the image forming apparatus, the image forming method, and the process cartridge using the image bearing drum of the present disclosure are confirmed to have an ability to provide images having quality equal to that of the offset printing which is required in the production printing field.

What is claimed is:

1. An image bearing drum comprising:
a hollow cylinder sleeve member;
a photosensitive layer overlying the hollow cylinder sleeve member;
a protective layer comprising fillers and overlying the photosensitive layer; and
flange members, each of which comprises an attachment unit attached to an open axial end of the hollow cylinder sleeve member, a shaft hole unit into which a shaft member is inserted at a position of a center axis of the hollow cylinder sleeve member, and a linking unit that extends in a direction parallel to a circular cross-section of the hollow cylinder sleeve member to link the attachment unit to the shaft hole unit,
wherein a surface of the protective layer having waviness has an arithmetical mean deviation of an assessed profile Wa (μm) of from 0.050 μm to 0.400 μm and a mean width of profile elements WSm (mm) of from 0.500 mm to 1.500 mm, which are obtained from a waviness profile in which roughness components are blocked off by a λc profile filter of 0.25 mm and wavelength components longer than the waviness are blocked off by λf profile filter of 2.5 mm, and
wherein the linking unit has at least one shock-absorbing hole located on a virtual line segment drawn to the shaft hole unit from a circumference of a virtually projected circle formed by projecting an outer periphery of the attachment unit axially along the shaft onto a virtual plane that contains the linking unit and is orthogonal to the shaft direction.

2. The image bearing drum according to claim 1, wherein the protective layer comprises a cured resin.

3. The image bearing drum according to claim 2, wherein the cured resin is formed by curing a polymerizable compound having a charge transport structure and a polymerizable compound having three or more functional groups with no charge transport structure.

4. The image bearing drum according to claim 1, wherein the filler is an inorganic filler.

5. The image bearing drum according to claim 4, wherein the inorganic filler is alumina.

6. The image bearing drum according to claim 1, wherein the linking unit has at least four shock-absorbing holes arranged around the circumference of a circle concentric with a center of the shaft hole in the virtual plane.

7. The image bearing drum according to claim 1, wherein the linking unit has at least two the shock-absorbing holes on a line segment drawn in the virtual plane from a center of the shaft hole to a circumference of the virtually projected circle.

8. An image forming apparatus comprising:
the image bearing drum of claim 1;
a charger to charge a surface of the image bearing drum;
an exposure device to expose the surface of the image bearing drum to form a latent electrostatic image thereon;
a development device to develop the latent electrostatic image formed on the image bearing drum with toner to obtain a toner image;
a transfer device to transfer the toner image to a recording medium; and
a cleaner to remove toner remaining on the surface of the image bearing drum.

9. An image forming method comprising:
charging a surface of the image bearing drum of claim 1;
exposing the surface of the charged image bearing drum to form a latent electrostatic image thereon;
developing the latent electrostatic image formed on the surface of the image bearing drum with toner to form a toner image;
transferring the toner image onto a recording medium; and
removing toner remaining on the surface of the image bearing drum.

10. A process cartridge comprising:
the image bearing drum of claim 1; and
at least one device selected from the group consisting of a charger, a development device, a transfer device, and a cleaner,
wherein the process cartridge is detachably mounted to an image forming apparatus.
